(19) United States
(12) Patent Application Publication
(10) Pub. No.: US 2026/0361187 A1
(43) Pub. Date: Nov. 12, 2026

(54) COMMUNICATION DEVICE

(71) Applicant: DENSO CORPORATION, Kariya-city (JP)

(72) Inventors: Toshihiro FUJITA, Kariya-city (JP); Kunihiko MATSUDA, Kariya-city (JP); Nao UEMATSU, Kariya-city (JP); Atsushi SAITO, Kariya-city (JP); Jumpei KUROKAWA, Kariya-city (JP)

(21) Appl. No.: 19/707,655

(22) Filed: Jun. 15, 2026

Related U.S. Application Data
(63) Continuation of application No. PCT/JP2024/044562, filed on Dec. 17, 2024.

(30) Foreign Application Priority Data
Dec. 18, 2023 (JP) 2023-212688
Feb. 29, 2024 (JP) 2024-029593

(51) Int. Cl. H02K 11/35; H02K 3/28; H02K 11/33

(52) U.S. Cl. CPC H02K 11/35; H02K 3/28; H02K 11/33

(57) ABSTRACT

A communication device includes a plurality of controllers and a plurality of electronic components. Each of the controllers includes at least one processing circuit. The electronic component is provided corresponding to the controller and is digitally communicably connected to the controller. Assuming that a combination of a controller and an electronic component that are provided correspondingly is a control system, and a communication line connecting the controller and the electronic component provided correspondingly is an intra-system communication line, an inter-system connection line connects (i) intra-system communication lines of different control systems, (ii) an intra-system communication line of a control system and an electronic component of another control system, or (iii) electronic components of different control systems.

### CROSS REFERENCE TO RELATED APPLICATIONS

The present application is a continuation application of International Patent Application No. PCT/JP 2024/044562 filed on Dec. 17, 2024, which designated the U.S. and claims the benefit of priority from Japanese Patent Application No. 2023-212688 filed on Dec. 18, 2023 and Japanese Patent Application No. 2024-029593 filed on Feb. 29, 2024. The entire disclosures of all of the above applications are incorporated herein by reference.

### TECHNICAL FIELD

The present disclosure relates to a communication device.

### BACKGROUND

In a related art, a motor control device that controls a motor having two sets of motor windings is known. For example, it is proposed that the motor control device has a configuration of two systems in which an inverter circuit and a control unit are provided corresponding to motor windings.

### SUMMARY

According to an aspect of the present disclosure, a communication device may include a plurality of controllers each having at least one processing circuit, and a plurality of electronic components. The electronic components may be provided corresponding to the controllers and be digitally communicably connected to the controllers. Assuming that a combination of a controller and an electronic component that are provided correspondingly is a control system, and a communication line connecting the controller and the electronic component provided correspondingly is an intra-system communication line, an inter-system connection line may connect (i) intra-system communication lines of different control systems, (ii) an intra-system communication line and an electronic component of another control system, or (iii) electronic components of different control systems.

### BRIEF DESCRIPTION OF DRAWINGS

Objects, features, and advantages of the present disclosure will become more apparent from the following detailed description with reference to the accompanying drawings. The drawings include:

FIG. 1 is a schematic configuration diagram illustrating an electric power steering device according to a first embodiment;

FIG. 2 is a block diagram illustrating an ECU according to the first embodiment;

FIG. 3 is a circuit diagram for describing a driver circuit according to the first embodiment;

FIG. 4 is a circuit diagram for describing a driver component according to the first embodiment;

FIG. 5 is a circuit diagram for describing the driver component according to the first embodiment;

FIG. 6 is a circuit diagram for describing the driver component according to the first embodiment;

FIG. 7 is a plan view illustrating the driver component according to the first embodiment;

FIG. 8 is a sectional view taken along line VIII-VIII in FIG. 7;

FIG. 9 is a schematic diagram for describing the substrate arrangement according to the first embodiment;

FIG. 10 is a schematic diagram for describing the substrate arrangement according to the first embodiment;

FIG. 11 is a schematic diagram for describing the substrate arrangement according to the first embodiment;

FIG. 12 is an explanatory diagram for describing a connection between the microcomputers and the components in the two systems;

FIG. 13 is an explanatory diagram for describing a connection between the microcomputers and the components in three systems;

FIG. 14A is an explanatory diagram illustrating an inter-system connection line according to the first embodiment;

FIG. 14B is an explanatory diagram illustrating the inter-system connection line according to the first embodiment;

FIG. 15 is an explanatory diagram illustrating an isolator according to the first embodiment;

FIG. 16 is an explanatory diagram for describing a communication configuration between the microcomputer and the driver component according to the first embodiment;

FIG. 17 is an explanatory diagram for describing a communication configuration between the microcomputer and the driver component according to the first embodiment;

FIG. 18 is a time chart for describing data communication according to the first embodiment;

FIG. 19 is a schematic diagram illustrating an arrangement in a case where motor windings have two systems;

FIG. 20 is a schematic diagram illustrating an arrangement in a case where motor windings have four systems;

FIG. 21 is a time chart for describing communication between a processing core and a pre-driver IC according to the first embodiment;

FIG. 22 is a time chart for describing communication with the pre-driver IC in a case where some of the processing cores according to the first embodiment fail;

FIG. 23 is an explanatory diagram for describing an inter-system connection line according to the first embodiment;

FIG. 24 is a block diagram for describing driving of the power supply relay and the reverse connection protection relay according to the first embodiment;

FIG. 25 is a block diagram for describing a redundant configuration in the microcomputer according to the first embodiment;

FIG. 26 is a flowchart for describing a clock monitoring process according to the first embodiment;

FIG. 27 is a flowchart for describing a power supply monitoring process according to the first embodiment;

FIG. 28 is a block diagram for describing driving of the power supply relay and the reverse connection protection relay according to a second embodiment;

FIG. 29 is a block diagram for describing driving of a power supply relay and a reverse connection protection relay according to a third embodiment;

FIG. 30 is a block diagram for describing an ECU according to the first embodiment;

FIG. 31 is a block diagram for describing an ECU according to a fourth embodiment;

FIG. 32 is a block diagram for describing an ECU according to a fifth embodiment;

FIG. 33 is a block diagram for describing an ECU according to a sixth embodiment;

FIG. 34 is a schematic diagram illustrating an arrangement in a case where motor windings have three systems;

FIG. 35 is a block diagram for describing an ECU according to a seventh embodiment;

FIG. 36 is a block diagram for describing an ECU according to an eighth embodiment;

FIG. 37 is a block diagram for describing an ECU according to a ninth embodiment;

FIG. 38 is a block diagram for describing computation timing according to the ninth embodiment;

FIG. 39 is a block diagram for describing an ECU according to a tenth embodiment;

FIG. 40 is a time chart for describing the operation of a motor relay according to the tenth embodiment;

FIG. 41 is a schematic diagram for describing a substrate arrangement according to an eleventh embodiment;

FIG. 42 is a schematic diagram for describing a substrate arrangement according to the eleventh embodiment;

FIG. 43 is a schematic diagram for describing a substrate arrangement according to a twelfth embodiment;

FIG. 44 is a block diagram for describing an ECU according to the twelfth embodiment;

FIG. 45 is a block diagram for describing an ECU according to a thirteenth embodiment;

FIG. 46 is a time chart for describing the operation of a motor relay according to the thirteenth embodiment;

FIG. 47 is a time chart for describing the operation of the motor relay according to the thirteenth embodiment;

FIG. 48 is a schematic diagram for describing a substrate arrangement according to a fourteenth embodiment;

FIG. 49 is a schematic diagram for describing a substrate arrangement according to a fifteenth embodiment;

FIG. 50 is a plan view illustrating a driver component according to a sixteenth embodiment;

FIG. 51 is a cross-sectional view taken along line LI-LI of FIG. 50;

FIG. 52 is a cross-sectional view taken along line LII-LII of FIG. 50;

FIG. 53 is a plan view illustrating a driver component according to a seventeenth embodiment;

FIG. 54 is a cross-sectional view taken along line LIV-LIV OF FIG. 53;

FIG. 55 is a cross-sectional view taken along line LV-LV of FIG. 53;

FIG. 56 is a plan view illustrating a driver component according to an eighteenth embodiment;

FIG. 57 is a block diagram illustrating a microcomputer and a driver component according to a nineteenth embodiment;

FIG. 58 is an explanatory diagram for describing an isolator according to the nineteenth embodiment;

FIG. 59 is an explanatory diagram for describing an input/output signal of the isolator according to an enable signal according to the nineteenth embodiment;

FIG. 60 is a flowchart for describing a communication process according to the nineteenth embodiment;

FIG. 61 is a time chart for describing a communication process at the time when the microcomputer normally operates according to the nineteenth embodiment;

FIG. 62 is a time chart for describing the communication process in a case where one of the microcomputers according to the nineteenth embodiment is abnormal;

FIG. 63 is a flowchart for describing a communication process according to a twentieth embodiment;

FIG. 64 is a time chart for describing the communication process according to the twentieth embodiment;

FIG. 65 is a block diagram illustrating a microcomputer and a driver component according to a twenty-first embodiment;

FIG. 66 is a flowchart for describing a communication process according to the twenty-first embodiment;

FIG. 67 is a time chart for describing the communication process according to the twenty-first embodiment;

FIG. 68 is a block diagram illustrating a microcomputer and a driver component according to a twenty-second embodiment;

FIG. 69 is a block diagram illustrating a microcomputer and a driver component according to a twenty-third embodiment;

FIG. 70 is a block diagram illustrating a data flow in the microcomputer and the driver component according to the twenty-third embodiment;

FIG. 71 is a block diagram for describing inter-driver communication at the time when the microcomputer normally operates in the twenty-third embodiment;

FIG. 72 is a block diagram for describing inter-driver communication during a microcomputer abnormality in a second control system in the twenty-third embodiment;

FIG. 73 is a flowchart for describing microcomputer-to-driver communication according to the twenty-third embodiment;

FIG. 74 is a flowchart for describing inter-driver communication according to the twenty-third embodiment;

FIG. 75 is a time chart for describing a communication process at the time when the microcomputer normally operates according to the twenty-third embodiment;

FIG. 76 is a time chart for describing the communication process in a case where one of the microcomputers according to the twenty-third embodiment is abnormal;

FIG. 77 is a block diagram illustrating a microcomputer and a driver component according to a twenty-fourth embodiment;

FIG. 78 is a time chart illustrating transmission and reception data in the microcomputer and the driver component according to the twenty-fourth embodiment;

FIG. 79 is a flowchart for describing microcomputer-to-driver communication according to the twenty-fourth embodiment; and

FIG. 80 is a time chart for describing a communication process according to the twenty-fourth embodiment.

### DETAILED DESCRIPTION

In a motor control device of a related art, there is a possibility that the motor cannot be continuously driven in a case where a further failure occurs during control continuation at the time of occurrence of one failure. The present disclosure provides a communication device capable of continuing control as much as possible even when an abnormality occurs.

According to an aspect of the present disclosure, a communication device includes a plurality of controllers and a plurality of electronic components. The controller includes at least one processing circuit. The electronic components are provided corresponding to the controllers and the electronic component is digitally communicably connected to a corresponding controller. Assuming that a combination of a controller and an electronic component that are provided correspondingly is a control system, and a communication line connecting the controller and the electronic component provided correspondingly is an intra-system communication line, an inter-system connection line connects (i) intra-system communication lines of different control systems, (ii) an intra-system communication line and an electronic component of another control system, or (iii) electronic components of different control systems.

Accordingly, it is possible to increase the possibility of control continuity at the time of failure occurrence with a relatively simple configuration.

Hereinafter, a communication device according to the present disclosure will be described with reference to the drawings. Hereinafter, in a plurality of embodiments, substantially the same components are denoted by the same reference numerals, and description thereof is omitted.

### First Embodiment

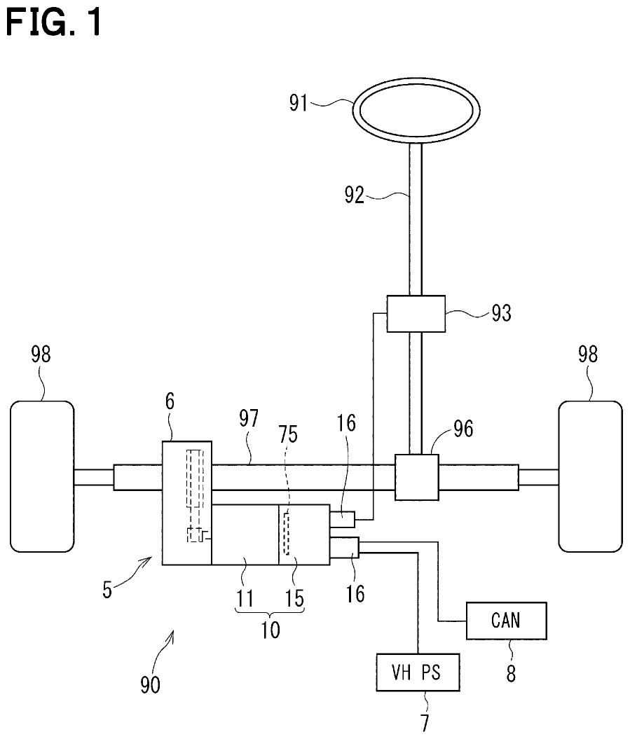

A first embodiment is illustrated in FIGS. 1 to 27. As illustrated in FIG. 1, a drive device 10 includes a motor 11 and an ECU 15 as a communication device, and is applied to, for example, an electric power steering device 5 which is a steering device for assisting a steering operation of a vehicle. FIG. 1 illustrates an overall configuration of a steering system 90 including the electric power steering device 5. The steering system 90 includes a steering wheel 91 which is a steering member, a steering shaft 92, a pinion gear 96, a rack shaft 97, wheels 98, the electric power steering device 5, and the like.

The steering wheel 91 is connected to the steering shaft 92. The steering shaft 92 is provided with a torque sensor 93 that detects steering torque. The pinion gear 96 is provided at a distal end of the steering shaft 92. The pinion gear 96 meshes with the rack shaft 97. A pair of wheels 98 is coupled to both ends of the rack shaft 97 via tie rods or the like.

When a driver rotates the steering wheel 91, the steering shaft 92 connected to the steering wheel 91 rotates. The rotational movement of the steering shaft 92 is converted into a linear movement of the rack shaft 97 by the pinion gear 96. The pair of wheels 98 is steered at an angle corresponding to the displacement amount of the rack shaft 97.

The electric power steering device 5 includes the drive device 10, a reduction gear 6 as a power transmission unit that decelerates the rotation of the motor 11 and transmits the rotation to the rack shaft 97, and the like. The electric power steering device 5 of the present embodiment is a so-called “rack assist type”, but may be a so-called “column assist type” or the like that transmits the rotation of the motor 11 to the steering shaft 92.

The drive device 10 is a so-called “electromechanical integrated type” in which the ECU 15 is integrally provided on one side of the motor 11 in the axial direction. The ECU 15 includes a connector 16, and is connected to a vehicle power supply 7, a vehicle communication network 8, and the torque sensor 93 via the connector 16. The vehicle power supply 7 includes power supplies 501 and 502 described later. The vehicle communication network 8 is, for example, a controller area network (CAN), and is described as a “CAN” in the figure. In the figures, “PS” represents power supply, “OSC” represents oscillator, “MCP” represents microcomputer. Also, “VH” represents vehicle, and “TRQ” represents torque. “CMND” represents command, “INF” represents information, “ARBT” represents arbitration and “RC” represents reverse connection. “SGN” represents signal, “STP-Dwn”represents Step down. “COMM” represents communication.

The ECU 15 is disposed coaxially with the motor 11 and opposite to the output shaft of the motor 11. Here, “coaxial” means that, for example, an error or deviation regarding assembly or design is permitted. Hereinafter, the axial direction of the motor 11 is regarded as the axial direction of the drive device 10, and is simply referred to as the “axial direction”. The same applies to the “radial direction” and the “circumferential direction”.

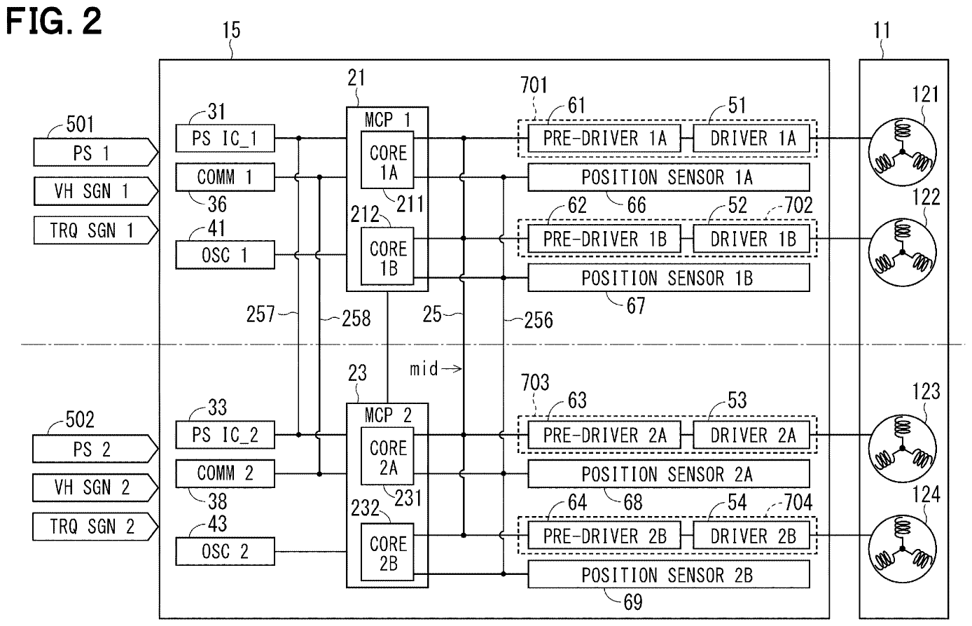

As illustrated in FIG. 2, the motor 11 is, for example, a three-phase brushless motor, and includes four motor windings 121 to 124. The motor 11 outputs part or all of the torque required for steering, is driven by power supplied from the power supplies 501 and 502, and rotates the reduction gear 6 forward and backward.

The ECU 15 includes microcomputers 21 and 23, power supply ICs 31 and 33, communication units 36 and 38, oscillators 41 and 43, driver circuits 51 to 54, pre-driver ICs 61 to 64, position sensors 66 to 69, and the like. Note that the description of suffixes “1”, “2”, “1A”, “2A”, “1B”, “2B”, and the like indicates that they are provided correspondingly, and reference numerals are appropriately omitted for configurations that can be identified by suffixes. Each component constituting the ECU 15 is mounted on a substrate 75 provided substantially parallel to one side end face of the motor 11 in the axial direction (see FIG. 1). Although one substrate 75 is illustrated in FIG. 1, a plurality of substrates may be provided.

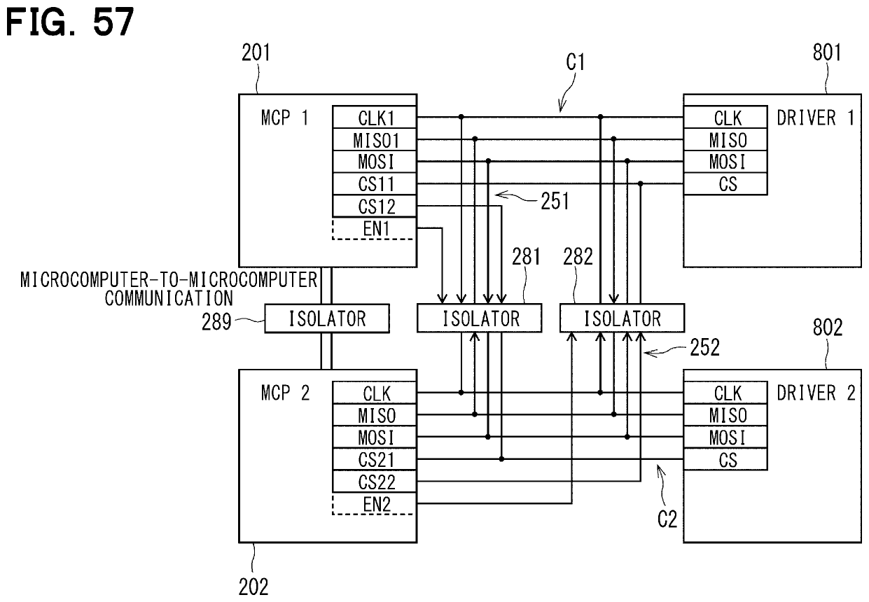

The microcomputer 21 includes processing cores 211 and 212 each having a lockstep. The microcomputer 23 includes processing cores 231 and 232 each having a lockstep. The microcomputers 21 and 23 are provided to be able to transmit and receive information to and from each other by microcomputer-to-microcomputer communication via an isolator 289 between the microcomputers (see FIG. 57). In the present embodiment, the microcomputers 21 and 23 are similarly configured, but may have different performances and configurations. The microcomputers 21 and 23 will be described later in detail.

Power is supplied to the microcomputer 21 from the power supply IC 31, and power is supplied to the microcomputer 23 from the power supply IC 33. The power supply ICs 31 and 33 are power management ICs (PMIC). In the present embodiment, power is supplied from the power supply 501 to the component on the upper side of the alternate long and short dash line in FIG. 2, and power is supplied from the power supply 502 to the component on the lower side of the alternate long and short dash line. That is, the drive device 10 of the present embodiment has “two power supply systems” to which power is supplied from the two power supplies 501 and 502.

The communication units 36 and 38 are used to transmit and receive various types of information. The communication units 36 and 38 are connected to the vehicle communication network 8 and acquire a vehicle signal from the vehicle communication network 8. The oscillators 41 and 43 are clock sources such as a crystal oscillator and a ceramic oscillator.

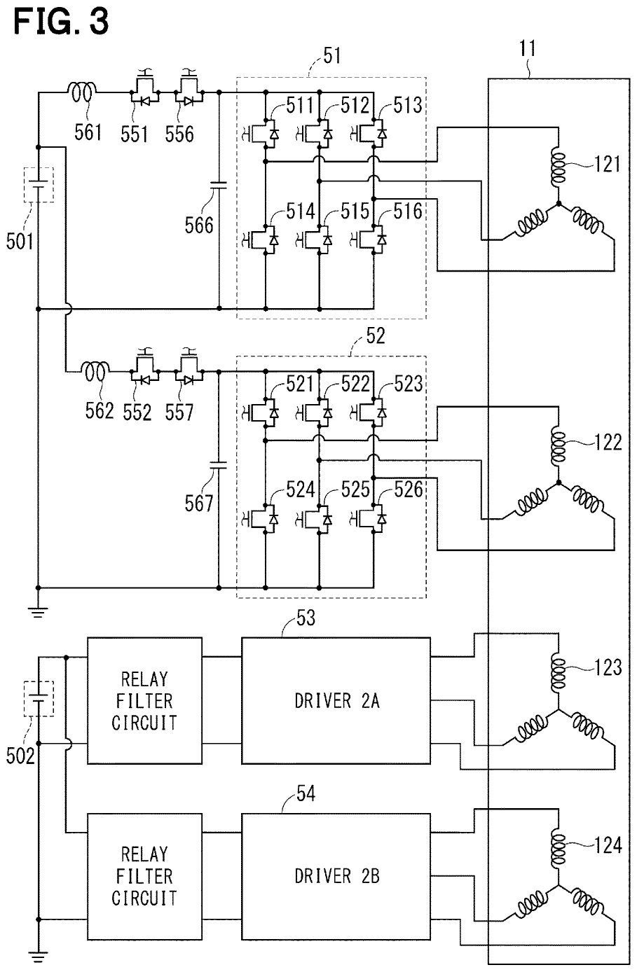

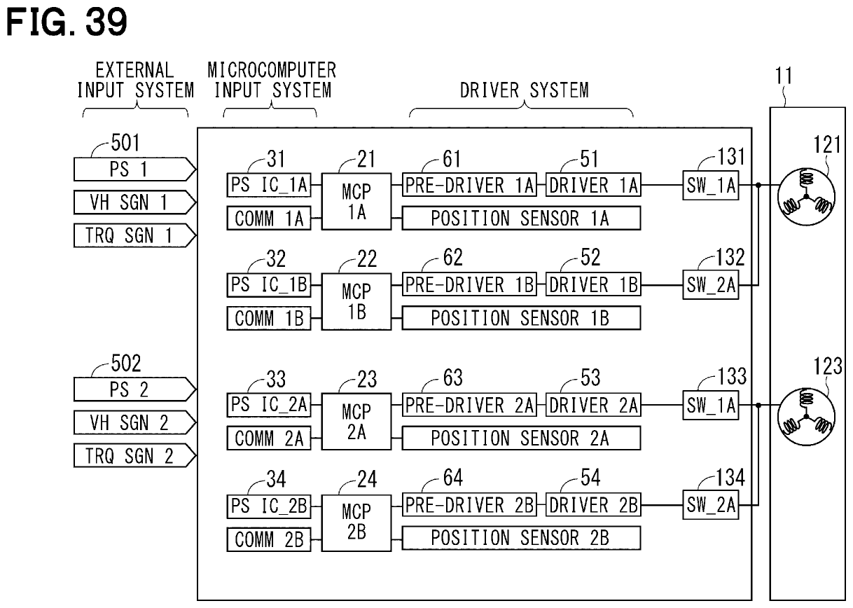

As illustrated in FIG. 3, the driver circuit 51 includes six switching elements 511 to 516 and is provided corresponding to the winding 121. The driver circuit 52 includes six switching elements 521 to 526 and is provided corresponding to the winding 122. The driver circuit 53 includes six switching elements and is provided corresponding to the winding 123. The driver circuit 54 includes six switching elements and is provided corresponding to the winding 124. Motor relays 131 to 134 are provided between the driver circuits 51 to 54 and the windings 121 to 124 (see FIG. 39).

In the driver circuit 51, the switching elements 511 to 513 are provided on the high potential side, and the switching elements 514 to 516 are provided on the low potential side, and they are bridge-connected. The switching elements 511 and 514 are connected to the U phase of the winding 121, the switching elements 512 and 515 are connected to the V phase of the winding 121, and the switching elements 513 and 516 are connected to the W phase of the winding 121.

In addition, in the driver circuit 52, the switching elements 521 to 523 are provided on the high potential side, and the switching elements 524 to 526 are provided on the low potential side, and they are bridge-connected. The switching elements 521 and 524 are connected to the U phase of the winding 122, the switching elements 522 and 525 are connected to the V phase of the winding 122, and the switching elements 523 and 526 are connected to the W phase of the winding 122. Hereinafter, the switching element on the high potential side is referred to as an upper arm element, and the switching element on the low potential side is referred to as a lower arm element as appropriate. The switching element of the present embodiment is a MOSFET, but may be an IGBT, a bipolar transistor, or the like.

The driver circuits 51 and 52 are connected to the power supply 501. A power supply relay 551, a reverse connection protection relay 556, a choke coil 561, and a capacitor 566 are provided between the power supply 501 and the driver circuit 51. The choke coil 561 and the capacitor 566 constitute a filter circuit. A power supply relay 552, a reverse connection protection relay 557, a choke coil 562, and a capacitor 567 are provided between the power supply 501 and the driver circuit 52. The choke coil 562 and the capacitor 567 constitute a filter circuit. The driver circuits 53 and 54 are connected to the power supply 502. The circuit configurations of the driver circuits 53 and 54, and the power supply relay, the reverse connection protection relay, and the filter circuit provided between the power supply 502 and the driver circuits 53 and 54 are similar to those of the driver circuits 51 and 52, the power supply relays 551 and 552, and the like, and thus the description thereof will be omitted.

Returning to FIG. 2, the pre-driver ICs 61 to 64 are provided corresponding to the driver circuits 51 to 54. The pre-driver ICs 61 and 62 are provided to be capable of performing digital communication with the microcomputer 21, and the pre-driver ICs 63 and 64 are provided to be capable of performing digital communication with the microcomputer 23. The microcomputers 21 and 23 transmit three-phase drive commands of the motor 11 as a set of digital signals to each of the pre-driver ICs 61 to 64.

Specifically, the pre-driver IC 61 is communicably connected to the processing core 211, the pre-driver IC 62 is communicably connected to the processing core 212, the pre-driver IC 63 is communicably connected to the processing core 231, and the pre-driver IC 64 is communicably connected to the processing core 232. In addition, the communication lines connecting the pre-driver ICs 61 to 64 and the processing cores 211, 212, 231, and 232 are connected by an inter-system connection line 25.

By digitizing communication between the microcomputer and the pre-driver and providing the inter-system connection line 25, for example, even in a case where an abnormality occurs in one processing core, commands from other normal processing cores to all the pre-driver ICs 61 to 64 can be continued. Note that the inter-system connection line 25 means that four connection lines connecting the cores and the pre-driver ICs are connected so as to have the same potential. Therefore, for example, even if a disconnection occurs at a location indicated by an arrow “mid” in FIG. 2, signal transmission and reception can be performed between the processing cores 1A and 1B and the pre-drivers 2A and 2B.

The inter-system connection line 25 is provided with an isolator 28 to be described later (not illustrated in FIG. 2). The isolator 28 may be provided at any position of the inter-system connection line 25. In addition, a similar effect can be obtained by imparting an isolator function to a necessary component.

The position sensors 66 to 69 detect the rotation of the motor 11. The position sensors 66 to 69 are connected to the processing cores 211, 212, 231, and 232, respectively. The communication lines connecting the position sensors 66 to 69 and the microcomputers 21 and 23 are connected by an inter-system connection line 256. The communication lines connecting the power supply ICs 31 and 33 and the microcomputers 21 and 23 are connected by an inter-system connection line 257, and the communication lines connecting the communication units 36 and 38 and the microcomputers 21 and 23 are connected by an inter-system connection line 258. Note that the inter-system connection line 256 to 258 may be omitted.

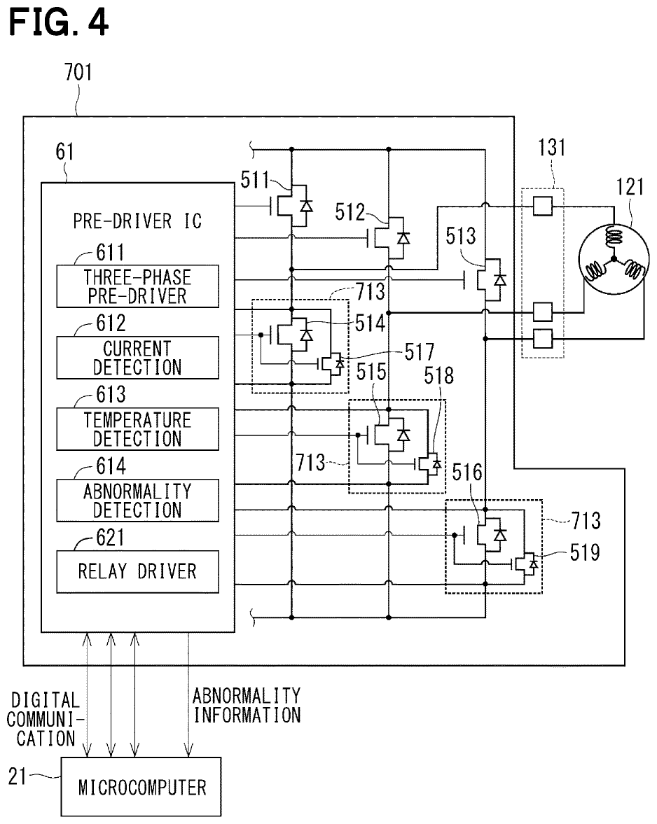

The pre-driver IC will be described with reference to FIG. 4. Here, the pre-driver IC 61 will be described as a representative example. As illustrated in FIG. 4, the pre-driver IC 61 includes a three-phase pre-driver circuit 611 that transmits a gate signal to the switching element constituting the driver circuit 51. In addition, the pre-driver IC 61 includes a current detection circuit 612, a temperature detection circuit 613, an abnormality detection unit 614, a relay driver circuit 621, and the like.

The pre-driver circuit 611 outputs a gate signal as a drive signal to the switching elements 511 to 516 based on a drive command from the microcomputer 21. The current detection circuit 612 detects a motor current based on detection values of current detection elements 517 to 519. Each of the current detection elements 517 to 519 of the present embodiment is a current sense MOS and is built in a low-side chip 713 to be described later. The current sense MOS may be built in a high-side chip 712 or may be a chip different from the upper and lower arm elements.

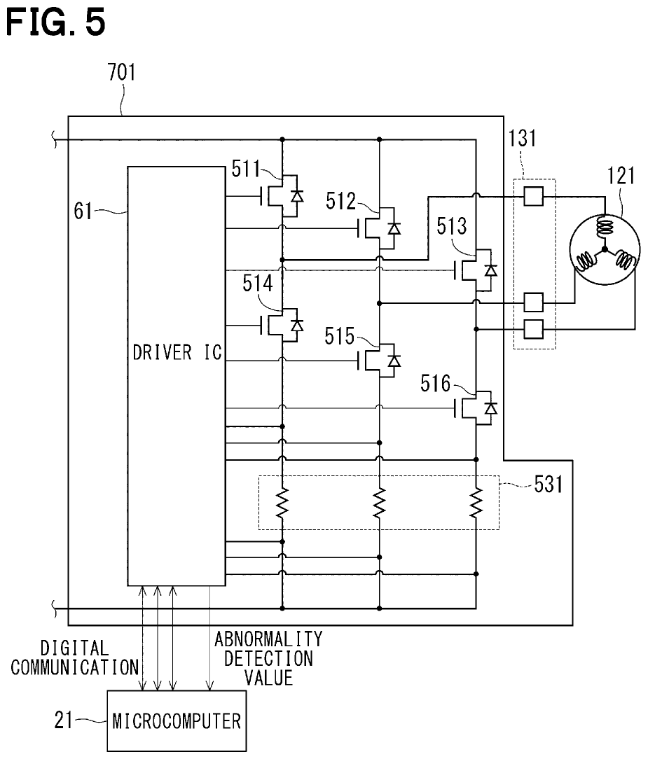

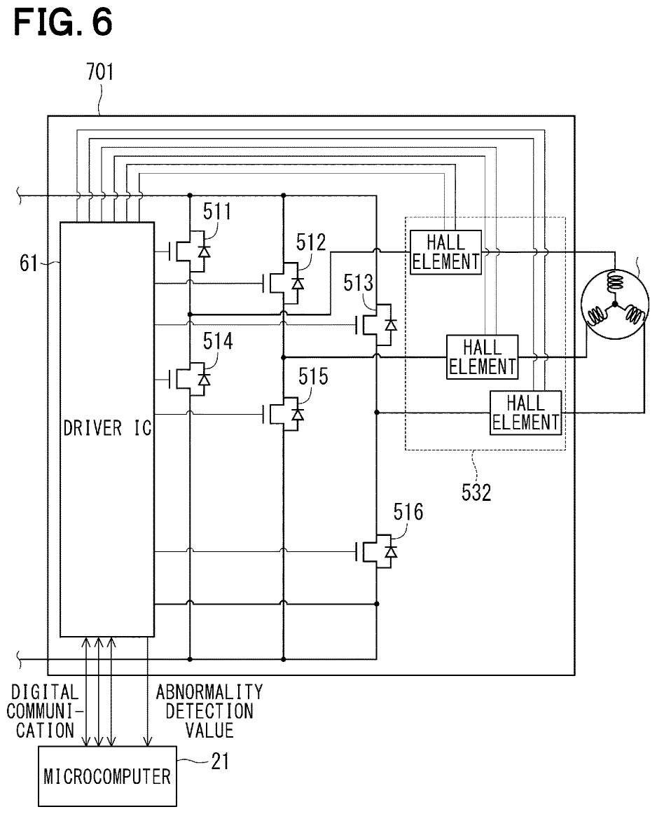

As illustrated in FIG. 5, the current detection element 531 may be a shunt resistor provided in an arm of each phase. In the example of FIG. 5, the shunt resistor is provided on the low potential side of the lower arm element, but may be provided on the high potential side of the upper arm element. Furthermore, as illustrated in FIG. 6, the current detection element 532 may be a Hall element provided between a connection point of the upper and lower arm elements and the motor winding. In FIGS. 5 and 6, the current detection elements 531 and 532 are described as being provided in the driver component 701 to be described later, but may be provided outside the driver component 701. In FIG. 6, the description of the motor relay 131 is omitted.

Returning to FIG. 4, the temperature detection circuit 613 detects the temperatures of the driver circuit 50 and the pre-driver IC 60 based on a detection value of a temperature detection element (not illustrated). The abnormality detection unit 614 monitors an abnormality of the driver circuit 50 based on a gate-source potential difference and a drain-source potential difference of the element constituting the driver circuit 50, and a drive command from the microcomputer 21. For example, the abnormality detection unit 614 monitors an abnormality such as a short circuit or a terminal open based on a potential difference. In addition, the abnormality detection unit 614 monitors an overheating abnormality based on temperature information and an abnormality of the pre-driver IC 61 itself.

The relay driver circuit 621 outputs a gate signal as a drive signal to the power supply relay 551, the reverse connection protection relay 556, and the motor relay 131 based on a drive command from the microcomputer 21.

The pre-driver IC 61 transmits the current detection value, the temperature information, and the abnormality information to the microcomputer 21. Information transmission from the pre-driver IC 61 to the microcomputer 21 may be digital communication or analog communication.

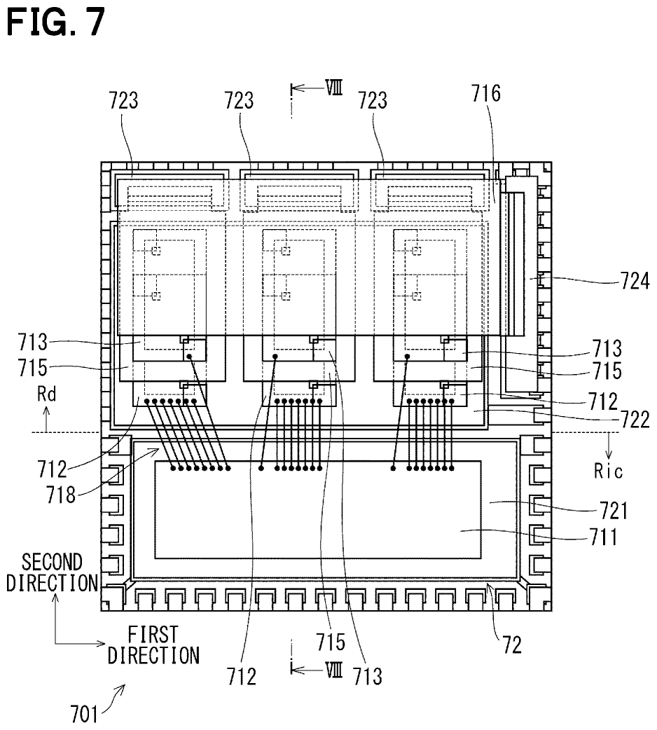

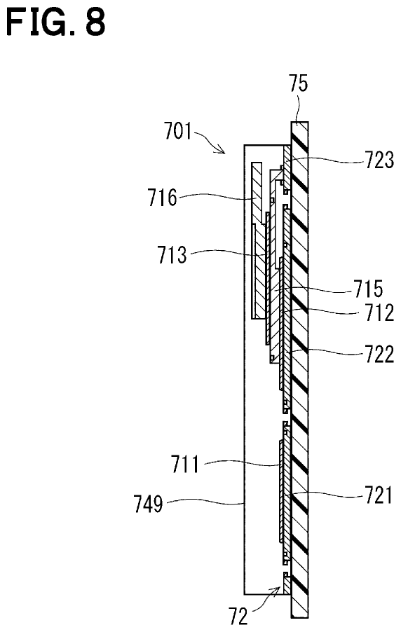

In the present embodiment, the driver circuits 51 to 54 and the pre-driver ICs 61 to 64 that are provided correspondingly are provided as respective driver components 701 to 704 in the common package. FIGS. 7 and 8 illustrate the driver component 701 including the driver circuit 51 and the pre-driver IC 61. In FIG. 7, a sealing unit 749 is omitted in order to describe the inside of the component, and in FIG. 8, hatching of the sealing unit 749 is omitted.

As illustrated in FIGS. 7 and 8, the driver component 701 includes a control chip 711, a high-side chip 712, a low-side chip 713, an intermediate clip 715, a ground clip 716, a lead frame 72, and the like, and is sealed by the sealing unit 749. The sealing unit 749 is formed in a substantially rectangular shape in plan view, and has a terminal along the outer edge. Regardless of the terminal arrangement and shape, the terminal may be a non-lead type or may be formed to protrude to the outside of the sealing unit 749. The driver component 701 is provided with a temperature detection element such as a temperature sensitive diode. As in the current detection elements 517 to 519, the temperature detection element may be built in the high-side chip 712 or the low-side chip 713.

The lead frame 72 includes a control land 721, a power land 722, an output land 723, and a ground land 724. The rear face of the lead frame 72 is exposed from the sealing unit 749 and is electrically connected to the wiring pattern of the substrate 75 by solder bonding or the like. Note that not all the lands are required to be connected to the substrate 75 on the back face. Hereinafter, a region on the control land 721 side is referred to as an IC region Ric, and a region on the power land 722 side is referred to as a drive element region Rd. Further, in the driver component 701, an end portion on the power land 722 side (the upper side of the sheet of FIG. 7) is defined as an element-side end portion, and an end portion on the control land 721 side (the lower side of the sheet of FIG. 7) is defined as an IC-side end portion.

The control chip 711 constitutes the pre-driver IC 61 and is disposed on the control land 721. In the present embodiment, the control land 721 on which the control chip 711 is mounted has the ground potential, but in a case of using a control land on which the back face of the control chip 711 is insulated, the potential of the control land 721 may be a potential other than the ground potential, such as a power supply potential.

A control terminal, which is a terminal provided in a control region Rc, is connected to the microcomputer 21, the power supply IC 31, other pre-driver ICs 62 to 64, and the like. The control terminal includes a clock signal terminal, a PWM frequency synchronization terminal, a sample hold terminal, and the like. In a case where communication between the microcomputer 21 and the pre-driver IC 61 is, for example, SPI communication, a chip select terminal, a MISO terminal, a MOSI terminal, and the like are included.

The upper arm element of each phase is built in each of the three high-side chips 712, and the lower arm element of each phase is built in each of the three low-side chips 713. In addition, the current detection elements 517 to 519 are built in the low-side chip 713.

The three high-side chips 712 are disposed on the power land 722 which is a power supply potential, and the high-side chips 712 are disposed side by side so that the gate electrode faces the control chip 711 and is along the long side of the control chip 711. In the high-side chip 712, a source electrode faces upward, and a drain electrode provided on the back side is connected to the power land 722. On the upper side of the high-side chip 712, the intermediate clip 715, the low-side chip 713, and the ground clip 716 are stacked in this order from the high-side chip 712 to form a stack structure.

The intermediate clip 715 is, for example, a conductive metal plate made of copper or the like, and is provided for every three high-side chips 712. The intermediate clip 715 is connected to the source electrode of the high-side chip 712 at the lower face, and is connected to the drain electrode of the low-side chip 713 at the upper face. The intermediate clip 715 is disposed to be shifted to such an extent that a signal line 718 can be connected to the control chip 711 of the high-side chip 712. The end portion of the intermediate clip 715, the end portion being opposite to the control chip 711, is bent downward and connected to the output land 723. The output land 723 is connected to the motor terminal, and is connected to each phase of the motor winding 121 via the board wiring or the like.

Assuming that a direction in which high-side chips 712 are adjacent to each other is a width direction (in the figure, a “first direction”), the intermediate clip 715 is formed to be away from the adjacent frame in the width direction to such an extent that insulation can be ensured, and to be wider than the high-side chip 712. The area of the intermediate clip 715 is formed larger than that of the high-side chip 712. By forming the area of the intermediate clip 715 as large as possible, the heat dissipation efficiency is enhanced.

The ground clip 716 is a conductive plate made of copper or the like, for example, and is provided across the three low-side chips 713. The ground clip 716 is disposed to be shifted to such an extent that the signal line 718 can be connected at the control chip 711 side of the low-side chip 713. The ground clip 716 is bent downward on one side in the width direction and connected to the ground land 724. In the present embodiment, the ground clip 716 is provided in the sealing unit 749, but the top face may be exposed from the sealing unit 749.

The high-side chip 712 and the low-side chip 713 are connected to the control chip 711 by the signal line 718. In the present embodiment, although the high-side chip and the low-side chip are stacked, the high-side chip 712 and the low-side chip 713 are shifted from each other and stacked in a stepwise manner, and a non-overlapping region that does not overlap with a component provided on the upper side is ensured. Therefore, the signal line 718 can be connected in the non-overlapping region. The connection ends of the signal lines 718 on the control chip 711 side are aggregated on one side of the control chip 711. The signal lines 718 include those for gate driving, current detection, and temperature detection. As a result, the drive element region Rd to which a large current is applied and the IC region Ric can be spatially divided inside the driver component 701.

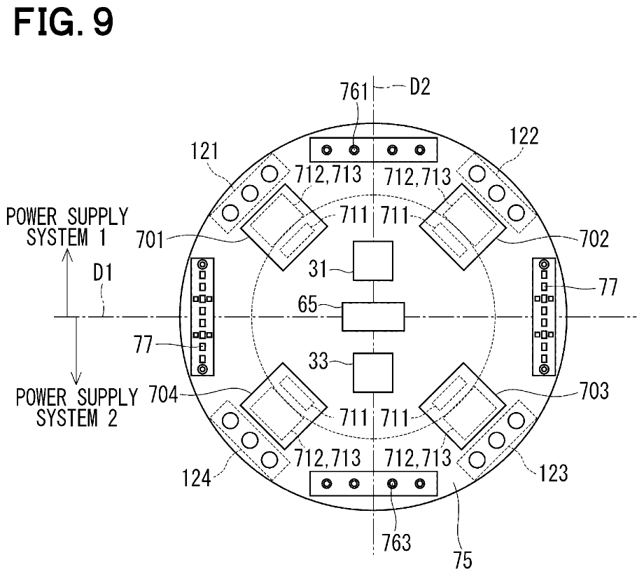

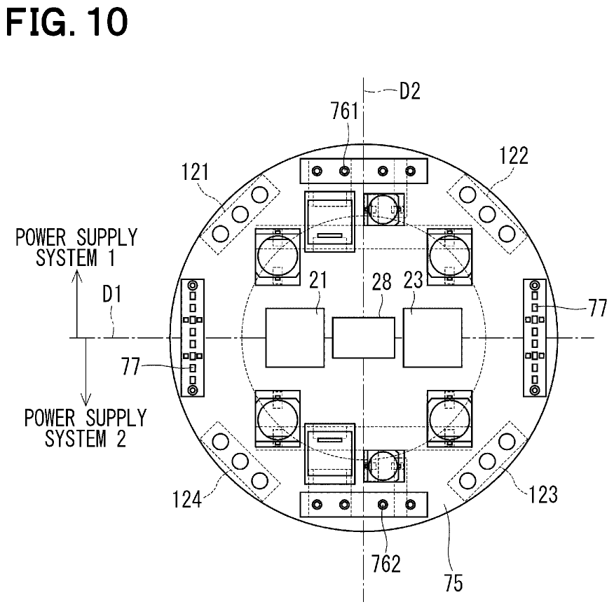

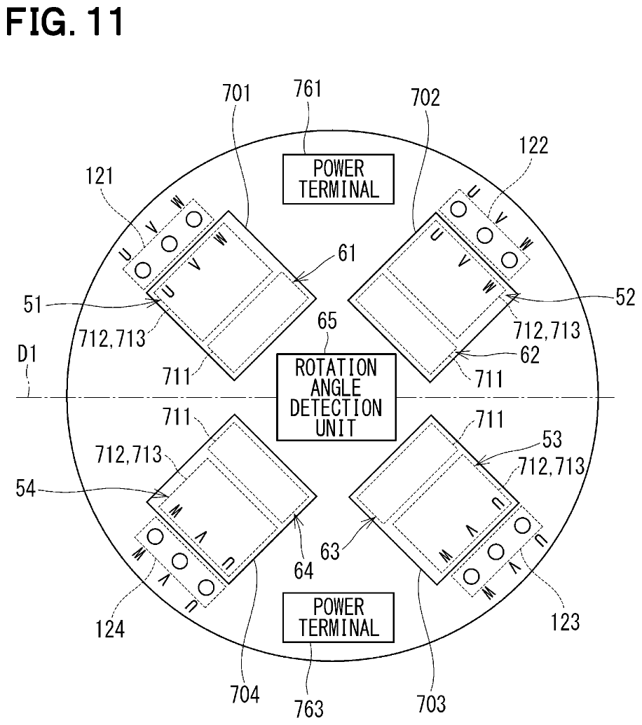

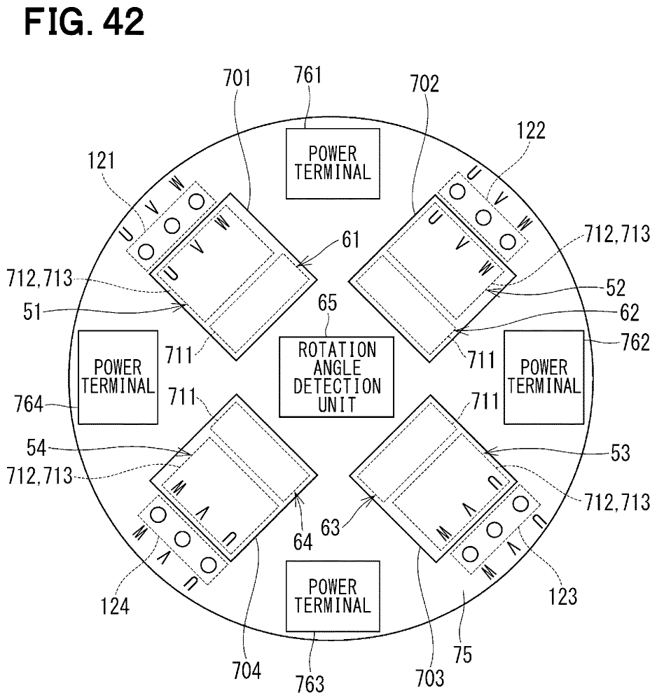

The component arrangement on the substrate 75 is illustrated in FIGS. 9 to 11. FIGS. 9 and 11 illustrate a face of the substrate 75, the face being close to the motor 11, and FIG. 10 illustrates a face of the substrate 75, the face being opposite to the motor 11. FIG. 11 schematically illustrates the arrangement of the driver components 701 to 704 and the motor windings 121 to 124 on the substrate 75. The same applies to FIG. 42 and the like.

As illustrated in FIGS. 9 and 11, the driver components 701 to 704 are mounted on the substrate 75. The four driver components 701 to 704 are provided on a face of the substrate 75, the face being close to the motor 11. The four driver components 701 to 704 are disposed on concentric circles at substantially equal intervals. The driver components 701 and 702 and the driver components 703 and 704 are disposed line-symmetrically with respect to a substrate division line D1. The substrate division line D1 is a division line that divides regions having different power supplies.

The driver components 701 to 704 are disposed so that the element side end portions face radially outward. The motor windings 121 to 124 are connected to the substrate 75 at the radially outer side of the driver components 701 to 704. That is, the control chip 711, the high-side chip 712, the low-side chip 713, and the motor wire connection unit are disposed in this order from the radially inner side. The extraction wires of the motor windings 121 to 124 are disposed substantially parallel to the element-side end portions of the driver components 701 to 704 so as to correspond to the phase arrangement of the switching elements in the driver components 701 to 704. The phase arrangement illustrated in FIG. 11 is an example, and may be different. In FIGS. 9 to 11, the winding connection portions to which the extraction wires of the motor windings are connected are numbered as the motor windings 121 to 124. The same applies to the power terminal and the signal terminal.

On the face of the substrate 75, the face being close to the motor 11, a rotation detection unit 65 is mounted at a position facing a magnet provided at an end of a shaft (not illustrated) of the motor 11. In the present embodiment, the rotation detection unit 65 is mounted at the center of the substrate 75. The rotation detection unit 65 includes the position sensors 66 to 69.

The power terminals 761 and 763 are connected to a region at the outer edge of the substrate 75 and across a substrate center line D2 orthogonal to the substrate division line D1. Each of the power terminals 761 and 763 includes a power supply terminal and a ground terminal. Power from the power supply 501 is supplied to the power terminal 761, and power from the power supply 502 is supplied to the power terminal 763. On the substrate 75, the power supply ICs 31 and 33 are mounted between the rotation detection unit 65 and the power terminals 761 and 763 on the substrate center line D2. The power supply ICs 31 and 33 may be disposed at positions other than the substrate center line D2 as long as the power supply ICs 31 and 33 are easily connected to the power terminals 761 and 763 and the microcomputers 21 and 23. In addition, a signal terminal 77 is connected to a region at the outer edge of the substrate 75 and across the substrate division line D1.

As illustrated in FIG. 10, the microcomputers 21 and 23 are mounted on the face opposite to the motor 11, on both sides across the substrate center line D2 on the substrate division line D1. Power is supplied from the power terminal 761 to the microcomputer 21, and a wiring pattern is formed so that power is supplied from the power terminal 763 to the microcomputer 23. The microcomputers 21 and 23 are communicably connected, and the isolator 28 is mounted at a connection portion between the microcomputers 21 and 23. In the present embodiment, the isolator 28 is provided at the center of the substrate. The components such as a capacitor and a coil constituting a filter circuit are mounted on a face opposite to the motor 11.

In the present embodiment, the drive device 10 is applied to the electric power steering device 5. In a case where the drive device 10 is applied not only to the electric power steering device 5 but also to, for example, a main motor or a brake motor, various components may be made redundant so that safety can be secured even in a case where a failure occurs in some components.

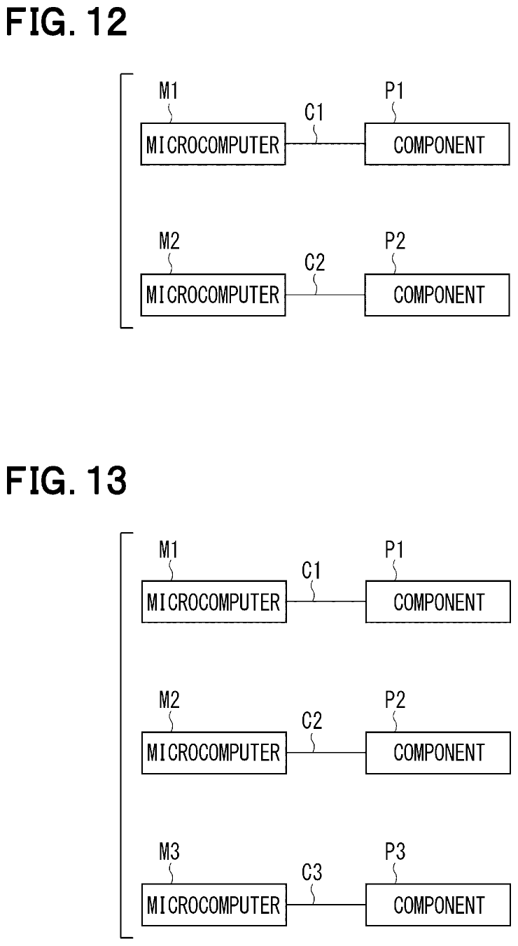

FIGS. 12 to 15 conceptually illustrate a communication configuration between the microcomputer and the component. As illustrated in FIG. 12, assuming that the combinations of the microcomputers (or the processing cores) M1 and M2 communicably connected by the communication lines C1 and C2 and the components P1 and P2 are the control systems, in a case where a failure occurs in the microcomputer M1 or the component P1 which is the first control system, the microcomputer M2 and the component P2 which are the second control system can continue to operate with 50% of the function remaining. Here, in a case where a failure occurs in any part of the second control system, the control cannot be continued. In the present embodiment, the communication lines C1 and C2 correspond to “intra-system communication lines”.

As illustrated in FIG. 13, as further redundancy, for example, in a case where the three control systems are provided, it is possible to continue the operation with 66% of the function remaining in the first failure, and it is possible to continue the operation with 33% of the function remaining in the remaining one control system even in a case where the further failure occurs during the operation continuation in the first failure and the two control systems. However, when the number of control systems is increased, the number of components is increased.

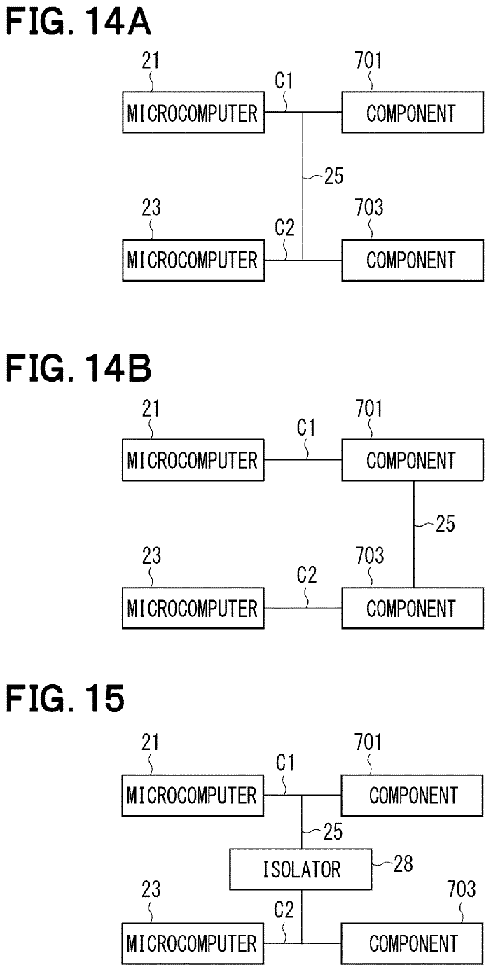

As illustrated in FIGS. 14A and 14B, the microcomputers M1 and M2 correspond to the microcomputers 21 and 23, respectively, and the components P1 and P2 correspond to the driver components 701 and 703, respectively. The driver components 701 and 703 include the pre-driver ICs 61 and 63 for controlling the driver circuits 51 and 53, and output drive signals for driving the driver circuits 51 and 53 according to commands transmitted from the microcomputers 21 and 23. Current detection values, driver outputs, abnormality information, temperature information, and the like are transmitted from the driver components 701 and 703 to the microcomputers 21 and 23.

As illustrated in FIG. 14A, in a case where the driver components 701 and 703 are capable of digital communication, the communication line C1 of the first system and the communication line C2 of the second system are connected to each other by the inter-system connection line 25, so that, for example, in a case where a failure occurs in the microcomputer 21, the microcomputer 23 commands the driver components 701 and 703. As a result, the control can be continued. When the second failure occurs in any one of the driver components 701 and 703, the control can be continued by the normal microcomputer and the normal driver component. As a result, even in the case of the two control systems, it is possible to increase the possibility of operation continuity at the time of failure. As illustrated in FIG. 14B, the inter-system connection line 25 may connect the driver components 701 and 703.

Communication between the microcomputers 21 and 23 and the components 701 and 703 is, for example, SPI communication, but may be a communication method other than SPI, such as PSI5, SENT, CAN, Ethernet, or Flexray, or may be wireless communication. Although one communication line is illustrated in FIG. 14A and the like, the number of communication lines and the number of terminals can be set in any number according to a communication method and the like.

As illustrated in FIG. 14A, in a case where the communication lines C1 and C2 are connected by the inter-system connection line 25, there is a failure mode in which all the connected microcomputers and components fail to operate in a case where the communication line is connected to the power supply or the ground and voltage is fixed. In addition, in a case where the microcomputers M1 and M2 are connected to different power supplies, there is a possibility of failure due to application of a high voltage to the normal system or inflow of a large current because of a failure of one control system.

Therefore, as illustrated in FIG. 15, the isolator 28 as a system separation component is provided at a location where it is not desired to cause simultaneous failures. Note that the description of the isolator 28 is omitted in FIG. 2 and the like. In the example of FIG. 15, the isolator 28 is provided in the inter-system connection line 25, but may be provided inside the microcomputers M1 and M2 or the components P1 and P2, for example. As a configuration for separating the systems, it is sufficient that information can be transmitted while a potential difference is maintained, and for example, an optical insulation type, a magnetic insulation type, or a capacitance insulation type can be used. In addition, the system separation component may be provided with, for example, a passive element such as a resistor, a buffer, or the like instead of the isolator. In addition, by using wireless communication as the communication, a tailgating failure may not occur. The same applies to isolators 281 to 283 in an embodiment described later.

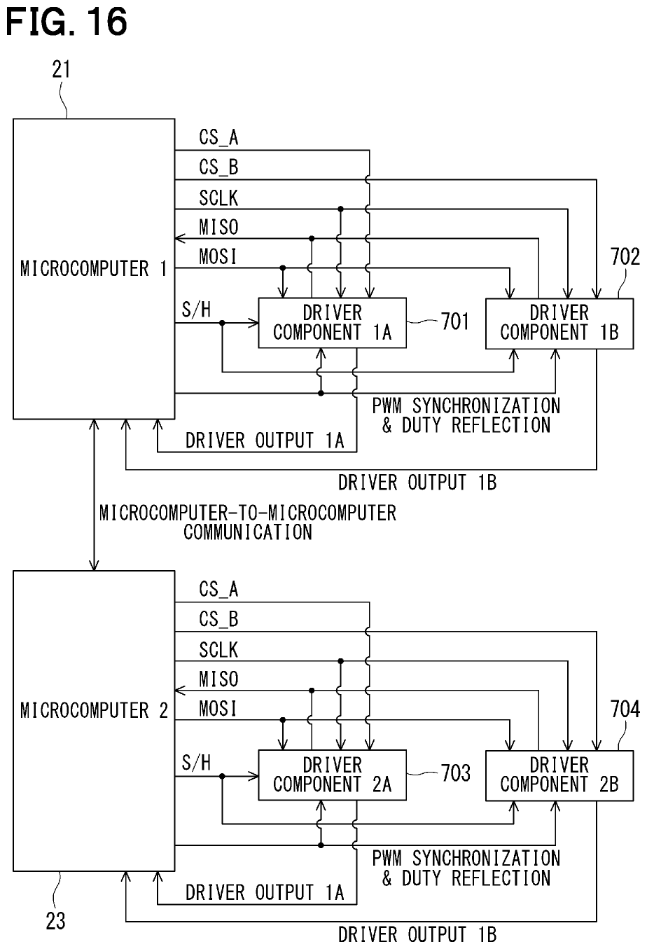

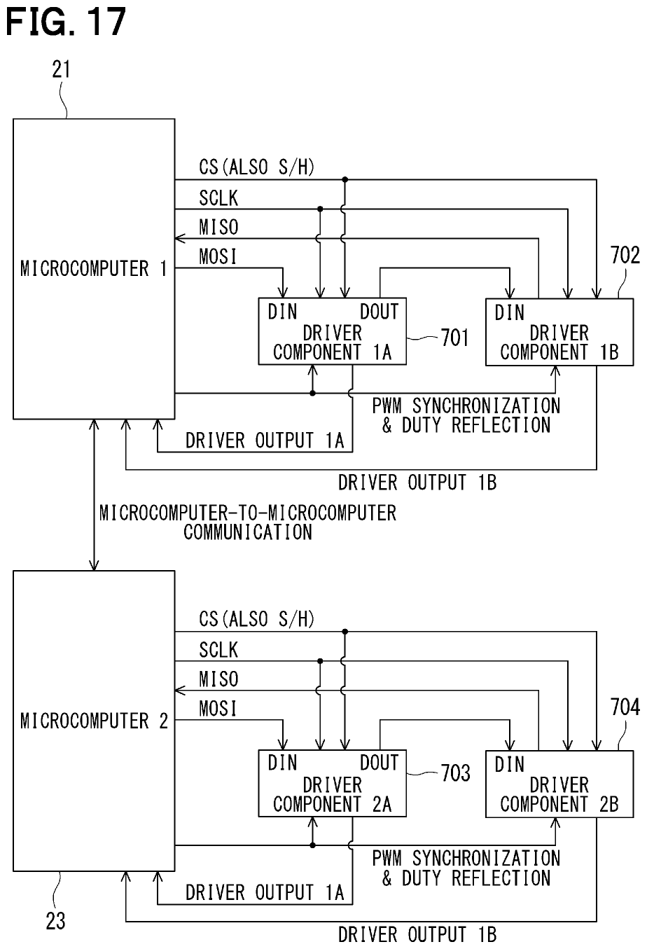

Specific examples of the communication configuration are illustrated in FIGS. 16 and 17. In FIGS. 16 and 17, for the sake of simplicity, the signal lines of the two cores of each microcomputer are collectively illustrated, and the inter-system connection line is omitted. As illustrated in FIG. 16, the microcomputers 21 and 23 can transmit the common clock signal SCLK and MOSI signal to the driver components 701 to 704 provided correspondingly, and can transmit the chip select signal CS_A to the driver components 701 and 703 and the chip select signal CS_B to the driver components 702 and 704. The driver components 701 to 704 can transmit the MISO signal to the microcomputers 21 and 23 provided correspondingly.

The microcomputers 21 and 23 are provided to be microcomputer-to-microcomputer communicable, and perform PWM synchronization, duty update timing synchronization, and sample and hold timing synchronization on the four driver components 701 to 704. The microcomputers 21 and 23 check the PWM update using the PWM reflection value and the current detection value based on the MISO signal. The PWM update may be checked by returning the driver output from the driver components 701 to 704 to the microcomputers 21 and 23. In a case where the driver output is not returned to the microcomputers 21 and 23, terminals and wires for returning the driver output can be omitted.

As illustrated in FIG. 17, the microcomputer 21, the driver component 701, and the driver component 702 may be a so-called “daisy-chain connection” that annularly connects the communication lines. Similarly, the microcomputer 23, the driver component 703, and the driver component 704 may be daisy-chain connected.

Specifically, signals from the microcomputers 21 and 23 are transmitted to the driver components 701 and 703, and the signals are transmitted from the driver components 701 and 703 to the driver components 702 and 704. The driver components 702 and 704 transmit MISO signals to the microcomputers 21 and 23, for example. In this case, the chip select signal and the sample hold may be common. Accordingly, the number of terminals and the number of wirings can be reduced.

In the present embodiment, since the communication lines of the control systems are connected by the inter-system connection line 25, the microcomputers 21 and 23 do not issue commands when communication from another microcomputer starts, or output commands after a predetermined time elapses after responses from the driver components 701 and 703 so that data is not mixed on the communication lines. In addition, the command destination may be identified by chip selection, ID assignment, or the like for the command from the microcomputers 21 and 23.

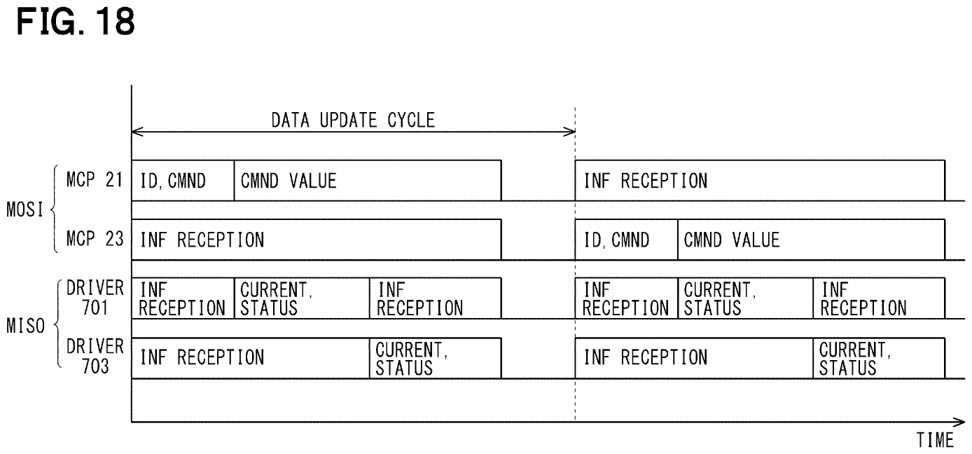

FIG. 18 illustrates an example of data transmission/reception. In the present embodiment, an ID and a command are output from each of the microcomputers 21 and 23 to designate a component to be driven. For example, a component to be driven is designated by the ID, and the MOSI transmits a current command value and an on-duty to the component. In the ID system, a component to be driven is designated by an ID, but an ID for simultaneously issuing commands to a plurality of components can also be set. Thus, for example, the timings of current detection of the plurality of components can be aligned. The component to be driven may be designated by a chip selection method.

The driver components 701 and 703 transmit current values and status information to the microcomputers 21 and 23, respectively. Since the data transmission from the driver components 701 and 703 is performed by the MISO, the information can be transmitted even during the command transmission from the microcomputers 21 and 23. However, for example, the transmission from the driver component 703 is set to start when the transmission from the driver component 701 is completed so that the data transmission timings from the different driver components do not overlap. In addition, for example, data arbitration may be performed by setting transmission in order of ID.

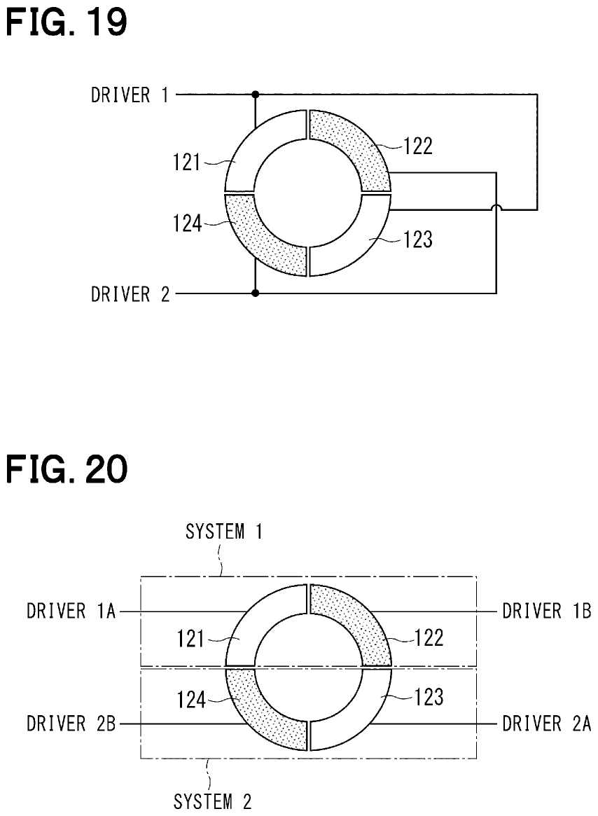

FIGS. 19 and 20 schematically illustrate an arrangement of motor windings, and three-phase wirings are indicated by one line. In the concentrated winding motor, a stator has a plurality of windings, and a three-phase motor having three input terminals is formed by connecting the plurality of windings. Depending on how the windings are connected, a set of three-phase windings can be configured, or a plurality of sets of three-phase windings can be configured. FIG. 19 illustrates an example of a case where two sets of three-phase windings are configured, and in a case where the windings facing each other at 180° are connected, the configuration of the wiring related to the connection of the plurality of windings and the bus bar responsible for the wiring tends to be complicated.

In the present embodiment, two power supplies and four motor windings are configured. As illustrated in FIG. 20, for example, in a case where four sets of three-phase windings are configured by a concentrated winding motor using a stator having 14 poles 18 slots, 10 poles 12 slots, or 8 poles 12 slots, it is not necessary to connect the windings disposed facing each other, so that the wiring can be simplified.

In the present embodiment, the substrate 75 is provided on one side of the motor 11 in the axial direction, and the configurations corresponding to respective power supplies are collectively disposed in the regions divided by the substrate division line D1 (see FIGS. 1 and 9 to 11). In addition, four sets of motor windings 121 to 124 are allocated to the two power supplies 501 and 502 and the two microcomputers 21 and 23. In a case where the motor 11 is driven by four sets of motor windings 121 to 124, winding sets facing each other at 180° are often driven in the same phase. In a case where the winding sets driven in the same phase are allocated to the same power supply, there is a possibility that an increase in size due to complication of members for collecting wirings, deterioration in layout property due to a cross arrangement of wirings on the substrate 75, and a common cause failure due to a wiring short will occur.

Therefore, windings disposed adjacent to each other in the stator and having different drive phases are allocated to one power supply system. Specifically, power is supplied from the power supply 501 to the windings 121 and 122, and power is supplied from the power supply 502 to the windings 123 and 124. In the present embodiment, since the inter-system connection line 25 is provided, a command to a winding allocated to another power supply can also be output by one core. Therefore, even when two windings disposed adjacent to each other in the stator and having different drive phases are allocated to the same power supply and disposed, the driver driving in the same phase can be operated by a command from the same core.

In addition, since the energization phases of the windings allocated to the same power supply are different, the timing at which the pull-in current is maximized when the motor is driven is shifted. As a result, as compared with a case where the driver circuit driven in the same phase is allocated to the same power supply, the power consumption in the driver circuit can be smoothed, and for example, the smoothing capacitor can be downsized. In addition, it is possible to integrate components allocated to the same power supply system to one side of the substrate, improve layout, and reduce the occurrence of common cause failures due to wiring short-circuiting. In FIG. 20, the windings 121 and 123 energized in the same phase are indicated by white, and the windings 122 and 124 energized in the same phase at a phase different from that of the windings 121 and 123 are indicated by satin.

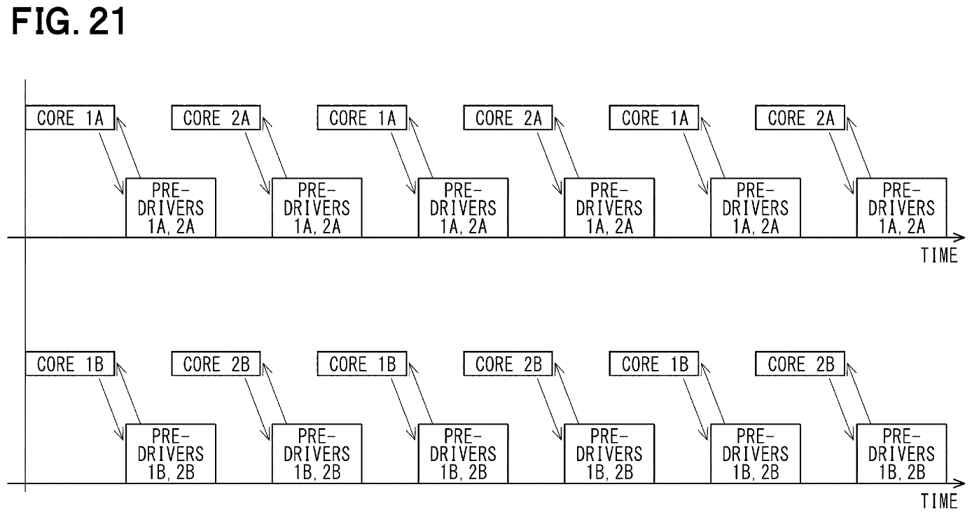

The communication between the processing cores 211, 212, 231, and 232 and the pre-driver ICs 61 to 64 will be described with reference to FIG. 21. In the description of communication, for the sake of simplicity, the processing core 211 is referred to as a “core 1A”, the processing core 212 as a “core 1B”, the processing core 231 as a “core 2A”, the processing core 232 as a “core 2B”, the pre-driver IC 61 as a “pre-driver 1A”, the pre-driver IC 62 as a “pre-driver 1B”, the pre-driver IC 63 as a “pre-driver 2A”, and the pre-driver IC 64 as a “pre-driver 2B”.

In the present embodiment, the windings 121 and 123 provided corresponding to the pre-drivers 1A and 2A face each other and are wound around the stator, and are energized in the same phase. The windings 122 and 124 provided corresponding to the pre-drivers 1B and 2B face each other and are wound around the stator, and are energized in the same phase. The energization phases of the windings 121 and 123 are different from the energization phases of the windings 122 and 124. It is assumed that the amplitudes of the currents applied to the windings 121 to 124 are the same.

As illustrated in FIG. 21, the cores 1A and 2A transmit command signals such as a duty command value and various drive permission signals to the pre-drivers 1A and 2A driven in the same phase. The pre-drivers 1A and 2A transmit current detection values and status information (for example, driver output, abnormality information, temperature information, and the like) to the cores 1A and 2A. In addition, the cores 1B and 2B transmit command signals such as a duty command value and various drive permission signals to the pre-drivers 1B and 2B driven in the same phase. The pre-drivers 1B and 2B transmit current detection values and status information to the cores 1B and 2B.

In the present embodiment, the cores 1A and 2A transmit drive commands to the pre-drivers 1A and 2A, but do not transmit drive commands to the pre-drivers 1B and 2B. Here, the pre-drivers 1B and 2B may transmit the current detection values and the status information to the cores 1A and 2A that have not received the drive command. Similarly, the pre-drivers 1A and 2A may transmit the current detection value and the status information to the cores 1B and 2B that have not received the drive command. As a result, each core can grasp the control state of the entire drive device 10.

The cores 1A and 2A alternately transmit commands to the pre-drivers 1A and 2A. Similarly, the cores 1B and 2B alternately transmit commands to the pre-drivers 1B and 2B. As a result, the processing load of each core can be reduced.

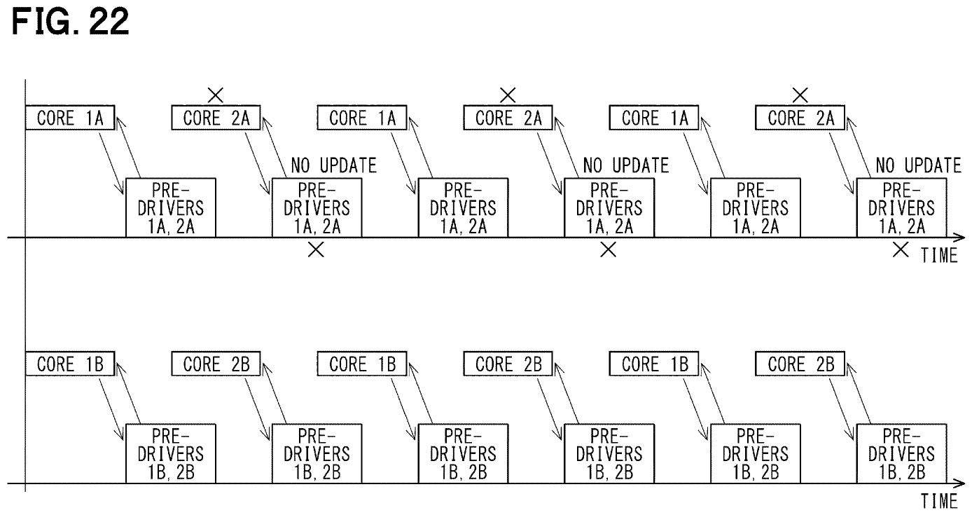

As illustrated in FIG. 22, in a case where one core fails, even in a case where the processing is not changed from the normal state, the control is continued without causing a fatal influence although the update cycle is extended. Specifically, for example, in a case where the core 2A fails, the information at the update timing of the command of the core 2A is not updated in the A group, and the update cycle is extended. In this case, the previous command value is held for the update timing in the core 2A. The influence of the failure can be reduced by using the estimated value from the past data at the update timing in the core 2A.

At the command update timing in the failed core 2A, the command may be transmitted from the normal core 1A instead of from the core 2A. As a result, it is possible to prevent performance degradation including the update cycle. In addition, the pre-drivers 1B and 2B that do not use the command of the core 2A can continue the control without being affected by the failure of the core 2A.

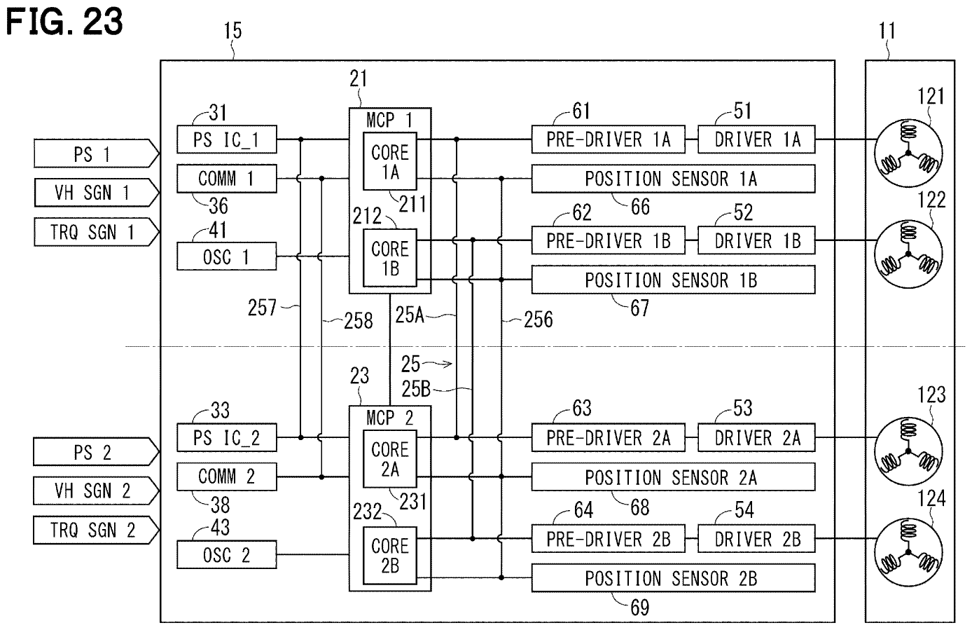

As illustrated in FIG. 23, the inter-system connection line 25 may be divided into the A group and the B group that are driven in the same phase. In FIG. 23, the inter-system connection line of the A group is “25A”, and the inter-system connection line of the B group is “25B”. By dividing the communication line for each phase, the amount of information of the communication line can be suppressed. In addition, since the common failure mode in the communication line can be avoided, even in a case where an abnormality occurs in one of the communication lines, the control can be continued.

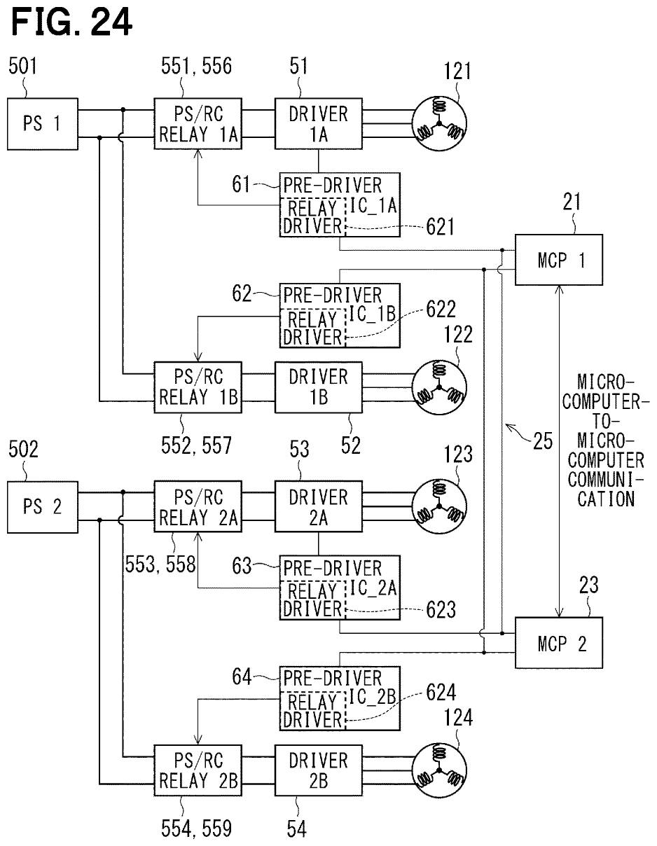

Next, driving of the power supply relay and the reverse connection protection relay will be described. As illustrated in FIG. 24, in the present embodiment, the power supply relays 551 to 554 and the reverse connection protection relays 556 to 559 are provided for respective driver circuits 51 to 54, and are driven in response to individual commands from the relay driver circuits 621 to 624 of the corresponding driver circuits 51 to 54 in the normal state. In FIG. 24, the power supply relay and the reverse connection protection relay are collectively referred to as a “power supply/reverse connection relay”, and the description of the processing core in the microcomputer is omitted. In FIG. 24, the inter-system connection lines are divided into the A group and the B group as illustrated in FIG. 23, but the inter-system connection lines may be integrated as illustrated in FIG. 2.

In a case where an abnormality occurs in the pre-driver IC 61, the power supply relay 551, or the reverse connection protection relay 556, the pre-driver IC 61 is configured to be pulled down (off), and the other pre-driver ICs 62 to 64 do not perform driving. The same applies to a case where an abnormality occurs in another pre-driver IC, another power supply relay, another reverse connection protection relay, or another motor relay (not illustrated in FIG. 24).

In a case where an abnormality occurs in the microcomputer 21, the microcomputer 23 commands the relay driver circuits 621 and 622 in the pre-driver ICs 61 and 62 to drive the power supply relays 551 and 552 and the reverse connection protection relays 556 and 557. Similarly, in a case where an abnormality occurs in the microcomputer 23, the microcomputer 21 commands the relay driver circuits 623 and 624 in the pre-driver ICs 63 and 64 to drive the power supply relays 553 and 554 and the reverse connection protection relays 558 and 559. As a result, even in a case where an abnormality occurs in one of the microcomputers, the motor 11 can be continuously driven by relay driving according to a command from another microcomputer.

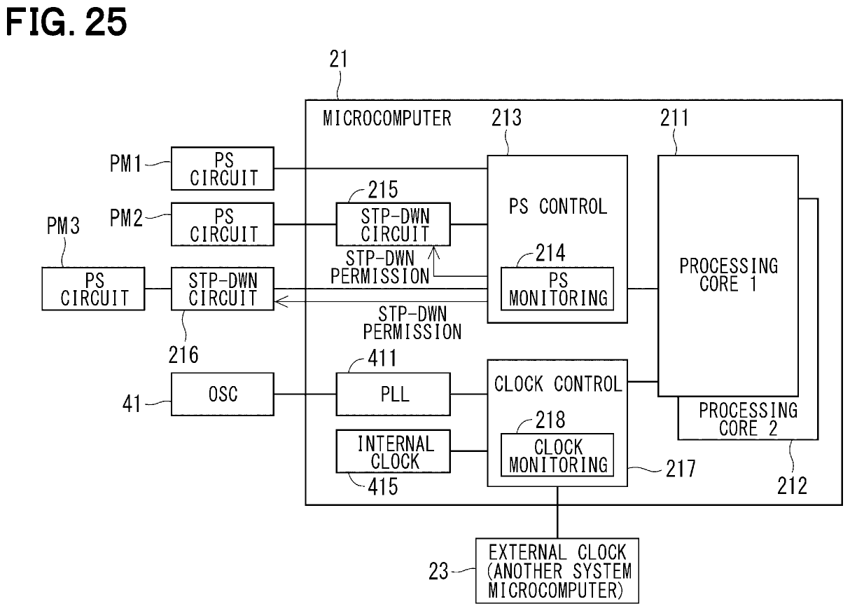

Next, a redundant configuration in the microcomputer will be described with reference to FIG. 25. Here, the microcomputer 21 will be described as an example. The microcomputer 21 includes processing cores 211 and 212, a power supply control unit 213, a clock control unit 217, and the like.

The power supply control unit 213 includes a power supply monitoring unit 214. The power supply control unit 213 is connected to a plurality of power supply circuits PM1 to PM3. The power supply circuits PM1 and PM2 correspond to the power supply IC 31, and the power supply circuit PM3 corresponds to the power supply IC 33. The power supply IC 31 has, for example, a core power supply voltage output (for example, about 1.2 [V]) and a power supply output (for example, 5 [V]) different from the core power supply voltage, and the core power supply corresponds to the power supply circuit PM1, and the 5 V power supply corresponds to the power supply circuit PM2. The power supply circuits PM1 and PM2 correspond to the same power supply IC 31, and generate different voltages inside the power supply IC 31, and can be regarded as “different power supply sources”. That is, it can be said that the power supply control unit 213 of the present embodiment has a redundant configuration in which power is supplied from three different power supply sources.

The voltage generated by the power supply circuit PM1 is input as it is to the power supply control unit 213 and used by the processing cores 211 and 212. The power from the power supply circuit PM2 is stepped down by a built-in step-down circuit 215 and input to the power supply control unit 213 to be used for core processing operation. The power from the power supply circuit PM3 is stepped down by a step-down circuit 216 outside the microcomputer and input to the power supply control unit 213. Note that the power supply circuit PM2 may be supplied with power from a power supply different from the power supply IC 33, such as the power supply IC 31, or may be configured to be stepped down by a step-down circuit outside the microcomputer. The power supply monitoring unit 214 monitors the voltage supplied from each power supply circuit.

The clock control unit 217 includes a clock monitoring unit 218. The clock control unit 217 acquires a clock signal from an oscillator 41 via a phase-locked loop (PLL) 411. Furthermore, the clock control unit 217 acquires a clock signal from an internal clock circuit 415 and an external clock circuit. In the present embodiment, the external clock circuit is the microcomputer 23 of another system, and acquires a clock signal from the microcomputer 23. The external clock circuit is not limited to another system microcomputer, and may be a clock circuit separately provided.

That is, it can be said that the clock control unit 217 of the present embodiment has a redundant configuration in which clocks are supplied from three different clock sources. Hereinafter, the clock signal acquired from the oscillator 41 via the phase-locked loop 411 is referred to as a “PLL clock”, the clock signal acquired from the internal clock circuit 219 is referred to as an “internal clock”, and the clock signal acquired from the external clock circuit is referred to as an “external clock”.

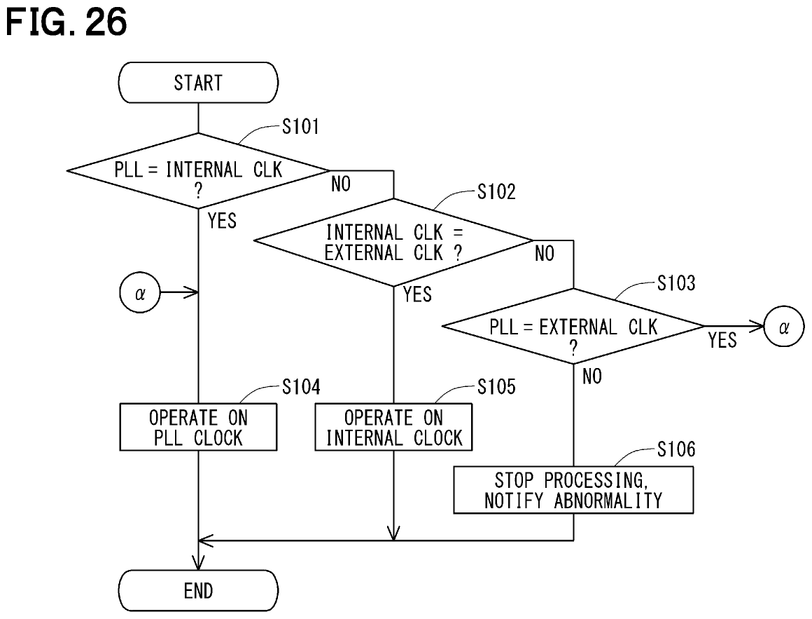

The clock monitoring process of the present embodiment will be described with reference to the flowchart of FIG. 26. Here, although the process in the microcomputer 21 will be described, the similar process is performed in the microcomputer 23. Each process in the microcomputers 21 and 23 may be software processing by executing a program stored in advance in a tangible memory device (that is, a readable non-transitory tangible recording medium) such as a ROM by a CPU, or may be hardware processing by a dedicated electronic circuit. Hereinafter, “step” such as step S101 is omitted, and is simply referred to as a symbol “S”.

In S101, the clock monitoring unit 218 determines whether the PLL clock and the internal clock match. Note that a deviation of an allowable error range is permitted, and it is determined that the PLL clock and the internal clock match. The same applies to another match determination. In a case where it is determined that the PLL clock and the internal clock match (S101: YES), the process proceeds to S104. In a case where it is determined that the PLL clock and the internal clock do not match (S101: NO), the process proceeds to S102.

In S102, the clock monitoring unit 218 determines whether the internal clock and the external clock match. In a case where it is determined that the internal clock and the external clock match (S102: YES), the process proceeds to S105. In a case where it is determined that the internal clock and the external clock do not match (S102: NO), the process proceeds to S103.

In S103, the clock monitoring unit 218 determines whether the PLL clock matches the external clock. In a case where it is determined that the PLL clock matches the external clock (S103: YES), the process proceeds to S104. In a case where it is determined that the PLL clock and the external clock do not match (S103: NO), the process proceeds to S106.

In S104 to which the process proceeds in a case where the PLL clock matches the internal clock or the external clock, the clock control unit 217 operates the processing cores 211 and 212 using the PLL clock.

In S105 to which the process proceeds in a case where the PLL clock and the internal clock do not match and the internal clock and the external clock match, the clock control unit 217 operates the processing cores 211 and 212 using the internal clock. That is, the PLL clock is used in the normal state, but the PLL clock is switched to the internal clock as the backup clock when the PLL clock is in the abnormal state. At this time, the switched clock is output to the microcomputer of another control system, and the processing is performed in synchronization with the clock received by another system microcomputer. In addition, abnormality monitoring by comparison between the internal clock and the external clock is continued.

In S106 to which the process proceeds in a case where none of the PLL clock, the internal clock, and the external clock match, the clock control unit 217 stops the processing of the processing cores 211 and 212 and notifies the external IC of the clock abnormality.

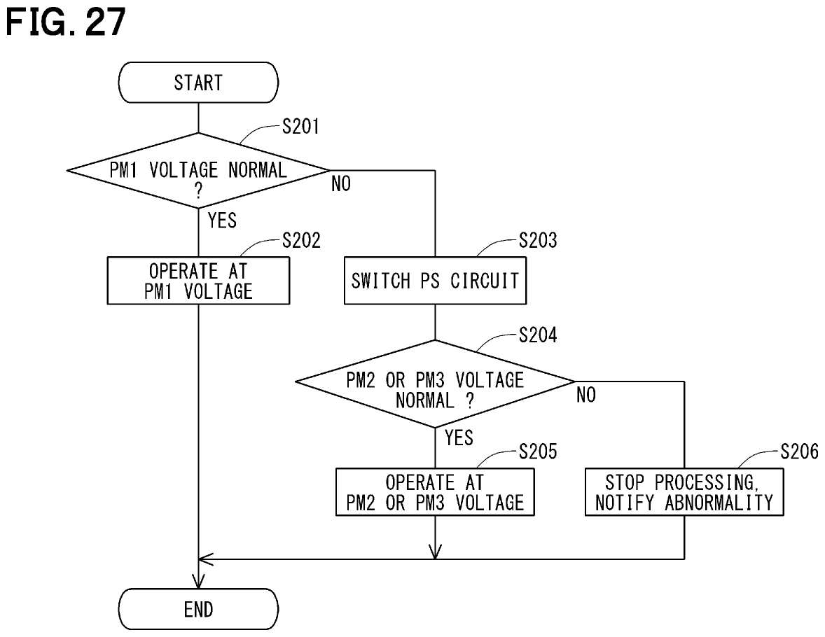

The power supply monitoring process will be described with reference to the flowchart of FIG. 27. In S201, the power supply monitoring unit 214 determines whether the core power supply voltage supplied from the power supply circuit PM1 is normal. In a case where it is determined that the core power supply voltage from the power supply circuit PM1 is normal (S201: YES), the process proceeds to S202, and the processing cores 211 and 212 are operated with the core power supply voltage from the power supply circuit PM1. In a case where it is determined that the core power supply from the power supply circuit PM1 is not normal (S201: NO), the process proceeds to S203, and the power supply used for the core processing operation is switched from the power supply circuit PM1 to the power supply circuit PM2 or the power supply circuit PM3. Here, a case of switching to the power supply circuit PM2 as the backup power supply source will be described as an example. In the case of switching to the power supply circuit PM3, the power supply circuit PM2 may be replaced with the power supply circuit PM3, and thus the description thereof will be omitted.

In S204, the power supply monitoring unit 214 determines whether the core power supply voltage supplied from the power supply circuit PM2 via the step-down circuit is normal. In a case where it is determined that the core power supply voltage derived from the power supply circuit PM2 is normal (S204: YES), the process proceeds to S205, and the processing cores 211 and 212 are operated with the core power supply voltage derived from the power supply circuit PM2. In a case where it is determined that the core power supply voltage derived from the power supply circuit PM2 is abnormal (S204: NO), the process proceeds to S206, the processing of the processing cores 211 and 212 is stopped, and the abnormality of the core power supply voltage is notified to the external IC. As a result, even in a case where a core power supply abnormality occurs in the power supply circuit PM1, the operation of the processing cores 211 and 212 can be continued by using the power supply circuits PM2 and PM3 as backup core power supplies.

As described above, the ECU 15 includes the plurality of microcomputers 21 and 23 and the driver components 701 to 704. Each of the microcomputers 21 and 23 has at least one processing core. In the present embodiment, the microcomputer 21 includes the processing cores 211 and 212, and the microcomputer 23 includes the processing cores 231 and 232.

The driver components 701 to 704 are provided corresponding to the microcomputers 21 and 23 and are digitally communicably connected to the microcomputers 21 and 23. Specifically, the driver components 701 to 704 are provided corresponding to the processing cores 211, 212, 231, and 232 and are provided to be capable of performing digital communication.

A combination of the microcomputers 21 and 23 and the driver components 701 to 704 provided correspondingly is referred to as a control system, and communication lines connecting the corresponding microcomputers 21 and 23 and the driver components 701 to 704 are referred to as intra-system communication lines C1 and C2. The inter-system connection line 25 connects intra-system communication lines of different control systems or driver components 701 and 703 of different control systems. As a result, it is possible to increase the possibility of control continuity at the time of occurrence of failure with a relatively simple configuration. Note that the same effect can be obtained by connecting the inter-system connection line between the driver components.

The driver components 701 to 704 include the pre-driver ICs 61 to 64 that transmit drive signals to switching elements included in the driver circuits 51 to 54 for driving the motor 11. The processing cores 211, 212, 231, and 232 digitally transmit drive commands for the switching elements to the pre-driver ICs 61 to 64. The drive command is, for example, a duty command value. The pre-driver ICs 61 to 64 transmit drive information including at least one of a current detection value, temperature information, and abnormality information to the microcomputers 21 and 23. Thus, the driving of the motor 11 can be appropriately controlled.

The processing cores 211, 212, 231, and 232 calculate drive commands for some driver circuits, and acquire drive information from a pre-driver IC corresponding to a driver circuit that does not calculate the drive command by itself. For example, the processing core 211 calculates drive commands for the driver circuits 51 and 53, and also acquires drive information from the pre-driver ICs 62 and 64 corresponding to the driver circuits 52 and 54 that do not calculate drive commands by themselves. As a result, the current drive state can be appropriately grasped in each of the processing cores 211, 212, 231, and 232.

The processing cores 211, 212, 231, and 232 transmit the drive command at a timing when the processing core of another control system connected by the inter-system connection line 25 does not output the drive command. As a result, it is possible to prevent data from being mixed on the communication line.

The plurality of driver components 701 to 704 hold detection values at the same timing in accordance with commands from the microcomputers 21 and 23, and sequentially transmit the detection values to the microcomputers 21 and 23. As a result, the control processing using the detection value acquired at the same timing can be appropriately performed.

The plurality of processing cores 211 and 231 alternately transmit drive commands to the pre-driver ICs 61 and 63 in each processing cycle. In addition, the plurality of processing cores 212 and 232 alternately transmit drive commands to the pre-driver ICs 62 and 64 every processing cycle. As a result, a computational load in the processing cores 211, 212, 231, and 232 can be reduced. In addition, even in a case where an abnormality occurs in some of the processing cores, the control processing can be continued. In addition, for example, it is possible to quickly shift to a command from a normal processing core.

In a case where an abnormality occurs in some processing cores of the plurality of processing cores 211 and 231 that transmit drive signals to the same pre-driver ICs 61 and 63, a normal processing core transmits a drive command instead of the some processing cores. In addition, in a case where an abnormality occurs in some processing cores of the plurality of processing cores 212 and 232 that transmit drive signals to the same pre-driver ICs 62 and 64, a normal processing core transmits a drive command instead of the some processing cores. As a result, even in a case where an abnormality occurs in some of the processing cores, it is possible to prevent performance degradation from the normal state, including the command update cycle.

The load of the present embodiment is the motor 11 having four sets of motor windings 121 to 124, and the motor winding 121, the motor winding 122, the motor winding 123, and the motor winding 124 are wound around a stator so as to be adjacent to each other in this order. In other words, the motor winding 121 and the motor winding 123 are disposed to face each other, and the motor winding 122 and the motor winding 124 are disposed to face each other (see FIG. 20). Here, “disposed so as to be adjacent” may be disposed so as to be an adjacent region when viewed as a whole, and may share some slots, for example.

The first driver circuit 51 provided corresponding to the motor winding 121 and the third driver circuit 53 provided corresponding to the motor winding 123 are driven by drive commands having the same phase. The second driver circuit 52 provided corresponding to the motor winding 122 and the fourth driver circuit 54 provided corresponding to the motor winding 124 are driven by a drive command having the same phase and a phase different from those of the pre-driver IC 61 and the pre-driver IC 63.

In the present embodiment, since the inter-system connection line 25 is provided, it is possible to relatively easily transmit a command of the same phase from the same processing core to the winding sets facing each other. Therefore, even when winding sets having different energization phases are allocated to the same microcomputer or power supply system, it is easy to design a substrate or a motor. In addition, the maximum value of the pull-in current can be reduced by allocating the winding sets energized at different phases to the same power supply system.

An intra-system communication line connecting the first pre-driver IC 61 provided corresponding to the first driver circuit 51 and the first processing core 211 and an intra-system communication line connecting the third pre-driver IC 63 provided corresponding to the third driver circuit 53 and the third processing core 231 are connected by a first inter-system connection line 25A. An intra-system communication line that connects the second pre-driver IC 62 provided corresponding to the second driver circuit 52 and the second processing core 212 and an intra-system communication line that connects the fourth pre-driver IC 64 provided corresponding to the fourth driver circuit 54 and the fourth processing core 232 are connected by a second inter-system connection line 25B different from the first inter-system connection line 25A. By dividing the inter-system connection line for each phase, the information amount of each communication line can be suppressed. In addition, the common failure mode in the communication line can be avoided.

The microcomputers 21 and 23 include a plurality of processing cores 211, 212, 231, and 232, and an intra-system communication line connected to a driver component is allocated to each of the processing cores 211, 212, 231, and 232. As a result, even in a case where some of the processing cores 211, 212, 231, and 232 fail, the control can be continued.

The inter-system connection line 25 connects the control systems via the isolator 28 that enables information transmission while maintaining a potential difference. As a result, even in a case where there is a potential difference in the connected control systems, the communication line can be appropriately connected. In addition, even in a case where an abnormality occurs in one control system, it is possible to prevent simultaneous failure due to application of a high voltage or flowing of a current.

### Second Embodiment, Third Embodiment

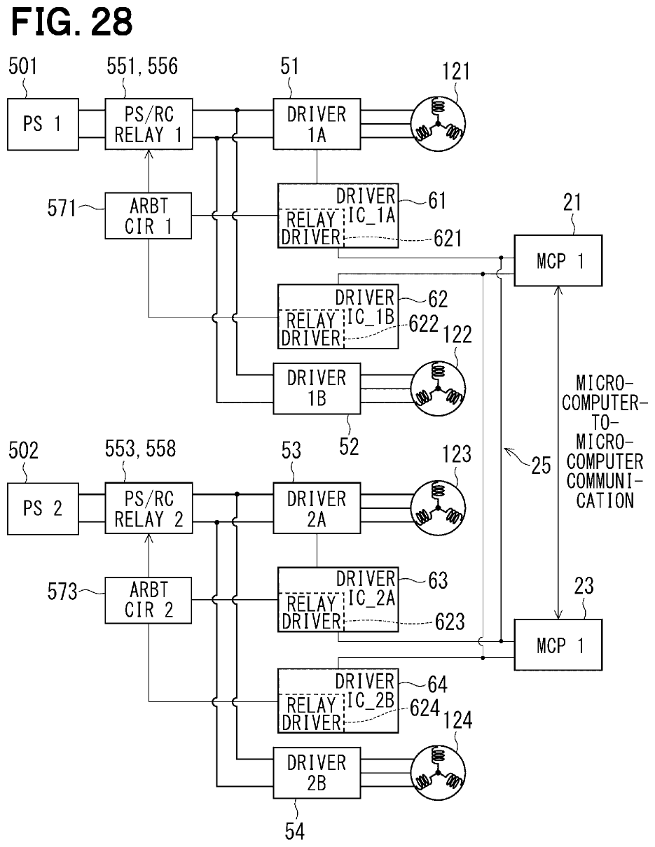

FIG. 28 illustrates the second embodiment. FIG. 28 is a diagram corresponding to FIG. 24 of the first embodiment, and the power supply relay and the reverse connection protection relay are different from those of the above embodiment. In the present embodiment, the power supply relays 551 and 553 and the reverse connection protection relays 556 and 558 are provided for each power supply. The power supply relay 551 and the reverse connection protection relay 556 are shared by the driver circuits 51 and 52, and the power supply relay 553 and the reverse connection protection relay 558 are shared by the driver circuits 53 and 54.

The relay driver circuits 621 and 622 drive the power supply relay 551 and the reverse connection protection relay 556 via an arbitration circuit 571. The relay driver circuits 623 and 624 drive the power supply relay 553 and the reverse connection protection relay 558 via an arbitration circuit 573. The number of relays can be reduced by providing the arbitration circuits 571 and 573.

In the normal state, the arbitration circuit 571 receives the same command from the relay driver circuits 621 and 622, performs matching, and drives the power supply relay 551 and the reverse connection protection relay 556. In a case where one of the relay driver circuits 621 and 622 is abnormal, the arbitration circuit 571 drives the power supply relay 551 and the reverse connection protection relay 556 by giving priority to a signal from a normally operating circuit because signals received from the relay driver circuits 621 and 622 are different.

In the normal state, the arbitration circuit 573 receives the same command from the relay driver circuits 623 and 624, performs matching, and drives the power supply relay 553 and the reverse connection protection relay 558. In a case where one of the relay driver circuits 623 and 624 is abnormal, the arbitration circuit 573 drives the power supply relay 553 and the reverse connection protection relay 558 by giving priority to a signal from a normally operating circuit because signals received from the relay driver circuits 623 and 624 are different.

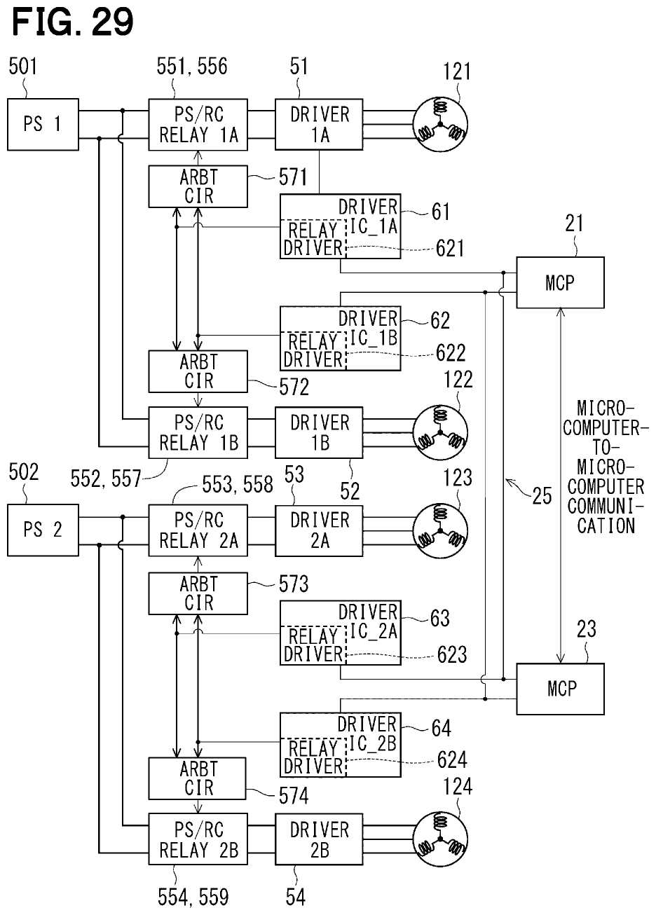

FIG. 29 illustrates the third embodiment. In the present embodiment, the power supply relays 551 to 554 and the reverse connection protection relays 556 to 559 are provided for the respective driver circuits 51 to 54, and in addition, the arbitration circuits 571 to 574 are provided.

The arbitration circuit 571 receives commands from the relay driver circuits 621 and 622, and drives the power supply relay 551 and the reverse connection protection relay 556. The arbitration circuit 572 receives commands from the relay driver circuits 621 and 622, and drives the power supply relay 552 and the reverse connection protection relay 557. The arbitration circuit 573 receives commands from the relay driver circuits 623 and 624, and drives the power supply relay 553 and the reverse connection protection relay 558. The arbitration circuit 574 receives commands from the relay driver circuits 623 and 624, and drives the power supply relay 554 and the reverse connection protection relay 559. The operation of the arbitration circuit 571 to 574 is substantially similar to that of the second embodiment. As a result, the operation of the motor 11 can be continued even in a wider failure mode. Further, the same effects as those of the above embodiment are obtained.

### Fourth Embodiment to Eighth Embodiment

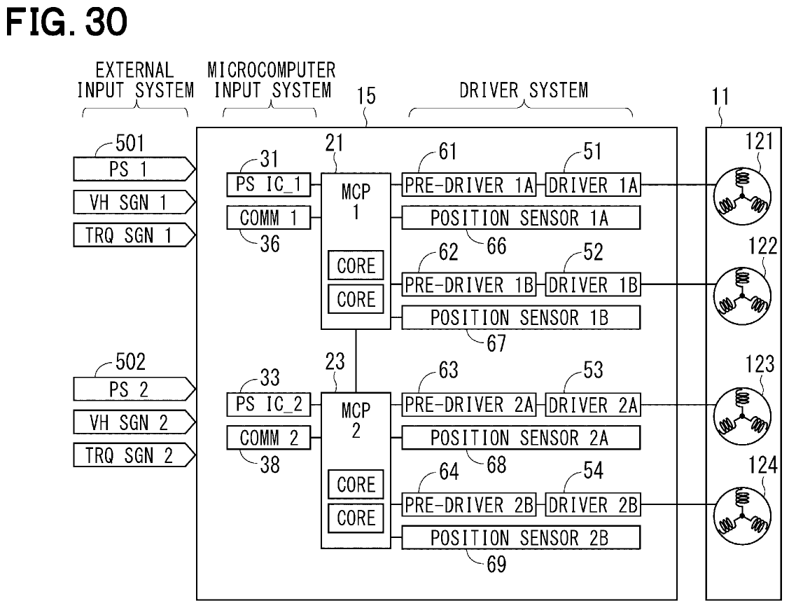

The fourth embodiment to the eighth embodiment are variations of the redundant configuration. In the description of the redundant system, the power supply, the vehicle signal input, and the torque signal input are collectively referred to as an “external input system”, the power supply IC, the communication unit, and the oscillator are collectively referred to as a “microcomputer input system”, and the pre-driver IC and the driver circuit are collectively referred to as a “driver system” as appropriate. The external input system corresponds to an input from the connector 16. In addition, the oscillator and the inter-system connection line are appropriately omitted. FIG. 30 illustrates a simplified configuration of the first embodiment. In a case where the number of cores in the microcomputer is not mentioned, the microcomputer has one processing core with a lockstep.

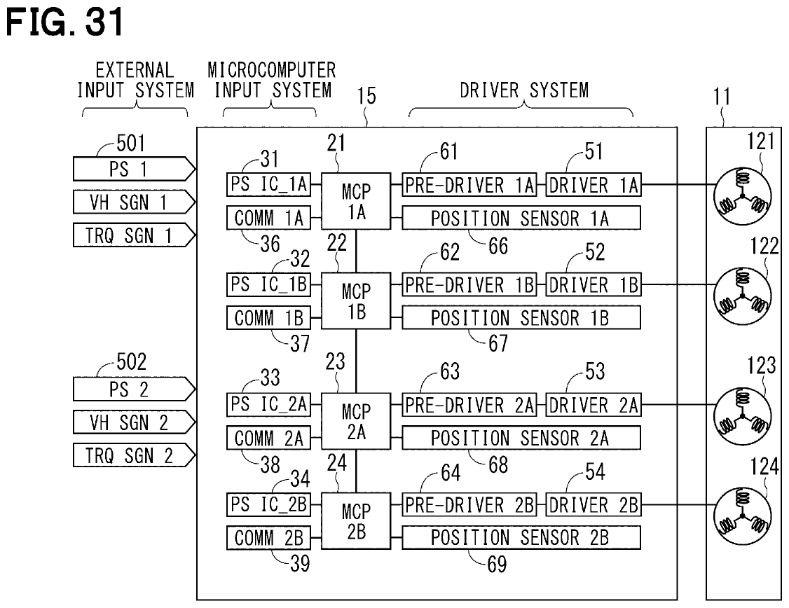

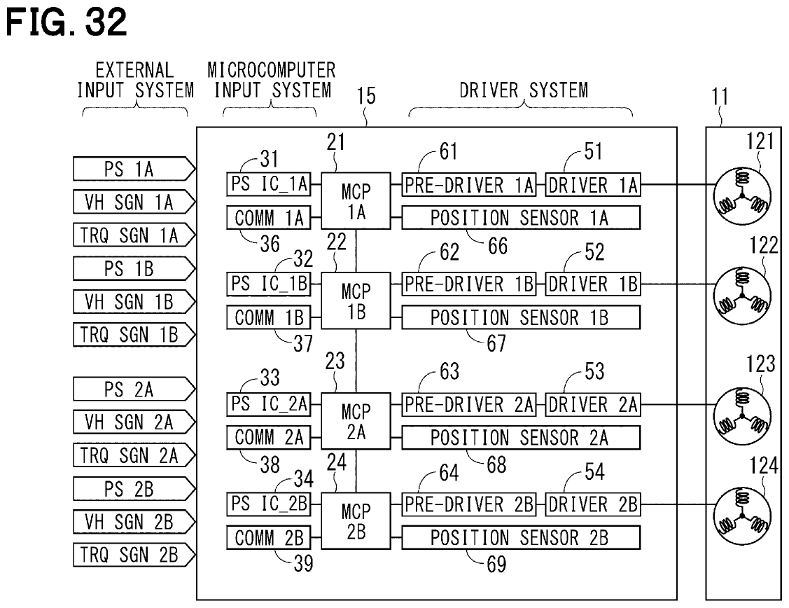

As illustrated in FIG. 31, in the fourth embodiment, the four microcomputers each having one processing core with a lockstep are provided. Other configurations are substantially the same as those of the first embodiment. As illustrated in FIG. 32, in the fifth embodiment, four external input systems are provided, and the power supply, the microcomputer, the driver, and the motor winding are provided for each of the four systems. By providing the power supply, the microcomputer, and the driver for each of the four systems, it is easy to combine with motors of the four systems. In addition, in the case of the two power supply configuration, it is easy to divide the power supply into two systems.

For all components, three or more of each component are provided, so that even when two identical components fail, control can be continued. In addition, as described in the first embodiment, by connecting the signal lines by the inter-system connection line, the output can be the same as that in the normal state unless the failure occurs on the drive side. In a case where an inter-system connection line is provided, it is preferable to appropriately insert an isolator in order to avoid a common cause failure.

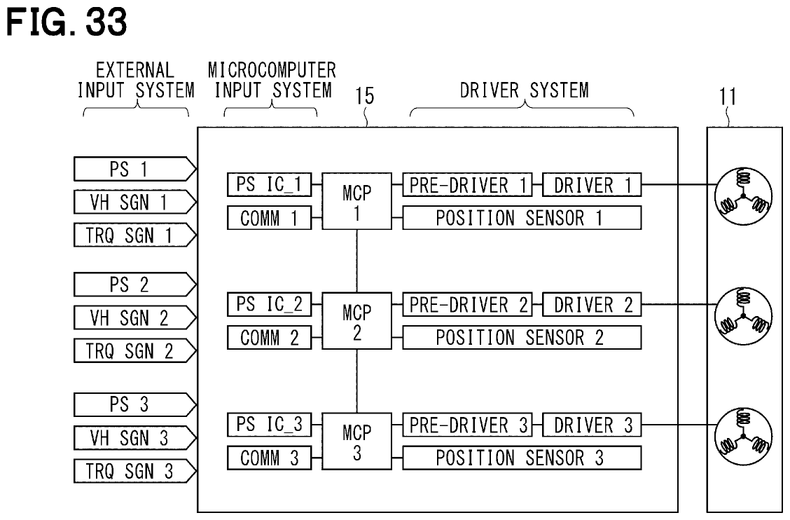

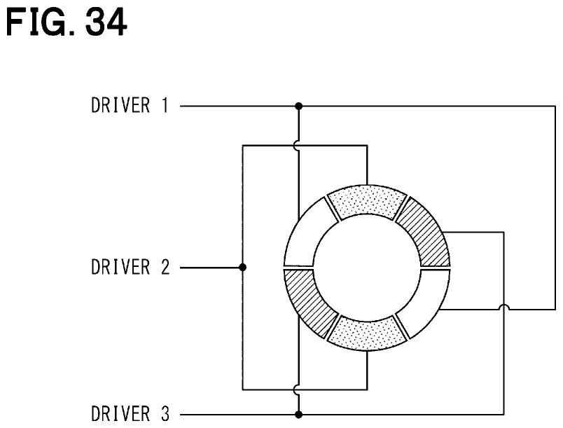

In addition, the present disclosure is not limited to an even system such as two systems or four systems, but may be an odd system, or may be a system in which a system having an odd number of components and a system having an even number of components are mixed. The sixth embodiment illustrated in FIG. 33 is an example of a three-system configuration in which three external input systems, three microcomputer input systems, three driver systems, and three motor windings are provided. As illustrated in FIG. 34, in a case where the number of driver systems is three, the number of motor windings is three, so that wiring can be efficiently performed.

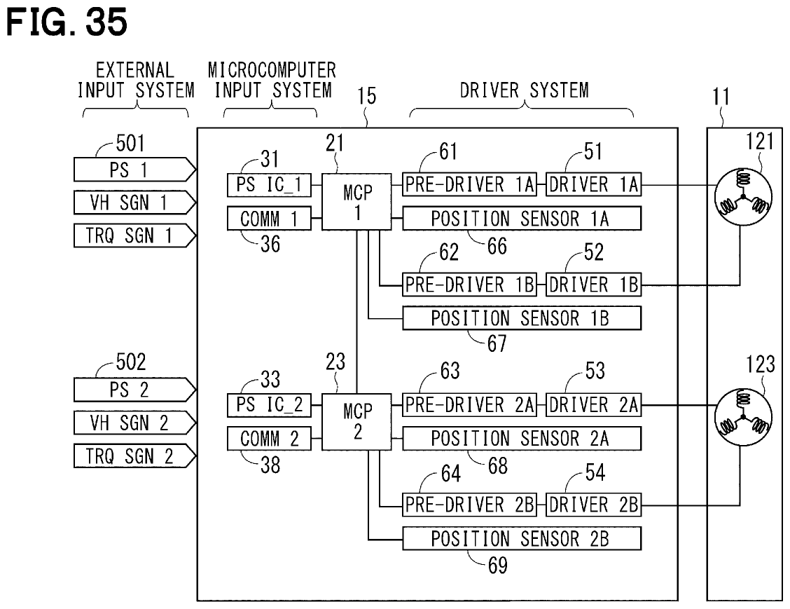

On the other hand, when redundancy is achieved by providing a plurality of components, there are concerns about an increase in the number of components, an increase in size, and an increase in computational load. In this case, three systems or four systems may be used for components that are relatively likely to fail, and two systems may be used for components that are relatively unlikely to fail. For example, in a case where the driver circuit is most likely to fail, as in the seventh embodiment illustrated in FIG. 35, the driver system is set to four systems, and the other systems are set to two systems.

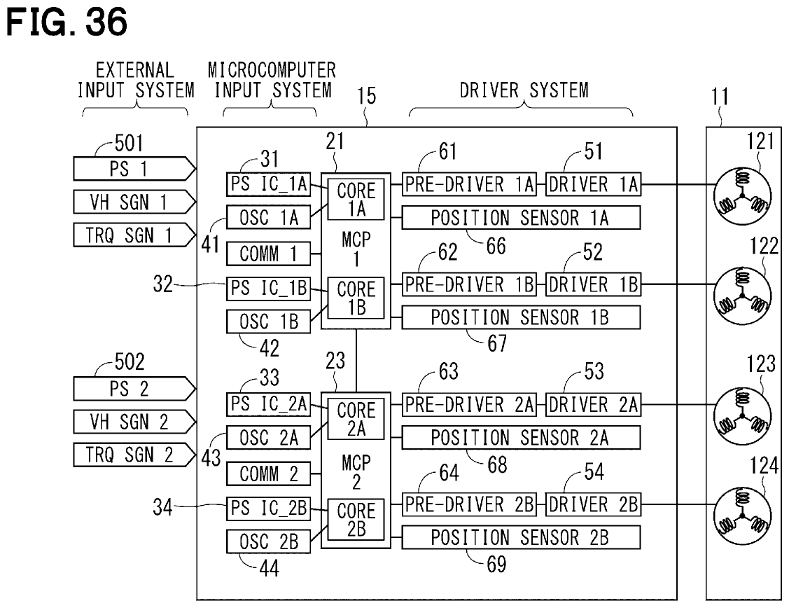

As in the eighth embodiment illustrated in FIG. 36, the ECU 15 may include four power supply ICs 31 to 34 and four oscillators 41 to 44, and a plurality of power supply ICs and a plurality of oscillators (two in FIG. 36) may be provided for one microcomputer. In the present embodiment, four processing cores are provided as a whole, and the processing cores include different power supply ICs as power supply sources, and include different oscillators as clock sources. Even with such a configuration, the same effects as those of the above embodiment are obtained.

### Ninth Embodiment

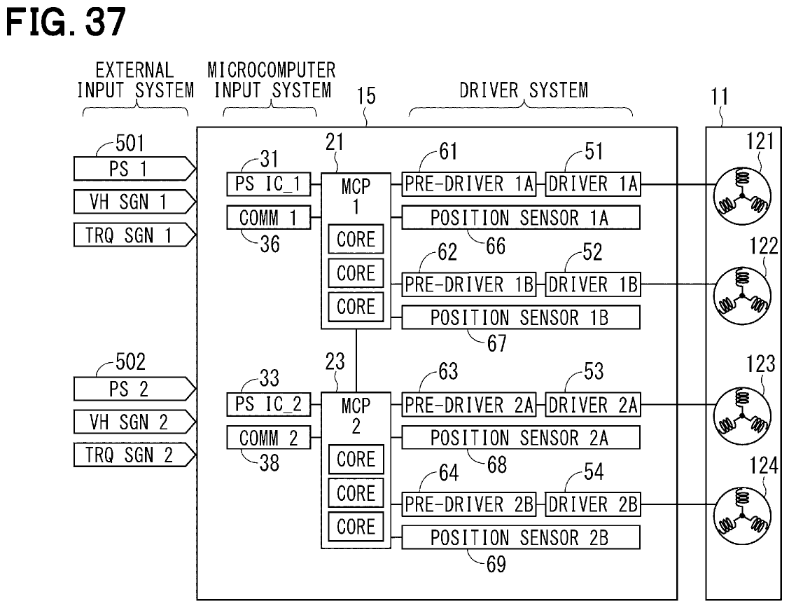

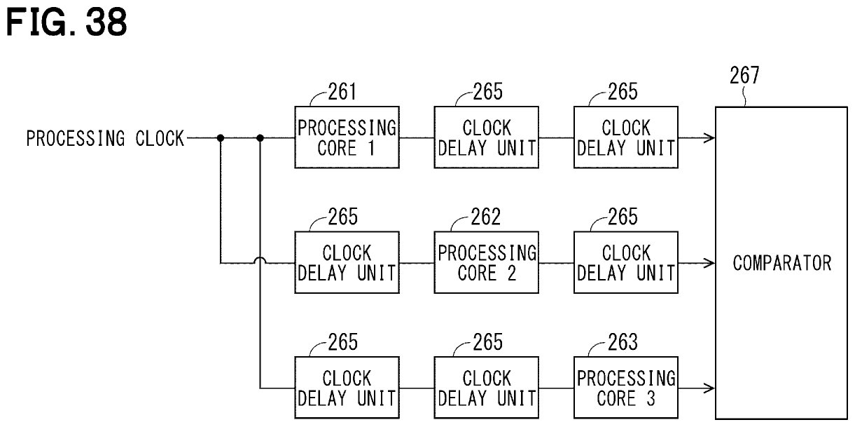

The ninth embodiment is illustrated in FIGS. 37 and 38. In the above embodiment, it is described that the processing core includes the lockstep. In a case where the processing core includes the lockstep, the redundant computation is performed by the lockstep core, and the abnormality detection is performed by comparing the computation results. On the other hand, in a case where the processing core does not have a lockstep core, a computation error cannot be detected. The ninth embodiment is an example in which the processing core does not have a lockstep core, and the microcomputers 21 and 23 each have three processing cores and perform abnormality monitoring by majority decision of the computation results.

As illustrated in FIG. 38, the three processing cores 261 to 263 can perform the computation independently, and can perform the computation simultaneously based on a common clock. In this case, for example, in a case where instantaneous noise is introduced, there is a possibility that the computations by the three processing cores 261 to 263 are similarly affected. Therefore, by shifting the computation timing using the clock delay unit 265, it is possible to prevent simultaneous occurrence of a computation error. Note that, in a comparator 267 that compares computation results, it is necessary to compare computation results at the same timing, and thus, delay amounts between the plurality of cores are organized. By dynamically comparing using the comparator 267, it is possible to perform determination at high speed. In addition, instead of the comparison by the comparator 267, data may be stored for a certain period of time, and the comparison may be collectively performed by the processing cores 261 to 263. Even with such a configuration, the same effects as those of the above embodiment are obtained.

### Tenth Embodiment

The tenth embodiment is illustrated in FIGS. 39 to 41. In the tenth embodiment, how to operate in a redundant configuration will be described. For example, in the case of a configuration in which four microcomputers and four motor windings are provided (see FIG. 32), the four microcomputers may be uniformly driven, and the output per set of motor windings may be set to 25%.

In addition, the two microcomputers and the two sets of motor windings are set to a drive system, the remaining two microcomputers and the remaining two sets of motor windings are set to a backup system, and the output per set of motor windings is set to 50% by performing driving in the drive system in the normal state. In addition, in a case where an abnormality occurs in the drive system, the driving is switched to the driving in the backup system.

FIG. 39 illustrates an example in which there are four microcomputers 21 to 24 and four driver circuits 51 to 54 and two sets of motor windings 121 and 123, the microcomputers 21 and 22 and the driver circuits 51 and 52 are connected to the motor winding 121, and the microcomputers 23 and 24 and the driver circuits 53 and 54 are connected to the motor winding 123. The motor relay 131 is provided between the driver circuit 51 and the motor winding 121, the motor relay 132 is provided between the driver circuit 52 and the motor winding 122, the motor relay 133 is provided between the driver circuit 53 and the motor winding 123, and the motor relay 134 is provided between the driver circuit 54 and the motor winding 124. The motor relays 131 to 134 include three switching elements corresponding to the respective phases. In the figure, the motor relay is referred to as an “SW”.

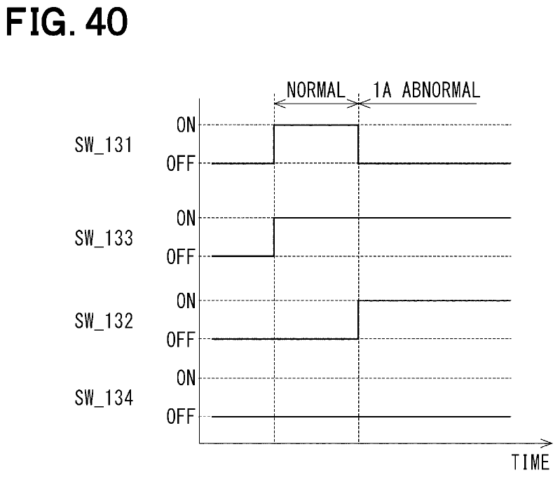

As illustrated in FIG. 40, in the normal state, the motor relays 131 and 133 are turned on to energize the motor windings 121 and 123 using the driver circuits 51 and 53, thereby driving the motor 11. In a case where an abnormality occurs in the microcomputer 21, the motor relay 131 is turned off, and the motor relay 132 is turned from off to on to energize the motor winding 121 using the driver circuit 52 instead of the driver circuit 51. When the microcomputer 23 is normal, the motor relay 133 is kept on and the motor relay 134 is kept off.

Similarly, in a case where an abnormality occurs in the microcomputer 23, the motor relay 133 is turned off, and the motor relay 134 is turned from off to on to energize the motor winding 123 using the driver circuit 54 instead of the driver circuit 53. When the microcomputer 21 is normal, the motor relay 131 is kept on and the motor relay 132 is kept off. As a result, even in a case where an abnormality occurs in the microcomputers 21 and 23, the motor 11 can be continuously driven in the same state as before the occurrence of the abnormality.

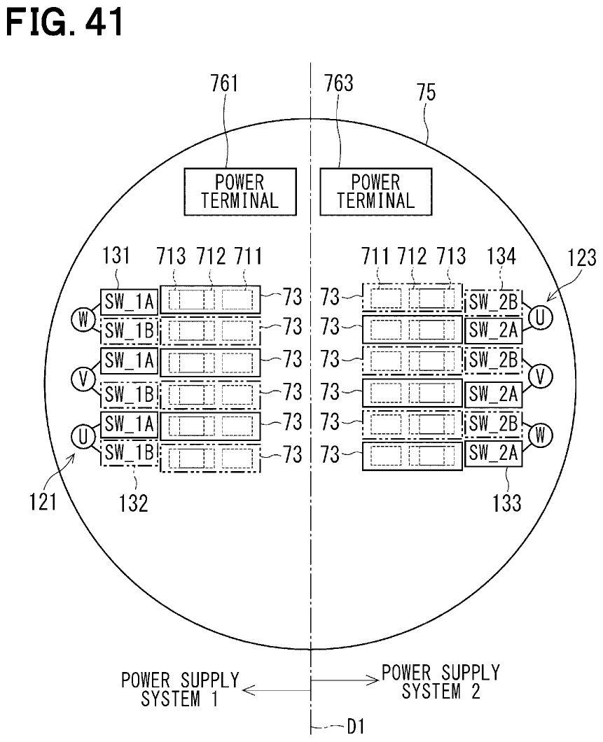

As illustrated in FIG. 41, the components related to the energization of the motor winding 121 are collectively disposed on one side (the left side of the sheet in the example of FIG. 41) of the substrate 75, and the components related to the energization of the motor winding 123 are collectively disposed on the other side (the right side of the sheet in the example of FIG. 41) of the substrate 75.

On the substrate 75, the power terminals are disposed line-symmetrically with respect to the substrate division line D1. The extraction wires of the motor windings 121 and 123, the driver component 73, and the motor relays 131 to 134 between the motor wires and the driver components are disposed line-symmetrically with respect to the substrate division line D1 in the configuration with respect to the motor winding 121 and the configuration with respect to the motor winding 123, and the phase arrangement is disposed in the reverse order.

In the driver component 73, one high-side chip 712 and one low-side chip 713 corresponding to each phase, and a control chip 711 incorporating a pre-driver IC corresponding thereto are integrally sealed. The six driver components 73 are disposed side by side with the element-side end portions facing the motor windings 121 and 123 and the IC-side end portions facing the substrate division line D1.

In the driver component 73, the low-side chip 713, the high-side chip 712, and the control chip 711 are disposed in this order from the motor windings 121 and 123. The low-side chip 713 is shifted from and stacked on the high-side chip 712, but may be in a flat state without being stacked, or the control chip 711 may be a separate body. The driver components 701 to 704 of the above embodiment in which a total of six switching elements are modularized may be used. In this case, the elements of the drive system and the elements of the backup system are allocated to different modules in the phase (the V phase in the example of FIG. 41) disposed in the middle.

In FIG. 41, the components of the drive system are indicated by solid lines, the components of the backup system are indicated by two-dot chain lines, and the driver components of the drive system and the driver components of the backup system corresponding to each phase are alternately disposed adjacent to each other. Therefore, the high-side chips 712 and the low-side chips 713 used for in-phase driving are disposed adjacent to each other. As a result, the driver component 73 and the motor windings 121 and 123 can be easily wired, and the mounting area of the power unit on the substrate can be suppressed. Even with such a configuration, the same effects as those of the above embodiment are obtained.

### Eleventh Embodiment to Thirteenth Embodiment

The eleventh embodiment to the thirteenth embodiment are variations of power terminal arrangement and connection. As in the eleventh embodiment illustrated in FIG. 42, in a case where four external input systems are provided (see FIG. 32), the power terminals 761 to 764 corresponding to the four connectors are uniformly disposed at 90° intervals.

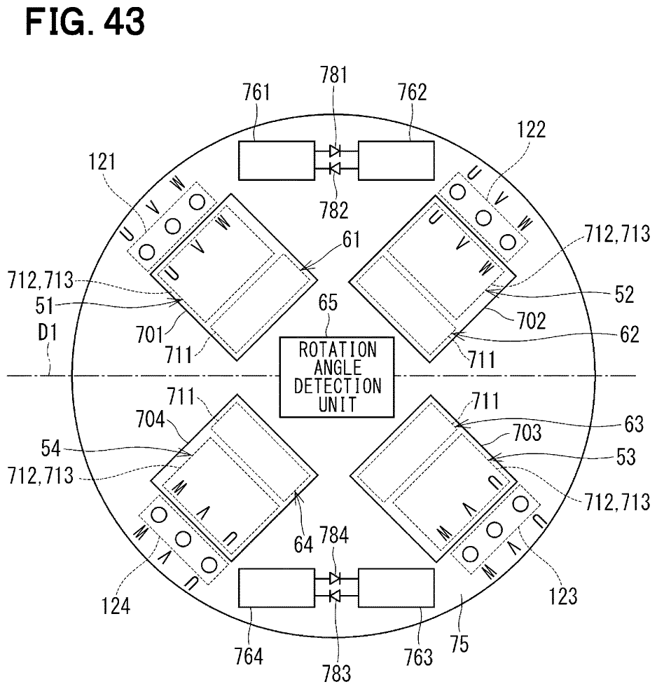

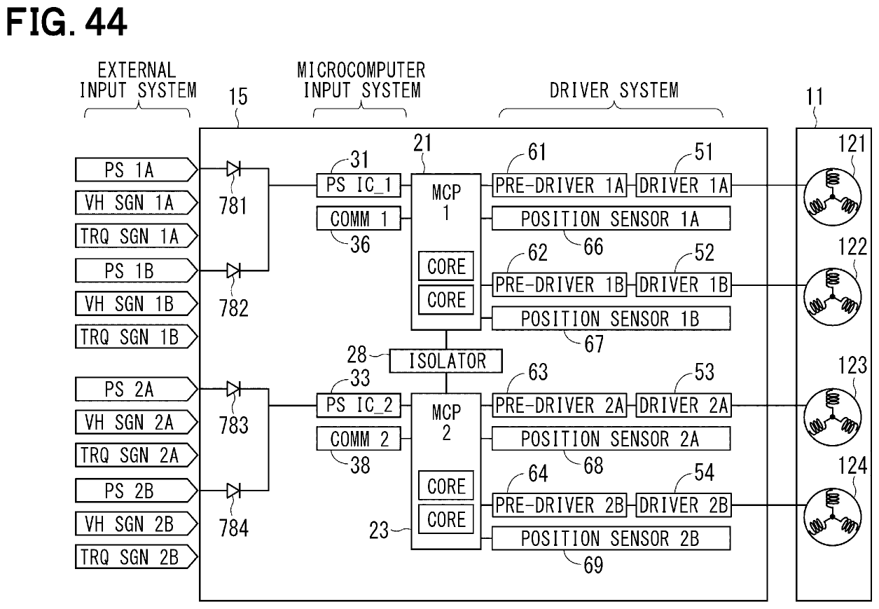

As in the twelfth embodiment illustrated in FIGS. 43 and 44, the power terminal 761 and the power terminal 762, and the power terminal 763 and the power terminal 764 may be disposed side by side at two positions on both sides of the substrate division line D1 on the outer edge of the substrate 75. In a case where four sets of power terminals 761 to 764 corresponding to four connectors are provided for the two power supply ICs 31 and 33, the two sets of power terminals 76 are connected to the respective power supply ICs 31 and 33 via the diodes 781 to 784. By electrically connecting the plurality of power supply inputs, power supply can be appropriately continued even in a case where connector abnormality, harness disconnection, or the like occurs.

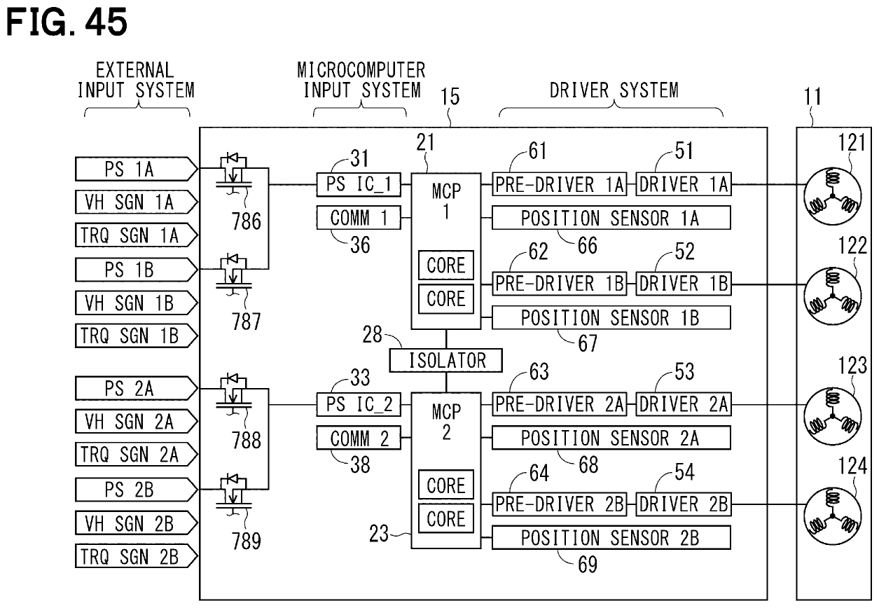

As in the thirteenth embodiment illustrated in FIGS. 45 to 47, the switching elements 786 to 789 may be provided between the connector and the power supply IC instead of the diodes 781 to 784. The switching elements 786 and 787 are connected to the power supply IC 31, and the switching elements 788 and 789 are connected to the power supply IC 33.

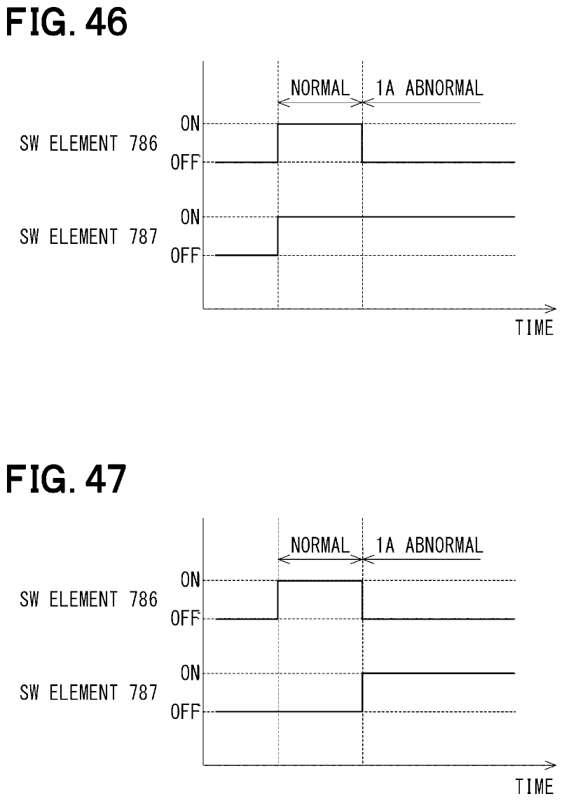

As illustrated in FIG. 46, both the switching elements 786 and 787 are turned on in the normal state, and in a case where an abnormality occurs in the power supply 1A, the switching element 786 where the abnormality occurs is turned off. In a case where an abnormality occurs in the power supply 1B, the switching element 787 is turned off. By turning on both switching elements 786 and 787 in the normal state, it is possible to quickly switch the power supply to be used when an abnormality occurs.

In addition, as illustrated in FIG. 47, in the normal state, the switching element 786 is turned on and the switching element 787 is turned off so that power is supplied from one power supply (for example, the power supply 1A). In a case where an abnormality of the power supply 1A is detected, the switching element 786 may be turned off, a wake-up signal may be transmitted from the normal microcomputer to the switching element 787, and the switching element 787 may be turned on. As a result, current consumption in the normal state can be suppressed. The same applies to the control of the switching elements 788 and 789 connected to the power supply IC 33. Even with such a configuration, the same effects as those of the above embodiment are obtained.

### Fourteenth Embodiment, Fifteenth Embodiment

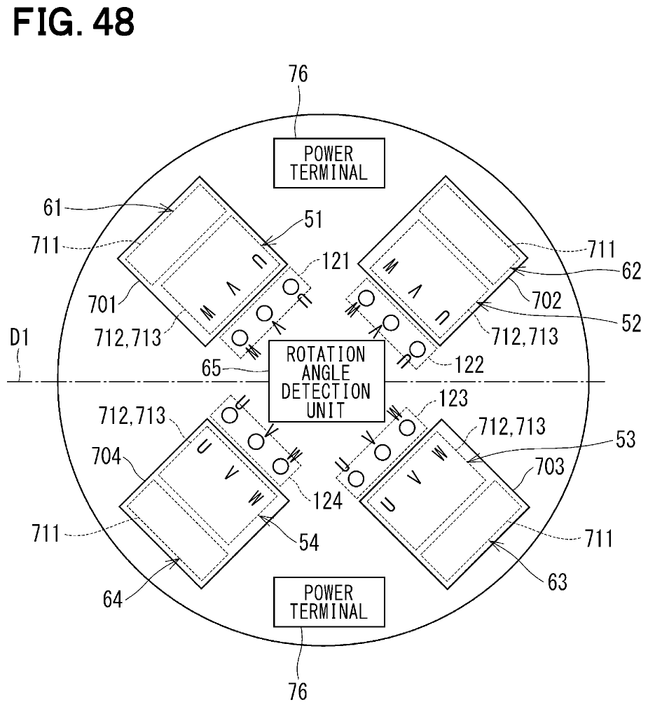

The fourteenth embodiment and the fifteenth embodiment are variations of the substrate arrangement. In the first embodiment, the motor windings 121 to 124 are provided at the radially outer side of the driver components 701 to 704 (see FIG. 11). In the fourteenth embodiment illustrated in FIG. 48, the motor windings 121 to 124 are provided at the radially inner side of the driver component 701.

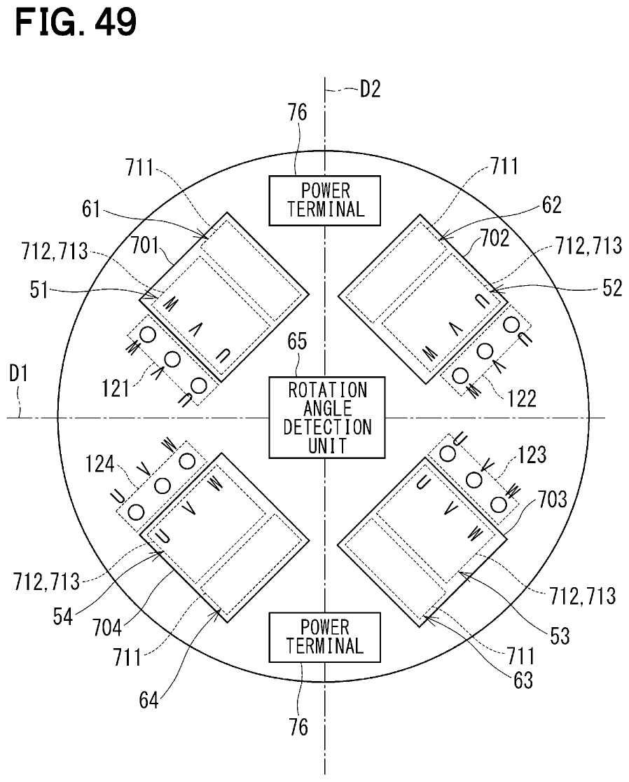

In addition, in the fifteenth embodiment illustrated in FIG. 49, the driver components 701 and 702 are disposed line-symmetrically with respect to the substrate center line D2 so that the pre-driver ICs 61 and 62 face the power terminal 76. In addition, the driver components 703 and 704 are disposed line-symmetrically with respect to the substrate center line D2 so that the pre-driver ICs 63 and 64 face the power terminal 76. The motor windings 121 to 124 are provided close to the driver circuits 51 to 54 of the driver components 701 to 704. Even with such a configuration, the same effects as those of the above embodiment are obtained.

### Sixteenth Embodiment

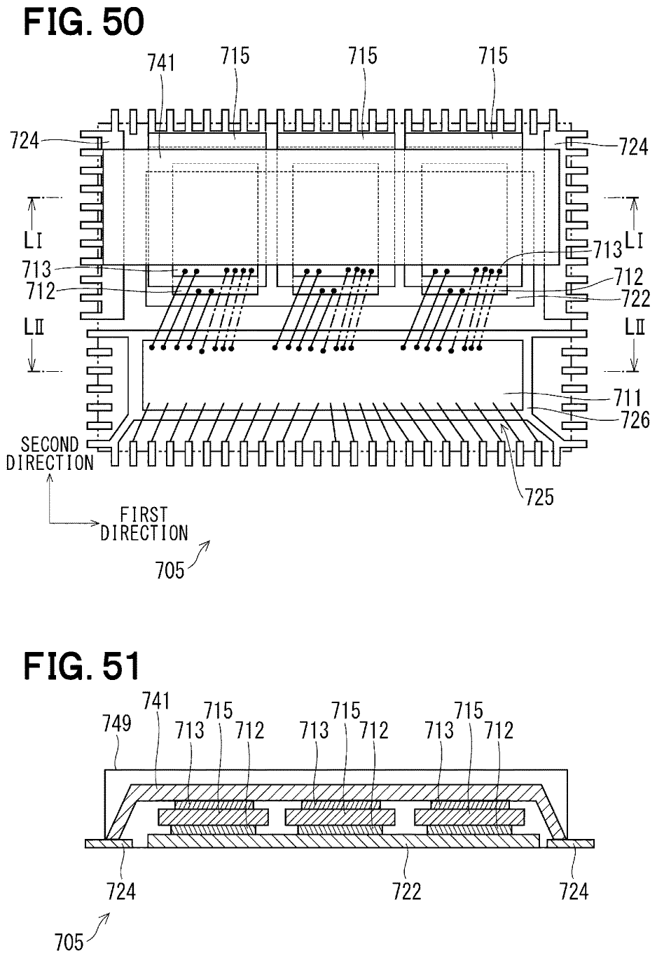

The sixteenth embodiment to the eighteenth embodiments are modifications of the driver component. The sixteenth embodiment is illustrated in FIGS. 50 to 52. FIG. 50 is a view corresponding to FIG. 7, and illustrates each component in a simplified manner. In a driver component 705 of the present embodiment, the stacked structure of the chips 712 and 713 is substantially the same as that of the first embodiment.

The ground lands 724 of a lead frame 725 are provided on both sides of the power land 722. The ground clip 741 is bent downward on both sides in the width direction and connected to the ground land 724.

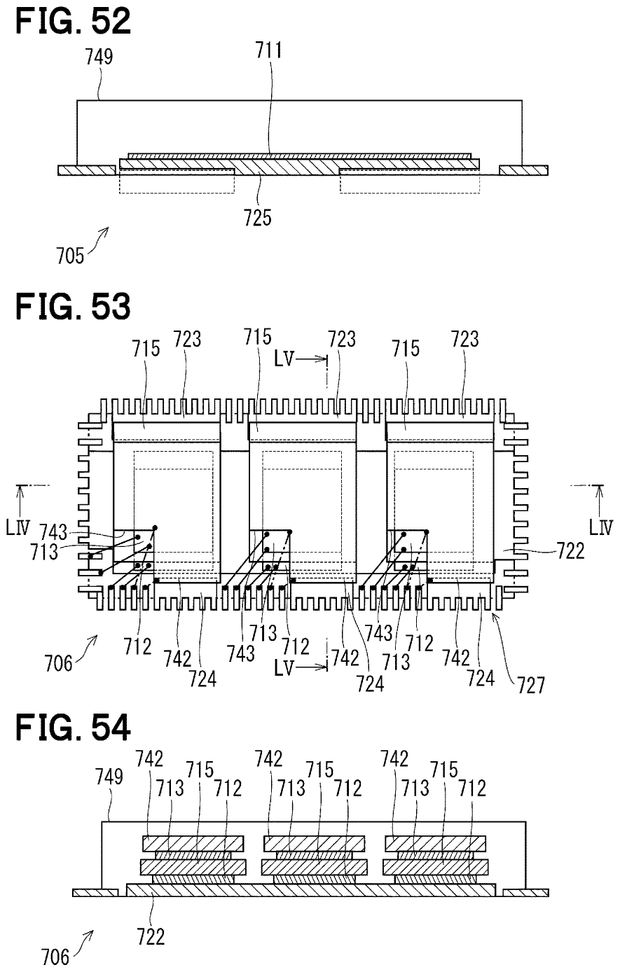

As illustrated in FIG. 52, a control land 726 where the control chip 711 is disposed is exposed to the back face from the sealing unit 749 at the intermediate portion in the width direction, and is not exposed from the sealing unit 749 on the outer side in the width direction. In other words, as indicated by a dashed square, part of the control land 726 is spaced apart from the substrate 75. As a result, it is possible to ensure substrate routing capability between the high-side chip 712 and the power supply line. In addition, since the power supply +line and the GND line are in a straight line, it is easy to arrange a miscellaneous protection element such as a snubber element (not illustrated). Furthermore, a noise loop can be reduced. Further, the same effects as those of the above embodiment are obtained.

### Seventeenth Embodiment

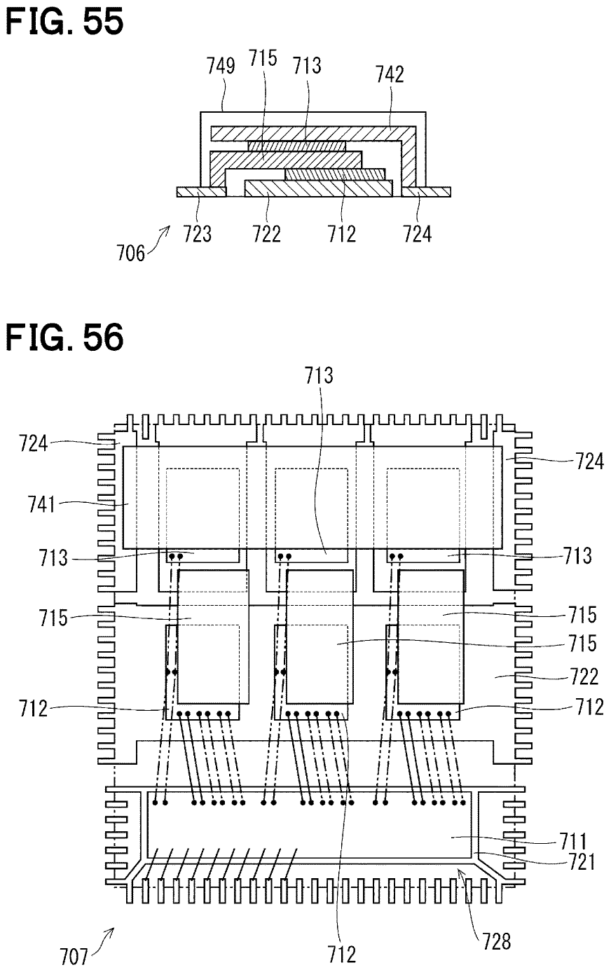

The seventeenth embodiment is illustrated in FIGS. 53 to 55. In a driver component 706 of the present embodiment, the control chip 711 is not built in, and a lead frame 727 does not include the control land 726. The stacked structure of the chips 712 and 713 is substantially the same as that of the first embodiment. Note that the control chip 711 may be built in the present embodiment. In the embodiment such as the first embodiment, the control chip 711 may be separately provided without being built in the driver component.

In the present embodiment, the ground land 724 is divided for each phase and is disposed opposite to the output land 723 with the power land 722 interposed therebetween. A ground clip 742 is provided for each phase. Each of the ground clips 742 is provided on the upper side of the low-side chip 713, and is bent downward to be connected to the ground land 724. The ground clip 742 has a notch portion 743 so that part of each of the high-side chip 712 and the low-side chip 713 is exposed to the top face. As a result, the non-overlapping region is ensured, and the high-side chip 712 and the low-side chip 713 can be connected to the signal line.

The motor current can be detected by dividing the ground clip 742 for each phase and detecting the voltage across the low-side chip 713 and the ground land 724. That is, in the present embodiment, the ground clip 742 also has a function as a current detection element. Thus, the motor current can be detected with a relatively simple configuration. Further, the same effects as those of the above embodiment are obtained.

### Eighteenth Embodiment

FIG. 56 illustrates the eighteenth embodiment. In a driver component 707 of the present embodiment, the high-side chip 712 and the low-side chip 713 are not stacked and are placed side by side in a planar manner. In the present embodiment, the control chip 711, the high-side chip 712, and the low-side chip 713 are disposed in this order from one side.

A lead frame 728 of the present embodiment includes a control land 721, a power land 722, an output land 729, and a ground land 724, and the low-side chip 713 is disposed on the output land 729. Each of the intermediate clips 715 is provided on the upper side of the high-side chip 712, and one end thereof is bent downward to be connected to the output land 729.

In the present embodiment, since the high-side chip 712 is disposed between the low-side chip 713 and the control chip 711, it is difficult to directly connect the gate electrode of the low-side chip 713 and the control chip 711. Therefore, in the present embodiment, a bonding pad is provided on the high-side chip 712, and the gate terminal of the low-side chip 713 and the control chip 711 are connected via the bonding pad of the high-side chip 712. By relaying the high-side chip 712 provided therebetween, the control chip 711 and the low-side chip 713 can be appropriately connected. Further, the same effects as those of the above embodiment are obtained.

### Nineteenth Embodiment

The nineteenth embodiment is illustrated in FIGS. 57 to 62. In the nineteenth embodiment to the twenty-fourth embodiment, communication between a microcomputer and a driver component or between driver components will be mainly described. In the following embodiment, for simplification of description, it is assumed that two microcomputers, two driver components, and two motor windings are provided, but the present embodiment is applicable to the configuration of each of the above embodiments.

As illustrated in FIG. 57, the microcomputer 201 and the driver component 801 are connected in the first control system, and the microcomputer 202 and the driver component 802 are connected in the second control system. The microcomputers 201 and 202 and the driver components 801 and 802 are substantially similar to the microcomputers 21 and 23 and the driver components 701 and 703 of the above embodiments except for the communication configuration. The reference numerals of the components other than the microcomputer, the driver component, and the isolator of the above embodiment are appropriately applied.

Hereinafter, a combination of the microcomputer 201 and the driver component 801 is referred to as a “first control system”, and a combination of the microcomputer 202 and the driver component 802 is referred to as a “second control system”. According to the embodiment described later, a combination of the microcomputer 201 and the driver components 803 and 811 is referred to as a “first control system”, and a combination of the microcomputer 202 and the driver components 804 and 812 is referred to as a “second control system”. In the figures and the like, in order to distinguish the system, a suffix “1” is appropriately added to the configuration and the signal of the first control system, and a suffix “2” is appropriately added to the configuration and the signal of the second control system. In addition, in a case where the systems are not distinguished, the suffixes “1”, “2”, and the like are omitted.

Each of the microcomputers 201 and 202 includes a terminal for outputting a clock signal CLK, a MISO signal terminal to which a signal from the driver is input, a MOSI signal terminal for outputting a signal to the driver, a terminal for outputting a chip select signal CS, and a terminal for outputting an enable signal EN. Each of the driver components 801 and 802 includes a terminal to which a clock signal CLK is input, a MISO signal terminal for outputting a signal to the microcomputer, a MOSI terminal to which a signal from the microcomputer is input, and a terminal to which the chip select signal CS is input. In the present embodiment, each of the driver components 801 and 802 has a set of communication ports used for microcomputer-to-driver communication.

The chip select signals CS11 and CS12 are signals output from the microcomputer 201, the chip select signal CS11 is a signal for selecting the driver component 801, and the chip select signal CS12 is a signal for selecting the driver component 802. The chip select signals CS21 and CS22 are signals output from the microcomputer 202, the chip select signal CS21 is a signal for selecting the driver component 802, and the chip select signal CS22 is a signal for selecting the driver component 801. The chip select signals CS12 and CS22 for selecting the driver components of another system are output to another system via the isolators 281 and 282, respectively.

The enable signal EN1 is a signal output from the microcomputer 201 to the isolator 281, and the enable signal EN2 is a signal output from the microcomputer 202 to the isolator 282.

An inter-system connection line 251 connects the intra-system communication lines C1 and C2, and is mainly used for signal transmission between the microcomputer 201 and the driver component 802. Specifically, the inter-system connection line 251 includes a signal line that outputs the clock signal and the MOSI signal output from the microcomputer 201 to the second control system. The inter-system connection line 251 includes a signal line that outputs the MISO signal output from the driver component 802 to the first control system. The inter-system connection line 251 includes the isolator 281.

The inter-system connection line 252 connects the intra-system communication lines C1 and C2, and is mainly used for signal transmission between the microcomputer 202 and the driver component 801. Specifically, the inter-system connection line 252 includes a signal line that transmits the clock signal output from the microcomputer 202 and the MOSI signal to the first control system. The inter-system connection line 252 includes a signal line that transmits the MISO signal output from the driver component 801 to the second system. The inter-system connection line 252 includes the isolator 282.

The enable signal EN1 from the microcomputer 201 is input to the isolator 281, and the enable signal EN2 from the microcomputer 202 is input to the isolator 282. That is, the isolators 281 and 282 of the present embodiment have, in addition to the system separation function of connecting lines so as to be able to transmit and receive signals in a state where the potential difference is held, an enable function of switching a signal between enabled and disabled states based on the enable signals EN1 and EN2 from the microcomputers 201 and 202. The enable function may be configured to be able to switch an enable signal between enabled and disabled states for each signal line, or may be configured to switch an enable signal between enabled and disabled states by collectively outputting one enable signal to a plurality of signal lines.

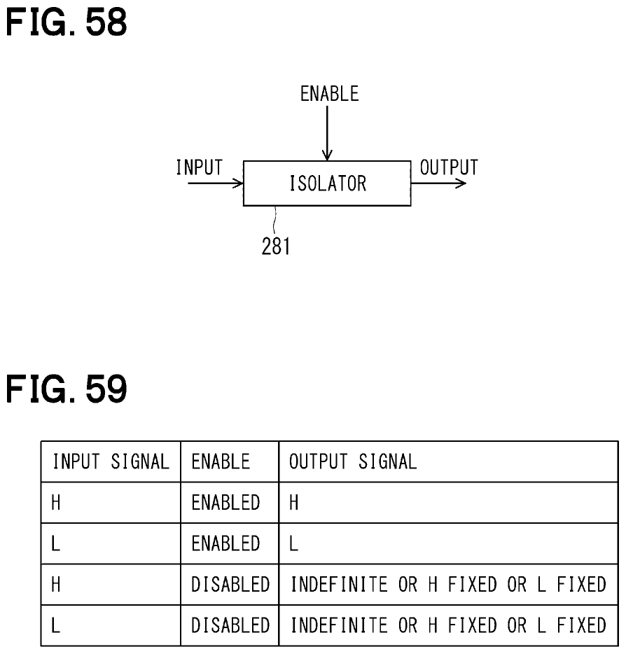

As illustrated in FIG. 58, the isolator 281 determines an output signal from the relationship between the input signal and the enable signal by using a logical operation or a switching element. For example, as illustrated in FIG. 59, in a case where the input signal is “H” and the enable signal is “enabled”, the output signal is “H”, and in a case where the input signal is “L” and the enable signal is “enabled”, the output signal is “L”. In a case where the enable signal is “disabled”, the output signal is set to “indefinite”, “H fixed”, or “L fixed” regardless of the input signal. The same applies to the isolator 282.

In the present embodiment, in the normal state, the microcomputers 201 and 202 perform microcomputer-to-driver communication with the driver components 801 and 802 of the own system, respectively. In a case where the microcomputer 202 is abnormal, the microcomputer 201 communicates with the driver components 801 and 802, and in a case where the microcomputer 201 is abnormal, the microcomputer 202 communicates with the driver components 801 and 802.

In the microcomputer-to-driver communication, the information transmitted from the microcomputers 201 and 202 includes duty command values Du1 and Du2 that are inverter control commands, and the information transmitted from the driver components 801 and 802 includes current detection values I1 and I2 and driver abnormality information E1 and E2.

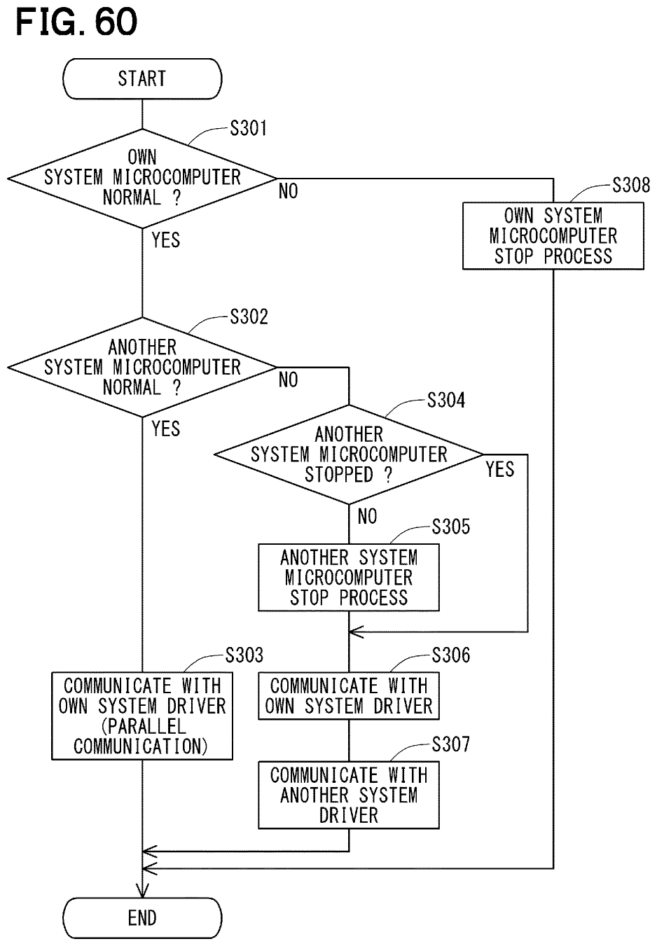

FIG. 60 is a flowchart for describing a communication process according to the present embodiment. This process is executed by the microcomputers 21 and 23 at a predetermined cycle in synchronization with each other. Here, the process by the microcomputer 21 will be described as an example in which the first control system is the own system and the second control system is another system. Note that the process by the microcomputer 23 may be appropriately interpreted by reading the second control system as the own system and the first control system as another system. The same applies to a flowchart according to an embodiment described later.

In S301, the microcomputer 201 determines whether the own system microcomputer is normal. In a case where it is determined that the own system microcomputer is not normal (S301: NO), the process proceeds to S308, and the own system microcomputer stop process is performed. In a case where it is determined that the own system microcomputer is normal (S301: YES), the process proceeds to S302.

In S302, the microcomputer 201 determines whether the microcomputer 202, which is another system microcomputer, is normal. The determination is made based on, for example, information acquired by microcomputer-to-microcomputer communication. In a case where it is determined that another system microcomputer is not normal (S302: NO), the process proceeds to S304. In a case where it is determined that another system microcomputer is normal (S302: YES), the process proceeds to S303.

In S303 to which the process proceeds in a case where both the own system and another system are determined to be normal, the microcomputer 201 sets the chip select signal CS11 to a state in which the driver component 801 is selected, sets the enable signal EN1 to the isolator 281 to a disabled state, and performs communication between the microcomputer 201 and then the driver component 801 in the own system. At the same time, in the second control system, which is another system, communication between the microcomputer 202 and the driver component 802 is performed.

Specifically, in the first control system, the chip select signal CS11 is in the selected state, the chip select signal CS12 is in the unselected state, and the enable signal EN1 is disabled. In the second control system, the chip select signal CS21 is in the selected state, the chip select signal CS22 is in the unselected state, and the enable signal EN2 is disabled. That is, here, by disabling the enable signals EN1 and EN2, transmission and reception of information in each control system are performed simultaneously in parallel.

In S304 to which the process proceeds in a case where it is determined that another system microcomputer is not normal (S302: NO), the microcomputer 201 determines whether another system microcomputer has stopped. In a case where it is determined that another system microcomputer has already stopped (S304: YES), S305 is skipped, and the process proceeds to S306. In a case where it is determined that another system microcomputer is not stopped (S304: NO), the process proceeds to S305, another system microcomputer stop process is performed, and the process proceeds to S306.

In S306, transmission and reception of information is performed between the microcomputer 201 and the driver component 801. At this time, the chip select signal CS11 is in the selected state, the chip select signal CS12 is in the unselected state, and the enable signal EN1 is disabled.

In S307, transmission and reception of information is performed between the microcomputer 201 and the driver component 802. At this time, the chip select signal CS11 is in the unselected state, the chip select signal CS12 is in the selected state, and the enable signal EN1 is enabled.

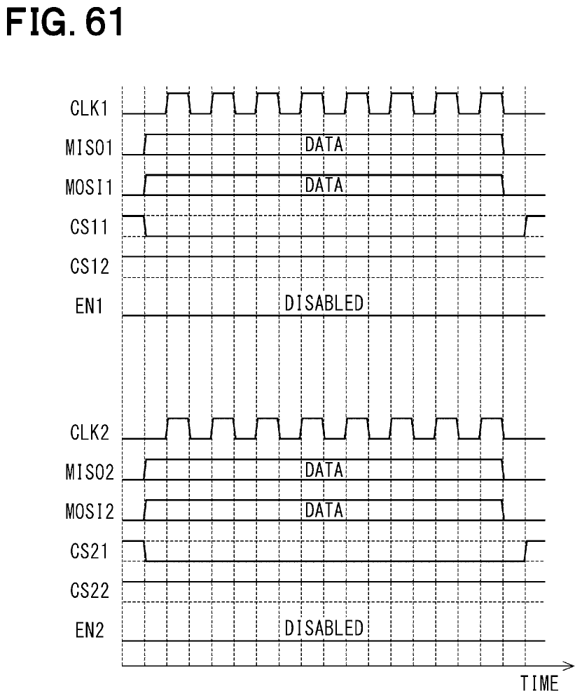

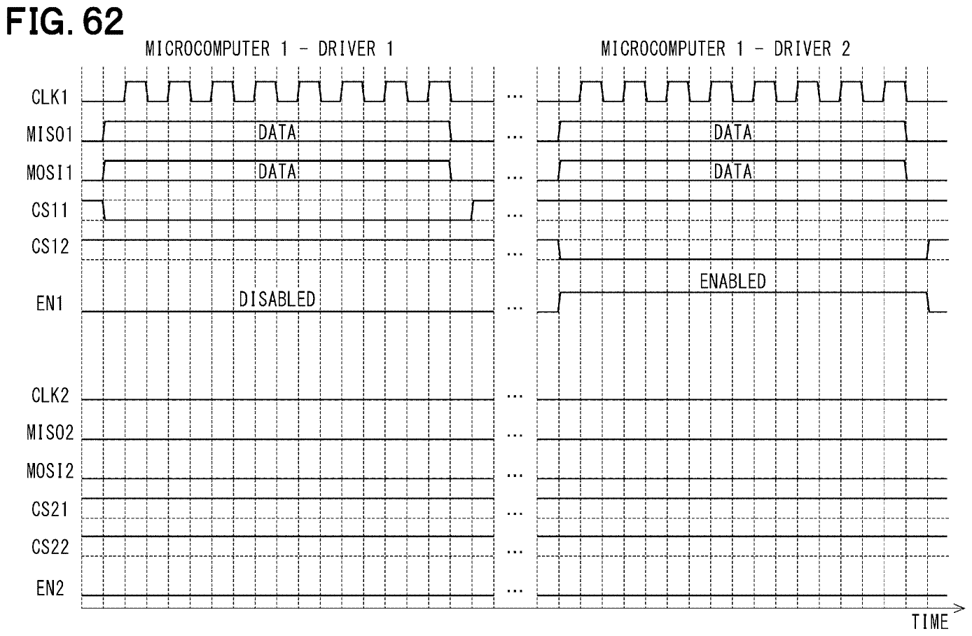

The communication process of the present embodiment will be described with reference to the time charts of FIGS. 61 and 62. In FIGS. 61 and 62, the horizontal axis represents the common time axis, the various signals output from the microcomputer 201 or the driver component 801 in the first control system are illustrated on the upper side, and the various signals output from the microcomputer 202 or the driver component 802 in the second control system are illustrated on the lower side.

Here, with respect to the enable signal EN, a case where the enable signal EN is enabled is described as H, and a case where the enable signal EN is disabled is described as L, but it is sufficient that enabled/disabled can be determined, and H may represent disabled, and L may represent enabled. In addition, an example in which the data frame length is 8 bits is illustrated, but the frame length is any length. The same applies to a time chart for describing a communication process according to an embodiment to be described later.

As illustrated in FIG. 61, in a case where both the microcomputers 201 and 202 are normal, the enable signals EN1 and EN2 are both disabled, data is transmitted and received between the microcomputer 201 and the driver component 801 in the first control system, and data is transmitted and received between the microcomputer 202 and the driver component 802 in the second control system. In the present embodiment, the signal lines between the microcomputer and the driver are connected by the inter-system connection lines 251 and 252, but the isolators 281 and 282 have an enable function, and communication in each control system can be performed in parallel by disabling the enable signal EN. As a result, a time difference in data acquisition between the systems can be reduced as compared with a case where communication is sequentially performed for each control system.

FIG. 62 illustrates an example of a case where the microcomputer 202 is abnormal. In a case where the microcomputer 202 is abnormal, the microcomputer 201 transmits and receives information to and from the driver components 801 and 802. As illustrated in the lower part of the sheet, the clock signal CKL2 and the SPI signal (MISO2, MOSI2) of the microcomputer 202 are both set to L, the chip select signals CS21 and CS22 are in the unselected state, and the enable signal EN2 is in the disabled state.

As illustrated in the upper part of the sheet, the microcomputer 201 uses a timer to alternately communicate with the driver components 801 and 802. As illustrated in the upper left part of the sheet, communication between the microcomputer 201 and the driver component 801 is similar to that in the normal state of FIG. 61. As illustrated in the upper right part of the sheet, in a case where communication is performed between the microcomputer 201 and the driver component 802, the chip select signal CS11 is in the unselected state, the chip select signal CS12 is in the selected state, and the enable signal EN1 is enabled. As a result, information can be transmitted and received between the microcomputer 201 and the driver component 802 via the inter-system connection line 251.

In a case where the microcomputer 201 is abnormal, the microcomputer 202 instead of the microcomputer 201 alternately communicates with the driver components 801 and 802. When communication is performed between the microcomputer 202 and the driver component 801, the chip select signal CS21 is in the unselected state, the chip select signal CS22 is in the selected state, and the enable signal EN2 is enabled. As a result, information can be transmitted and received between the microcomputer 202 and the driver component 801 via the inter-system connection line 252.

Note that communication can be established only by chip selection, but in a case where the chip selection signal fluctuates due to disturbance or the like, erroneous communication may be performed. Therefore, the enable signal EN is disabled by the enable function during a period in which communication with another system is not performed. In addition, although an example in the case of a failure of the microcomputer is described here, it is preferable to separate the driver in the case of a failure of the driver.

In the present embodiment, the inter-system connection lines 251 and 252 connect the control systems via the isolators 281 and 282 that enable information transmission while maintaining a potential difference. The isolators 281 and 282 are capable of receiving the enable signals EN1 and EN2 from the microcomputers 201 and 202, respectively, and communication between the systems is enabled in a case where the enable signals EN1 and EN2 are in the enabled state, and communication between the systems is prohibited in a case where the enable signals EN1 and EN2 are in the disabled state.

In the present embodiment, the inter-system connection lines 251 and 252 connect the intra-system communication lines C1 and C2, and the intra-system communication lines C1 and C2 are shared for communication in the system and communication between the systems. Therefore, by using the enable signals EN1 and EN2, communication in the system and communication between the systems can be appropriately performed.

The microcomputer 201 communicates with the driver component 801 of the own system in a case where the microcomputer 202 of another system is normal, and communicates with the driver component 801 of the own system and the driver component 802 of another system in a case where the microcomputer 202 of another system is abnormal. The microcomputer 202 communicates with the driver component 802 of the own system in a case where the microcomputer 201 of another system is normal, and communicates with the driver component 802 of the own system and the driver component 801 of another system in a case where the microcomputer 201 of another system is abnormal. The communication data includes a duty command value, a current detection value, abnormality information, and the like. Thus, even in a case where an abnormality occurs in one of the microcomputers, the motor 11 can be continuously driven using the two sets of motor windings 121 and 123. Further, the same effects as those of the above embodiment are obtained.

### Twentieth Embodiment

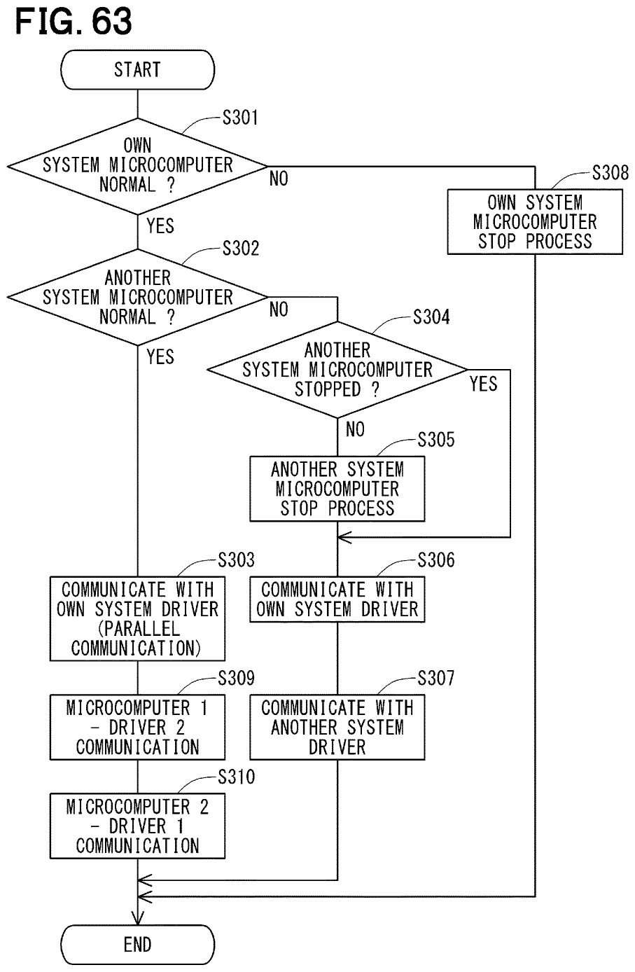

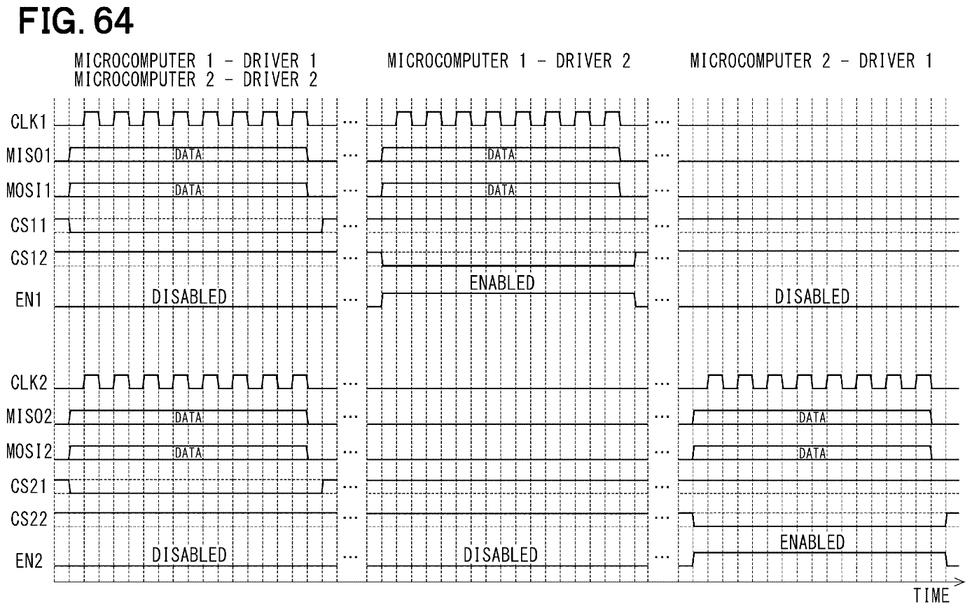

The twentieth embodiment is illustrated in FIGS. 63 and 64. The communication process of the present embodiment will be described with reference to the flowchart of FIG. 63. FIG. 63 is different from FIG. 60 in that S309 and S310 that proceed after S303 are added.

In S309 in which both the own system and another system are normal and to which the process proceeds after the parallel communication in each system is performed in S303, communication between the microcomputer 201 and the driver component 802 is performed, and in S310, communication between the microcomputer 202 and the driver component 801 is performed. The processing order may be switched between S309 and S310. The microcomputers 201 and 202 synchronize the timers by microcomputer-to-microcomputer communication or the like, and sequentially communicate with another system.

The communication process of the present embodiment will be described with reference to a time chart of FIG. 64. The left side of the sheet of FIG. 64 corresponds to S303, and the enable signals EN1 and EN2 are turned off to perform microcomputer-to-driver communication in each system. The state of the signal is similar to that in FIG. 61.

The center of the sheet of FIG. 64 corresponds to S309, and communication is performed between the microcomputer 201 and the driver component 802. In a case where communication is performed between the microcomputer 201 and the driver component 802, the chip select signal CS12 is in the selected state, the other chip select signals CS11, CS21, and CS22 are in the unselected state, the enable signal EN1 is enabled, the enable signal EN2 is disabled, and SPI communication is performed between the microcomputer 201 and the driver component 802.

The right side of the sheet of FIG. 64 corresponds to S310, and communication is performed between the microcomputer 202 and the driver component 801. In a case where communication is performed between the microcomputer 202 and the driver component 801, the chip select signal CS22 is in the selected state, the other chip select signals CS11, CS12, and CS21 are in the unselected state, the enable signal EN2 is enabled, the enable signal EN1 is disabled, and SPI communication is performed between the microcomputer 202 and the driver component 801. Communication at the time of a microcomputer abnormality is similar to that in the nineteenth embodiment.

In the present embodiment, even in a case where both the microcomputers 201 and 202 are normal, communication with the driver components 802 and 801 of another system is performed using the inter-system connection lines 251 and 252. Thus, the load of the microcomputer-to-microcomputer communication can be reduced. Alternatively, the microcomputer-to-microcomputer communication can be omitted. Even with such a configuration, the same effects as those of the above embodiment are obtained.

### Twenty-First Embodiment

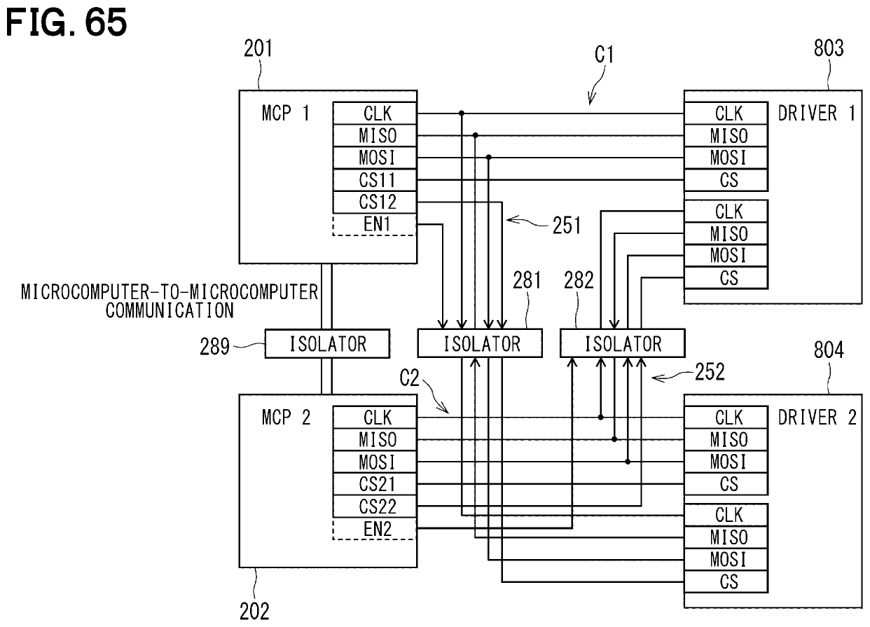

The twenty-first embodiment is illustrated in FIGS. 65 to 67. In the nineteenth embodiment, the inter-system connection line 251 is connected to the intra-system communication line C2 of the second control system via the isolator 281, and the inter-system connection line 252 is connected to the intra-system communication line C2 of the first control system via the isolator 282.

On the other hand, in the present embodiment, as illustrated in FIG. 65, each of the driver components 803 and 804 has communication ports connected to another system via the isolators 281 and 282, in addition to communication ports used for communication with the own system microcomputer. The inter-system connection line 251 is directly connected to the driver component 804 via the isolator 281, and the inter-system connection line 252 is directly connected to the driver component 803 via the isolator 282. Accordingly, communication between the microcomputer 201 and the driver component 804 and communication between the microcomputer 202 and the driver component 803 can be simultaneously performed.

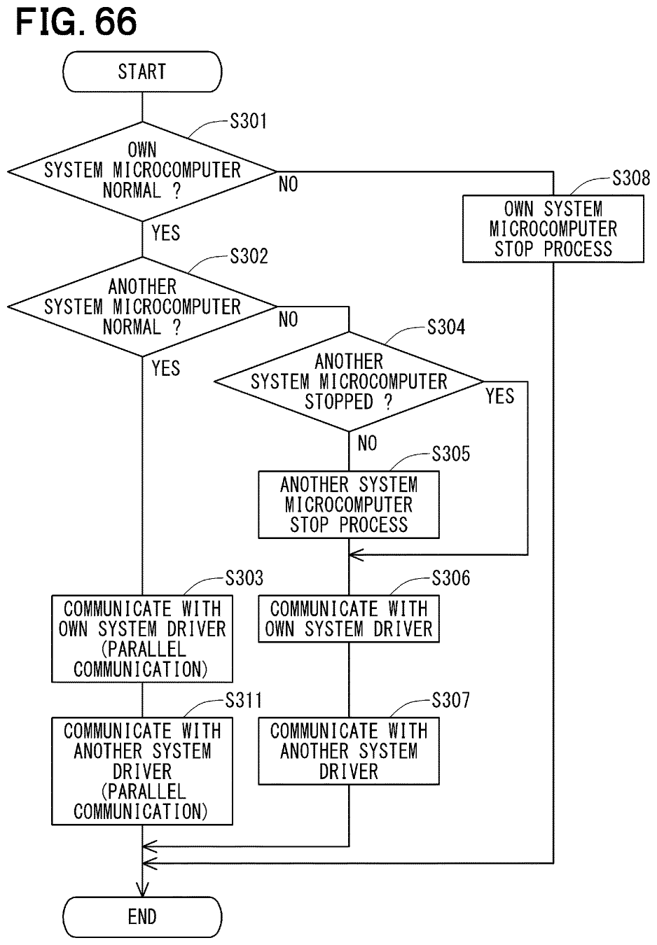

The communication process of the present embodiment will be described with reference to the flowchart of FIG. 66. FIG. 66 is different from FIG. 63 in that S311 is used instead of S309 and S310. In S311 in which both the own system and another system are normal and to which the process proceeds after the parallel communication in each system is performed in S303, the microcomputer 201 communicates with the driver component 804 of another system. At the same time, the microcomputer 202 communicates with the driver component 803.

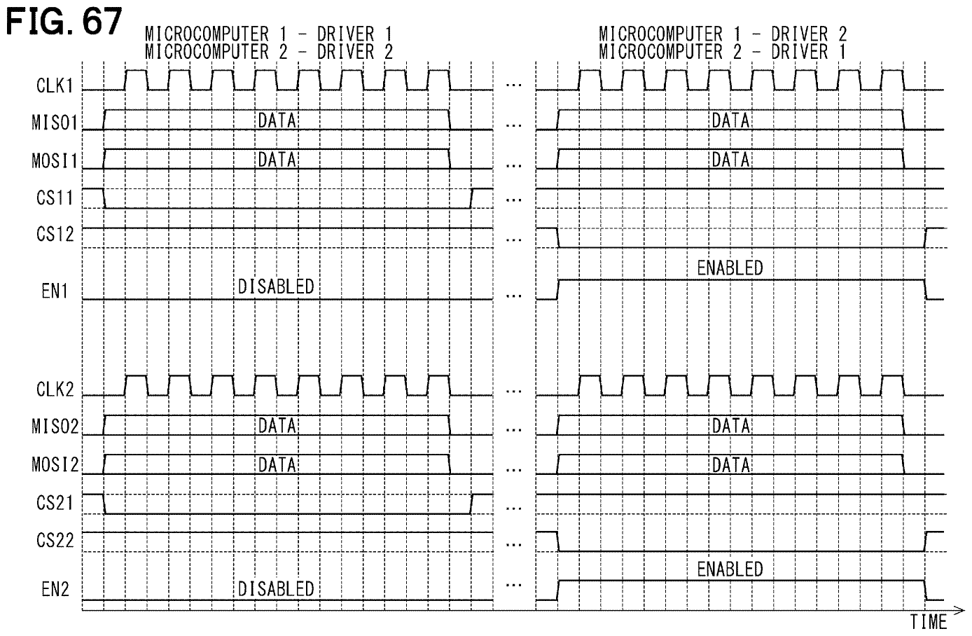

The communication process of the present embodiment will be described with reference to a time chart of FIG. 67. The left side of the sheet of FIG. 67 corresponds to S303, and the enable signals EN1 and EN2 are disabled to perform microcomputer-to-driver communication in each system. The state of the signal is similar to that in FIG. 61.

The right side of the sheet of FIG. 67 corresponds to S311, and communication between the microcomputer 201 and the driver component 804 and communication between the microcomputer 202 and the driver component 803 are performed in parallel. The microcomputer 201 causes the chip select signal CS11 to be in the unselected state, the chip select signal CS12 to be in the selected state, and the enable signal EN1 to be enabled, and SPI communication is performed between the microcomputer 201 and the driver component 804. The microcomputer 202 causes the chip select signal CS21 to be in the unselected state, the chip select signal CS22 to be in the selected state, and the enable signal EN2 to be enabled, and SPI communication is performed between the microcomputer 202 and the driver component 803.

In the present embodiment, since the port for communication in the system and the port for communication with another system are separately provided, the microcomputers 201 and 202 can communicate with the driver components 804 and 803 of another system in parallel by controlling the chip select signal CS and the enable signal EN. As a result, it is possible to reduce the time difference between the data acquired by the microcomputers 201 and 202 from the driver. Furthermore, the communication time can be reduced.

In the present embodiment, the inter-system connection line 251 connects the intra-system communication line C1 and the driver component 804 of another control system, and the inter-system connection line 252 connects the intra-system communication line C2 and the driver component 803 of another control system. In the driver components 803 and 804, the communication ports to which the inter-system connection lines 251 and 252 are connected are provided separately from the ports to which the intra-system communication lines C1 and C2 are connected. Accordingly, the microcomputer-to-driver communication with another system can be performed in parallel. Further, the same effects as those of the above embodiment are obtained.

### Twenty-Second Embodiment

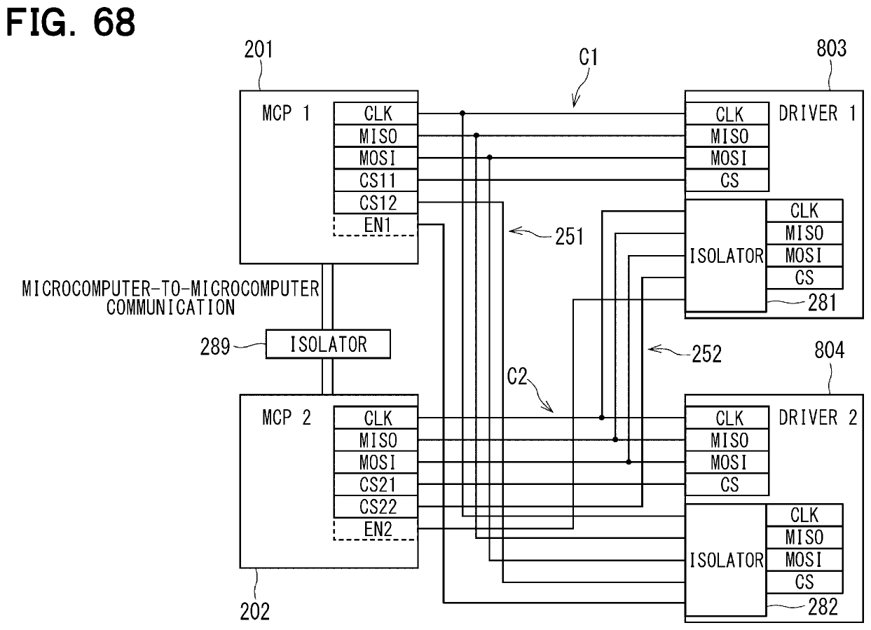

FIG. 68 illustrates the twenty-second embodiment. The present embodiment is different from the twenty-first embodiment in the mounting position of the isolator. As illustrated in FIG. 68, the isolators 281 and 282 of the present embodiment are built in the driver components 803 and 804. By incorporating the isolators 281 and 282 in the driver components 803 and 804, component arrangement and wiring of the substrate 75 can be simplified. Note that the communication process and the like are similar to those in the twenty-first embodiment. Further, the same effects as those of the above embodiment are obtained.

### Twenty-Third Embodiment

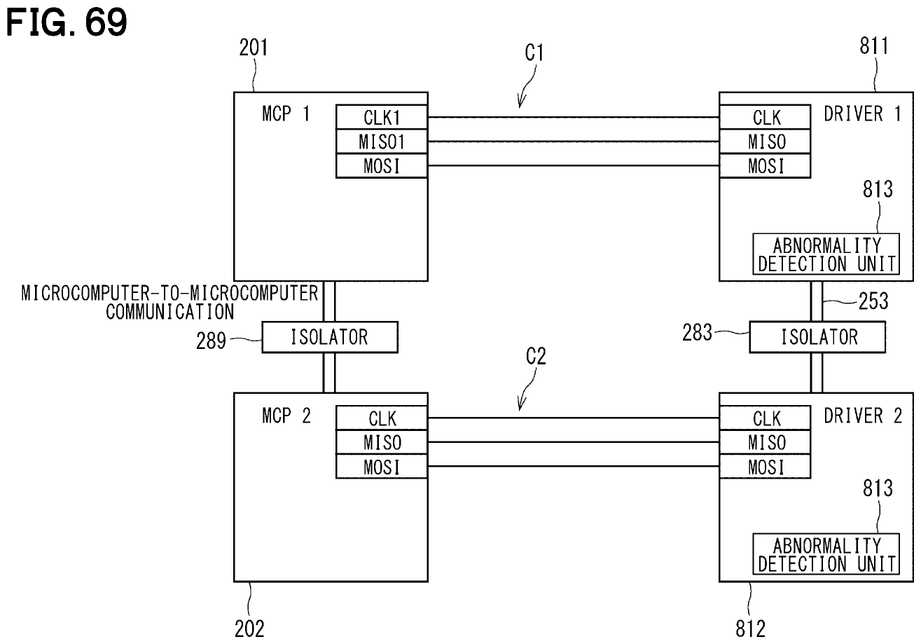

The twenty-third embodiment is illustrated in FIGS. 69 to 76. In the twenty-third embodiment and the twenty-fourth embodiment, the driver components 811 and 812 are connected by the inter-system connection line 253, and the isolator 283 is provided in the inter-system connection line 253. As a result, communication can be performed between the driver components 811 and 812 without going through the microcomputers 201 and 202. In the example of FIG. 69, the isolator 283 is provided in the inter-system connection line 253, but the isolator 283 may be built in at least one of the driver components 811 and 812 as in the twenty-second embodiment. The same applies to the twenty-fourth embodiment. Further, the isolator 283 may have an enable function as in the above embodiment.

The driver components 811 and 812 include a driver abnormality detection unit 813 and the like. The driver abnormality detection unit 813 detects an abnormality of the own system such as an internal voltage abnormality, a communication abnormality, and an output voltage abnormality. The information about the driver abnormal state is transmitted to the microcomputer of the own system and the driver component of another system. In a case where a notification of the driver abnormality is made, the microcomputers 201 and 202 perform an abnormality process.

The driver component 811 transmits the duty command value Du1 and the current detection value I1 of the own system to the driver component 812 of another system by inter-driver communication, and receives the duty command value Du2 and the current detection value I2 of another system from the driver component 812. The driver component 812 transmits the duty command value Du2 and the current detection value I2 of the own system to the driver component 811 of another system by inter-driver communication, and receives the duty command value Du1 and the current detection value I1 of another system from the driver component 811. In the driver components 811 and 812, the duty command value, the current detection value, and the driver abnormal state of both systems are updated as needed.

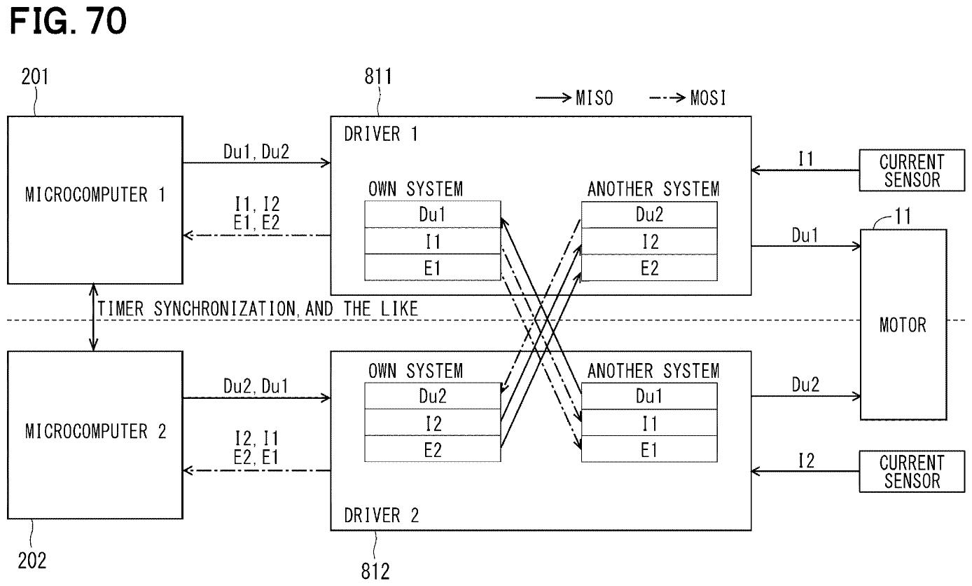

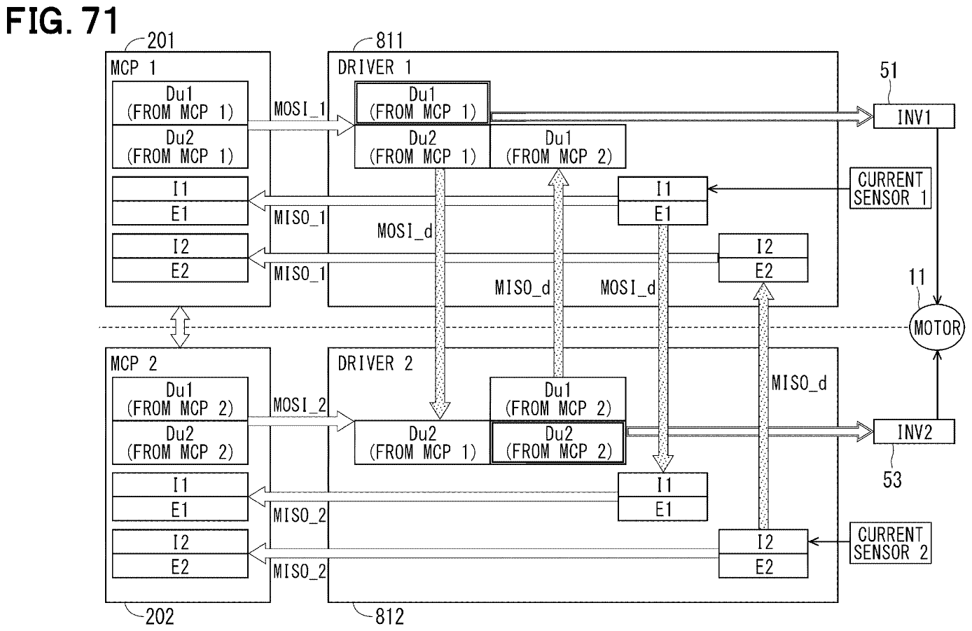

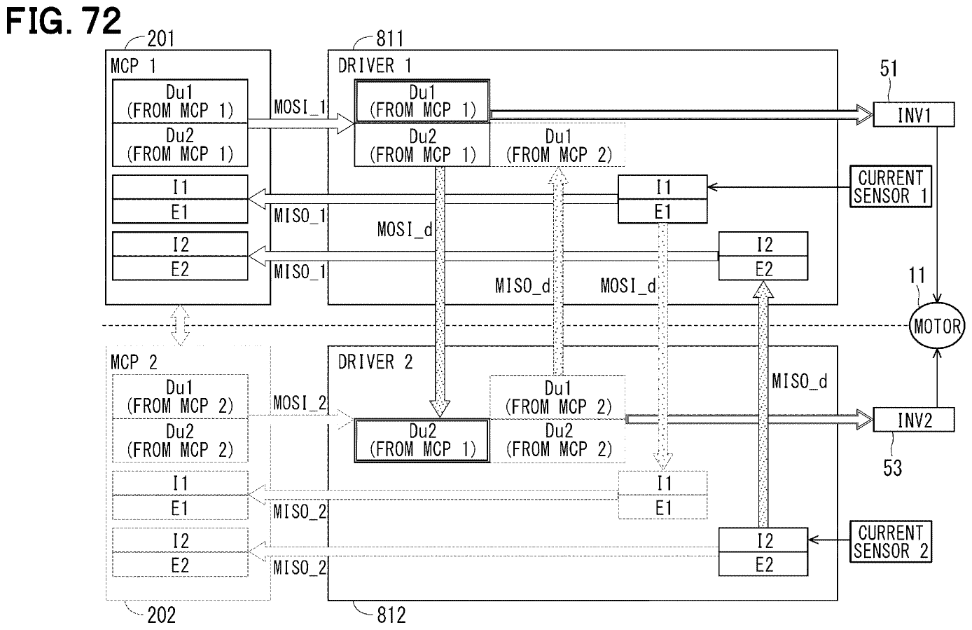

FIGS. 70 and 71 illustrate data flows in the microcomputers 201 and 202 and the driver components 811 and 812. In FIG. 70, the MISO signal is indicated by a solid line, and the MOSI signal is indicated by an alternate long and short dash line for microcomputer-to-driver communication and driver-to-driver communication. Note that signal lines at the other portions are indicated by solid lines, but do not mean that the signal lines are MISO signals. In FIGS. 71 and 72, the microcomputer-to-driver communication is indicated by a white block arrow, the driver-to-driver communication is indicated by a satin block arrow, and values used for motor driving are indicated by double lines. The driver circuits 51 and 53 are referred to as an “INV1” and an “INV2”, respectively.

In the microcomputer-to-driver communication in the system, SPI communication is performed with the microcomputers 201 and 202 as masters and the driver components 811 and 812 as slaves. In the inter-driver communication, here, an example is illustrated in which communication is performed with the driver component 811 as the master and the driver component 812 as the slave, but the driver component 812 may be used as the master and the driver component 811 may be used as the slave.

In the inter-driver communication, the driver component 811 receives the current detection value I2 and the driver abnormality information E2 of the second control system and the duty command value Du1 related to the first control system from the driver component 812 through MISO_d. In addition, the driver component 811 transmits the current detection value I1 and the driver abnormality information E1 of the first control system and the duty command value Du2 related to the second control system through MOSI_d.

In the microcomputer-to-driver communication, the microcomputer 201 transmits the duty command values Du1 and Du2 of the own system and another system to the driver component 811 through MOSI_1. The microcomputer 201 receives the current detection values I1 and I2 and the driver abnormality information E1 and E2 of the own system and another system from the driver component 811 through MISO_1.

The microcomputer 202 transmits the duty command values Du2 and Du1 of the own system and another system to the driver component 812 through MOSI_2. The microcomputer 202 receives the current detection values I2 and I1 and the driver abnormality information E2 and E1 of the own system and another system from the driver component 812 through MISO_2. In a case where the microcomputers 201 and 202 of the own system are normal, the driver components 811 and 812 control the driver circuits 51 and 53 using the duty command values Du1 and Du2 transmitted from the microcomputers 201 and 202 of the own system, and control energization of the motor windings 121 and 123.

In FIGS. 70 and 71, the information about the own system and another system is transmitted and received through the microcomputer-to-driver communication regardless of the states of the microcomputers 201 and 202. However, in a case where the microcomputer of another system is normal, the information about another system may not be transmitted and received. The duty command value transmitted to another system through the inter-driver communication may be calculated from the duty command value of the own system by the driver components 811 and 812 (see Expression (1)). In Expression, “D*own” is a duty command value of the own system, “D*another” is a duty command value of another system, and K is an offset value according to a phase difference of the motor winding.

D*another=D*own+K (1)

A case where one microcomputer (here, the microcomputer 202) is abnormal will be described with reference to FIG. 72. In a case where the microcomputer 202 is abnormal, microcomputer-to-microcomputer communication and microcomputer-to-driver communication between the microcomputer 202 and the driver component 812 cannot be performed. In FIG. 72, a broken line indicates units in which transmission and reception cannot be performed due to an abnormality in the microcomputer 202. Here, only a characteristic unit at the time of abnormality will be described, and description of a unit common to the units in the normal state will be appropriately omitted.

In a case where the microcomputer 202 is abnormal, the driver component 812 transmits the current detection value I2 and the abnormality information E2 of the own system to the driver component 811 through MISO_d. The driver component 811 transmits the current detection value I2 and the driver abnormality information E2 of the second control system to the microcomputer 201 through MISO_1, in addition to the current detection value I1 and the driver abnormality information E1 of the own system.

The microcomputer 201 calculates the duty command value Du2 based on the current detection value I2 of the second control system. The duty command values Du1 and Du2 may be calculated based on the current detection values I1 and I2 by controlling the sum and the difference. The same applies to the control in the normal state. The duty command value Du2 calculated by the microcomputer 201 is transmitted to the driver component 801 through MOSI_1. The driver component 801 transmits the duty command value Du2 to the driver component 802 through MOSI. The driver component 802 controls the driver circuit 53 using the duty command value Du2 received from the first control system to control energization of the motor winding 123.

In a case where the microcomputer 201 is abnormal, the duty command value Du2 calculated by the microcomputer 202 is transmitted to the driver component 811 through the microcomputer-to-driver communication, and is transmitted from the driver component 811 to the driver component 812 through the inter-driver communication. As a result, even in a case where one of the microcomputers 201 and 202 is abnormal, motor driving in the two systems can be continued.

In a case where the driver component 811 is abnormal, the motor drive signal output to the driver circuit 51 is stopped, and single-system driving is performed in the second system. In addition, in a case where the driver component 812 is abnormal, the motor drive signal output to the driver circuit 53 is stopped, and single-system driving is performed in the first system. The stop command of the motor drive signal may be output from one of the own system microcomputer, another system driver, and another system microcomputer, the one having acquired the information related to the driver abnormality. In a configuration for stopping the motor drive signal, for example, relays may be provided at the output units of the pre-driver ICs 61 and 63 to block the signal, or the pre-driver ICs 61 and 63 may have functions allowing the output to be stopped from the outside.

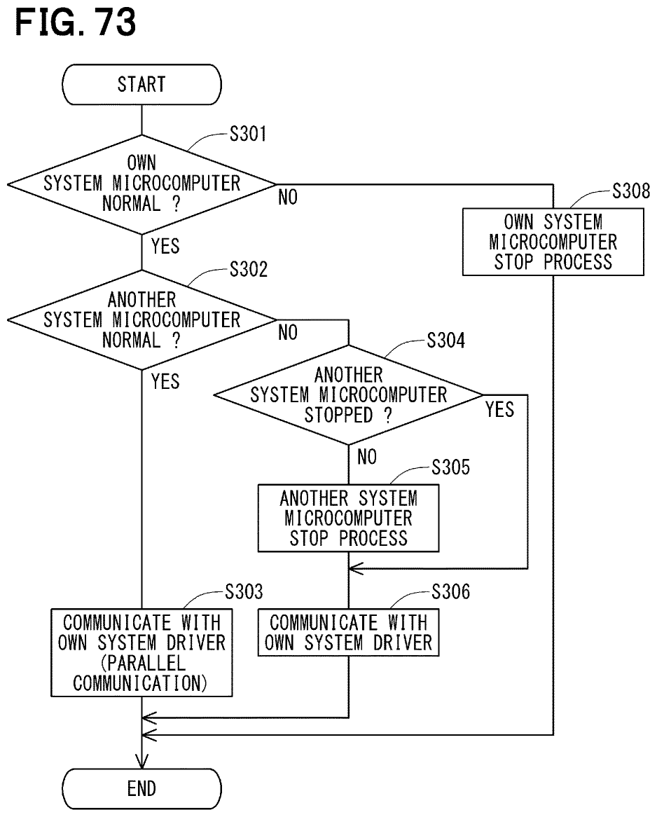

FIG. 73 is a flowchart illustrating the microcomputer-to-driver communication process according to the present embodiment. FIG. 71 is similar to FIG. 60 except that step S307 is omitted. That is, in the present embodiment, the inter-system connection line 253 is provided between the drivers, and the microcomputer 201 acquires information about the driver component 812, which is another system driver, via the driver component 811, which is the driver of the own system, so that the microcomputer 201 does not directly transmit and receive information to and from the driver component 812.

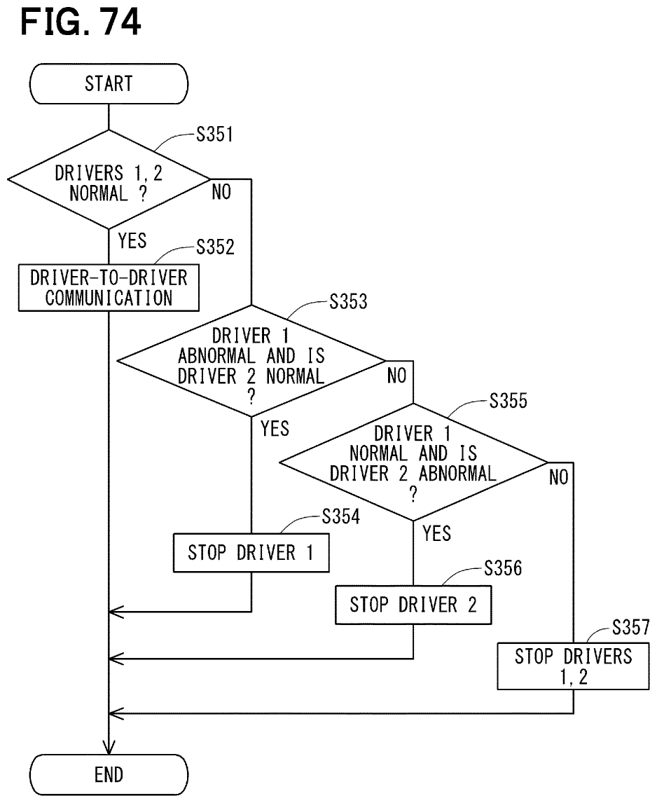

The driver-to-driver communication process is illustrated in the flowchart of FIG. 74. The communication frequency of the driver-to-driver communication is higher than the communication frequency of the microcomputer-to-driver communication. Although processing of the driver component 811 will be described here, similar processing is performed in the driver component 812.

In S351, the driver component 811 determines whether both the driver component 811 and the driver component 812 are normal. In a case where it is determined that both the driver component 811 and the driver component 812 are normal (S351: YES), the process proceeds to S352 to perform driver-to-driver communication. In a case where it is determined that at least one of the driver component 811 and the driver component 812 is abnormal (S351: NO), the process proceeds to S353.

In S353, the driver component 811 determines whether the driver component 811 is abnormal and whether the driver component 812 is normal. In a case where it is determined that the driver component 811 is abnormal and the driver component 812 is normal (S353: YES), the process proceeds to S354 to stop the driver component 811. In a case where it is determined that the driver component 811 is abnormal and the driver component 812 is not normal (S353: NO), the process proceeds to S355.

In S355, the driver component 811 determines whether the driver component 811 is normal and whether the driver component 812 is abnormal. In a case where it is determined that the driver component 811 is normal and the driver component 812 is abnormal (S355: YES), the process proceeds to S356 to stop the driver component 812. In a case where both the driver components 811 and 812 are abnormal (S355: NO), the process proceeds to S366 to stop the driver components 811 and 812.

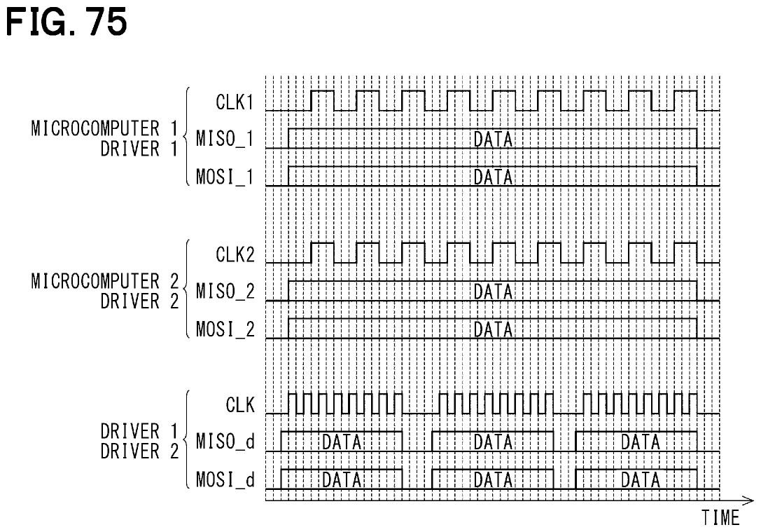

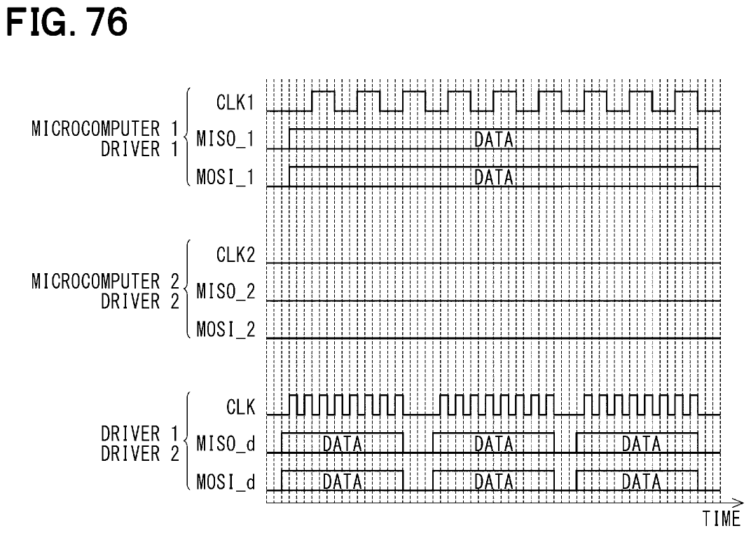

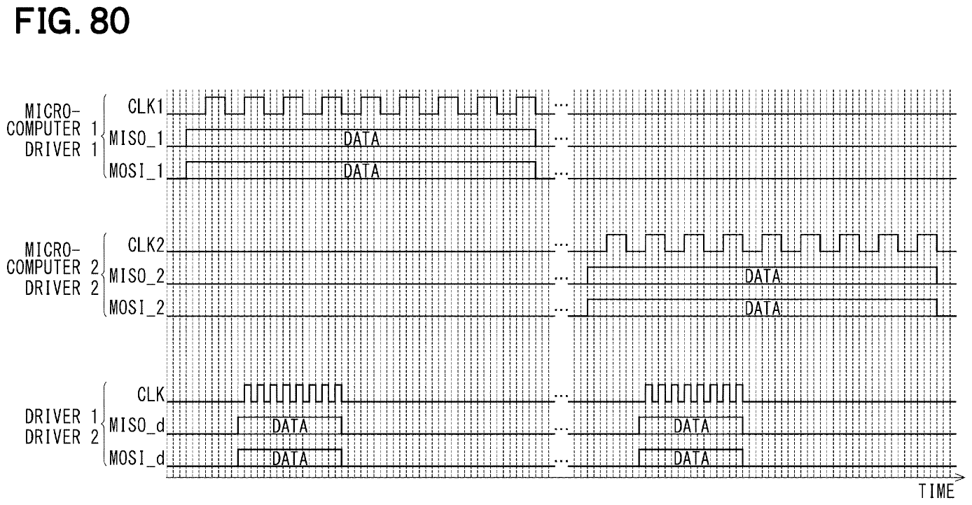

The communication process of the present embodiment will be described with reference to the time charts of FIGS. 75 and 76. In FIGS. 75 and 76, communication between the microcomputer 201 and the driver component 811 is illustrated in the upper part of the sheet, communication between the microcomputer 202 and the driver component 812 is illustrated in the middle part of the sheet, and communication between the driver components 811 and 812 is illustrated in the lower part of the sheet. The same applies to communication in FIG. 80 described later.

As illustrated in FIG. 75, In a case where both the microcomputers 201 and 202 are normal, communication between the microcomputer 201 and the driver component 811, communication between the microcomputer 202 and the driver component 812, and communication between the driver components 811 and 812 are performed in parallel. In FIG. 75, the frequency of the inter-driver communication is three times the frequency of the microcomputer-to-driver communication, but the communication frequency can be set in any frequency.

As illustrated in FIG. 76, in a case where the microcomputer 202 is abnormal, communication between the microcomputer 202 and the driver component 812 is not performed. Communication between the microcomputer 201 and the driver component 811 and communication between the driver components 811 and 812 are similar to those in the normal state. The microcomputer 201 transmits the duty command values Du1 and Du2 of the own system and another system to the driver component 811, and receives the current detection values I1 and I2 and the driver abnormality information E1 and E2 of the own system and another system from the driver component 811.

In the present embodiment, since the inter-system connection line 253 for performing driver-to-driver communication is provided independently of the intra-system communication lines C1 and C2, it is possible to execute microcomputer-to-driver communication and driver-to-driver communication in each control system in parallel. As a result, the data simultaneity between the drivers is improved by increasing the communication speed.

The inter-system connection line 253 connects the driver components 811 and 812 of different control systems. The microcomputer 201 can transmit the duty command value Du2 to the driver component 812 of another system via the driver component 811 of the own system, and can receive, from the driver component 812 of another system, the current detection value I2 which is the sensor data and the driver abnormality information E2 of the another system. The microcomputer 202 can transmit the duty command value Du1 to the driver component 811 of another system via the driver component 812 of the own system, and can receive, from the driver component 811 of another system, the current detection value I1 which is the sensor data and the driver abnormality information E1 of the another system.

In the present embodiment, information about the own system and information about another system are continuously updated between the driver components 811 and 812. Thus, the microcomputers 201 and 202 can appropriately communicate with another system via the driver components 811 and 812 of the own system. Further, the same effects as those of the above embodiment are obtained.

### Twenty-Fourth Embodiment

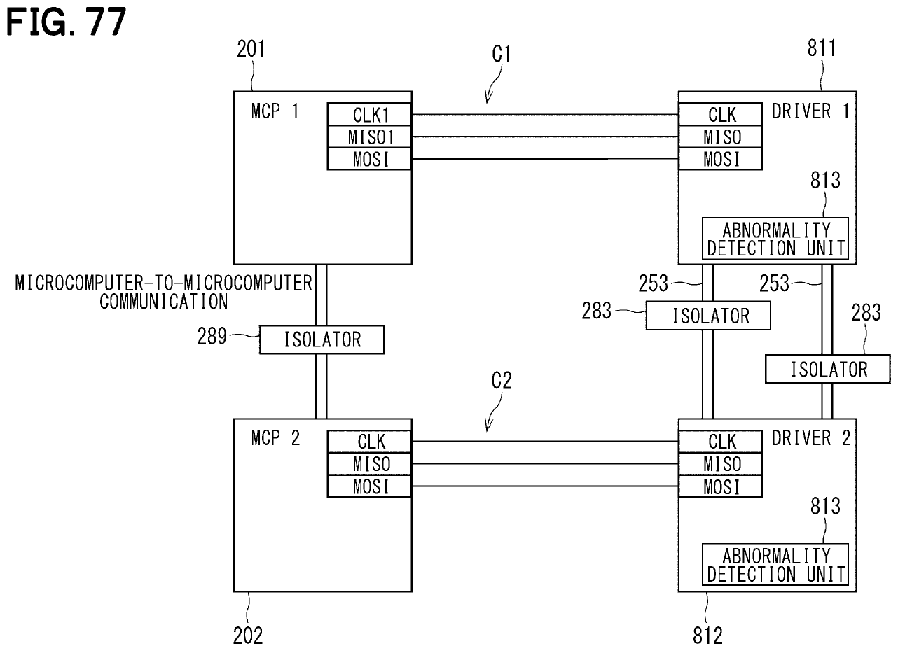

The twenty-fourth embodiment is illustrated in FIGS. 77 to 80. As illustrated in FIG. 77, the driver components 811 and 812 are provided with two sets of inter-system connection lines 253, and each is provided with the isolator 283. One of the two sets of inter-system connection lines 253 is a communication line with the driver component 811 as a master and the driver component 812 as a slave, and the other is a communication line with the driver component 812 as a master and the driver component 811 as a slave.

In the twenty-third embodiment, the driver-to-driver communication is constantly performed. On the other hand, in the present embodiment, when another system access command is issued by the microcomputer and the another system access command is received by the driver component, communication between the drivers is performed. Hereinafter, a case where the driver component 811 is a master and the driver component 812 is a slave will be described as an example. The microcomputer 201 is configured to be able to transmit, to the driver component 811, two commands of a command for performing reading and writing of only the own system (hereinafter referred to as “R/W”) and a command for performing R/W of the own system and another system. The command for performing R/W of the own system and another system corresponds to “another system access command”.

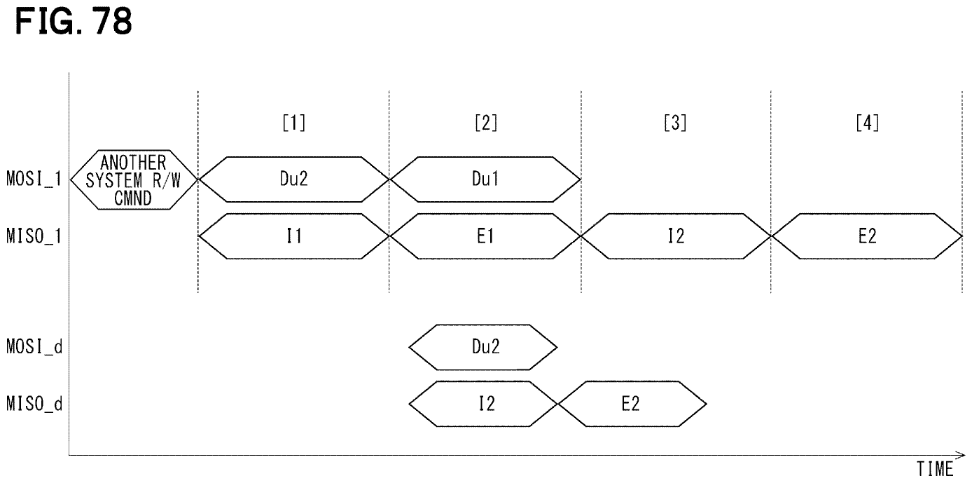

A data flow of the present embodiment will be described with reference to FIG. 78. When the driver component 811 receives the R/W commands of the own system and another system from the microcomputer 201, the duty command value Du2 of another system is transmitted from the microcomputer 201 to the driver component 811 and the current detection value I1 of the own system is transmitted from the driver component 811 to the microcomputer 201 in the period [1] through the microcomputer-to-driver communication.

In the period [2], the microcomputer 201 transmits the duty command value Du1 of the own system to the driver component 811 through the microcomputer-to-driver communication, and the driver component 811 transmits the abnormality information E1 of the driver of the own system to the microcomputer 201. The driver component 811 performs inter-driver communication in parallel while returning data of the own system to the microcomputer 201. Specifically, the driver component 811 transmits the duty command value Du2 to the driver component 812 through the inter-driver communication, and the driver component 812 transmits the current detection value I2 to the driver component 811. The driver component 812 transmits the driver abnormality information E2 of the second control system, following the current detection value I2, to the driver component 811.

The driver component 811 transmits the current detection value I2 of another system to the microcomputer 201 in the period [3] after the reception of the current detection value I2 is completed, and transmits the abnormal state of another system to the microcomputer 201 in the period [4] after the reception of the driver abnormality information E2 of the second control system is completed.

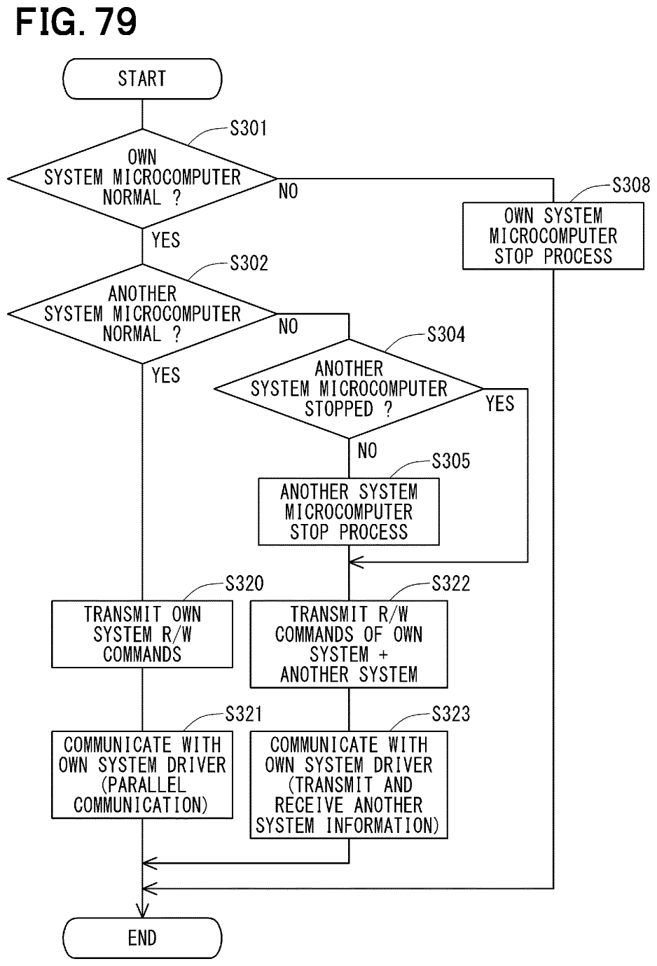

The microcomputer-to-driver communication process according to the present embodiment will be described with reference to the flowchart of FIG. 79. The processing in S301 to S305 and S308 is similar to that in FIG. 73. In S320 to which the process proceeds in a case where both the microcomputers 201 and 202 are normal (S301: YES, and S302: YES), the microcomputer 201 transmits a command for performing R/W of only the own system to the driver component 811. The process of S321 is similar to that of S303, and the microcomputer 201 communicates with the driver component 811. At the same time, in the second control system, which is another system, the microcomputer 202 communicates with the driver component 812. In a case where communication with another system is performed even when both the microcomputers 201 and 202 are normal, the process may proceed to S322 after positive determination is made in S302.

In S322 in which the microcomputer 202 that is another system microcomputer is abnormal and to which the process proceeds after another system microcomputer is stopped, the microcomputer 201 transmits the R/W commands of the own system and another system to the driver component 811.

In S323, the microcomputer 201 performs microcomputer-to-driver communication with the driver component 811. At this time, the driver components 811 and 812 perform inter-driver communication, and the microcomputer 201 transmits and receives the duty command value Du2, the current detection value I2, and the driver abnormality information E2 via the driver component 811.

The communication process of the present embodiment will be described with reference to a time chart of FIG. 80. The left side of FIG. 80 illustrates a case where the driver component 811 is set as the master in the inter-driver communication, and the right side of FIG. 80 illustrates a case where the driver component 812 is set as the master in the inter-driver communication. Here, information communication of another system will be mainly described, and description of information communication in the system will be omitted.

As illustrated on the left side of the sheet, in a case where the driver component 811 is set as the master, the microcomputer 201 transmits the R/W commands of the own system and another system and the duty command value Du2 of another system to the driver component 811. After recognizing the command, the driver component 811 performs inter-driver communication, transmits the duty command value Du2 to the driver component 812, and receives the current detection value I2 and the driver abnormality information E2 of another system from the driver component 812. The driver component 811 transmits the current detection value I2 and the driver abnormality information E2 received from the driver component 812 to the microcomputer 201.

As illustrated on the right side of the sheet, in a case where the driver component 812 is set as the master, the microcomputer 202 transmits the R/W commands of the own system and another system and the duty command value Du1 of another system to the driver component 812. After recognizing the commands, the driver component 812 performs inter-driver communication, transmits the duty command value Du1 to the driver component 811, and receives the current detection value I1 and the driver abnormality information E1 of another system from the driver component 811. The driver component 812 transmits the current detection value I1 and the driver abnormality information E1 received from the driver component 811 to the microcomputer 202. As a result, even in a case where an abnormality occurs in one of the microcomputers 201 and 202, motor driving in the two systems can be continued.

In the present embodiment, the driver components 811 and 812 communicate with the driver components 812 and 811 of another system in response to commands from the microcomputers 201 and 202 of the own system. Even with this configuration, communication between the systems can be appropriately performed. Further, the same effects as those of the above embodiment are obtained.

In the embodiment, the motor 11 corresponds to a “load”, the ECU 15 corresponds to a “communication device”, the motor winding 121 corresponds to a “first winding set”, the motor winding 122 corresponds to a “second winding set”, the motor winding 123 corresponds to a “third winding set”, the motor winding 124 corresponds to a “fourth winding set”, the microcomputers 21 to 24 correspond to “control Units” or “controllers”, the Driver Components 701 to 704, 801 to 804, 811, and 812, the power supply ICs 31 and 33, the communication units 36 and 38, and the position sensors 66 to 69 correspond to “electronic components”, and the isolators 28 and 281 to 283 correspond to “system separation components”. The processing cores 211, 212, 231, and 232 correspond to “processing circuits”, the processing core 211 corresponds to a “first processing circuit”, the processing core 212 corresponds to a “second processing circuit”, the processing core 231 corresponds to a “third processing circuit”, and the processing core 232 corresponds to a “fourth processing circuit”. The duty command values Du1 and Du2 correspond to “drive commands”, and the current detection values I1 and I2 correspond to “sensor data”.

### Other Embodiments

In the above embodiment, the example in which the power supply system has 2 to 4 systems and the control system has 2 to 4 systems has been mainly described. In another embodiment, the number of power supply ICs, microcomputers, processing cores, pre-driver ICs, driver circuits, motor windings, and the like can be set in any number according to required redundancy, mounting space, and the like. In addition, the numbers of components may be different; for example, the number of fragile components (for example, a microcomputer or a driver circuit) may be four and the number of other components may be three.

In the above embodiment, the electronic component is mainly a driver component in which a pre-driver IC is built. In another embodiment, the electronic component is only required to be capable of performing digital communication with the microcomputer, and may be, for example, a pre-driver IC, a sensor, or the like provided separately from the driver circuit. In the above embodiment, it is described that the electronic components of the respective systems are the same. In another embodiment, the electronic components of the respective systems may have different outputs, different accuracy, and the like.

In the above embodiment, the duty command value, the current detection value, and the driver abnormality information are transmitted and received through microcomputer-to-driver communication or driver-to-driver communication. In another embodiment, part of the duty command value, the current detection value, and the driver abnormality information may be omitted or other information may be included as the information transmitted and received through microcomputer-to-driver communication or driver-to-driver communication. In the above embodiment, the duty command value is used as the drive command. In another embodiment, a value other than the duty command value may be used as the drive command. In the above embodiment, as the sensor data, the current detection value is shared by microcomputer-to-driver communication or driver-to-driver communication. In another embodiment, the sensor data is not limited to the current detection value, and may be, for example, a rotation angle detection value or the like.

In the above embodiment, the target to be controlled by the ECU is the motor. In another embodiment, the targets to be controlled by the ECU may be an actuator or another device, other than the motor. In the above embodiment, the communication device is applied to the electric power steering device. In another embodiment, the communication device may be applied to an in-vehicle device other than the electric power steering device, or may be applied to a device other than the in-vehicle device.

The control unit or controller and the method thereof described in the present disclosure may be realized by a dedicated computer provided by configuring a processor and a memory programmed to execute one or a plurality of functions embodied by a computer program. Alternatively, the control unit or controller and the method thereof described in the present disclosure may be realized by a dedicated computer provided by configuring a processor with one or more dedicated hardware logic circuits. Alternatively, the control unit or controller and the method thereof described in the present disclosure may be realized by one or more dedicated computers configured by a combination of a processor and a memory programmed to execute one or a plurality of functions and a processor configured by one or more hardware logic circuits. Furthermore, the computer program may be stored in a computer-readable non-transitory tangible recording medium as an instruction executed by a computer. As described above, the present disclosure is not limited to the above embodiments at all, and can be implemented in various forms without departing from the gist of the present disclosure.

The present disclosure is described in accordance with the embodiments. However, the present disclosure is not limited to the embodiments and the structures. The present disclosure also includes various modifications and variations within the scope of equivalents. In addition, various combinations and modes, and other combinations and modes including only one element, more elements, or fewer elements therein are within the scope and idea of the present disclosure.

What is claimed is:

1. A communication device comprising:
a plurality of controllers each including at least one processing circuit; and
a plurality of electronic components provided corresponding to the controllers and digitally communicably connected to the controllers, wherein
a combination of a controller and an electronic component that are provided correspondingly is referred to as a control system, and a communication line connecting the controller and the electronic component provided correspondingly is referred to as an intra-system communication line, and
the communication device comprises an inter-system connection line that connects (i) intra-system communication lines of different control systems, (ii) an intra-system communication line of a control system and an electronic component of another control system, or (iii) electronic components of different control systems.

2. The communication device according to claim 1, wherein
the electronic components include a driver component having a pre-driver integrated circuit (IC) configured to transmit a drive signal to a driver circuit related to driving of a load,
the processing circuit digitally transmits a drive command for the driver circuit to the pre-driver IC, and
the pre-driver IC transmits drive information including at least one of a current detection value, temperature information, and abnormality information to the processing circuit.

3. The communication device according to claim 2, wherein
the processing circuit is configured to
calculate and output the drive command for some of the driver circuits,
acquire drive information from the pre-driver IC that has output the drive command, and
acquire drive information from a pre-driver IC corresponding to a driver circuit that does not output the drive command by itself.

4. The communication device according to claim 2, wherein
the processing circuit transmits the drive command at a timing when a processing circuit of another control system connected by the inter-system connection line does not output the drive command.

5. The communication device according to claim 2, wherein
a plurality of the driver components holds detection values at a same timing in accordance with a command from the controller, and sequentially transmit the detection values to the controller.

6. The communication device according to claim 2, wherein
the plurality of processing circuits alternately transmit the drive command to the pre-driver IC every processing cycle.

7. The communication device according to claim 6, wherein
in a case where an abnormality occurs in at least one processing circuit of the plurality of processing circuits that transmits the drive commands to a same pre-driver IC, a normal processing circuit transmits the drive command, instead of the at least one processing circuit.

8. The communication device according to claim 2, wherein
the load is a motor including four sets of motor windings, the motor windings being wound around a stator so that a first winding set, a second winding set, a third winding set, and a fourth winding set are adjacent in this order,
a first driver circuit provided corresponding to the first winding set and a third driver circuit provided corresponding to the third winding set are driven by the drive command having a same phase, and
a second driver circuit provided corresponding to the second winding set and a fourth driver circuit provided corresponding to the fourth winding set are driven by the drive command having a same phase but different from the phase of the first driver circuit and the third driver circuit.

9. The communication device according to claim 8, wherein
an intra-system communication line that connects a first pre-driver IC provided corresponding to the first driver circuit and a first processing circuit and an intra-system communication line that connects a third pre-driver IC provided corresponding to the third driver circuit and a third processing circuit are connected by a first inter-system connection line, and
an intra-system communication line that connects a second pre-driver IC provided corresponding to the second driver circuit and a second processing circuit and an intra-system communication line that connects a fourth pre-driver IC provided corresponding to the fourth driver circuit and a fourth processing circuit are connected by a second inter-system connection line different from the first inter-system connection line.

10. The communication device according to claim 1, wherein
the controller includes a plurality of the processing circuits, and the intra-system communication line is allocated to each of the processing circuits.

11. The communication device according to claim 1, wherein
the inter-system connection line connects the control systems via a system separation component capable of transmitting information while maintaining a potential difference.

12. The communication device according to claim 11, wherein
the system separation component is configured to receive an enable signal from the controller,
communication between systems is enabled in a case where the enable signal is in an enabled state, and
communication between systems is prohibited in a case where the enable signal is in a disabled state.

13. The communication device according to claim 11, wherein
the controller is configured to communicate with an electronic component of an own system in a case where a controller of another system is normal, and
communicate with the electronic component of the own system and the electronic component of the another system in a case where the controller of the another system is abnormal.

14. The communication device according to claim 11, wherein
the inter-system connection line connects the intra-system communication line and an electronic component of another control system or electronic components of different control systems, and
the system separation component is built in the electronic component.

15. The communication device according to claim 11, wherein
the inter-system connection line connects the intra-system communication line and an electronic component of another control system, and
in the electronic component, a communication port to which the inter-system connection line is connected is provided separately from a port to which the intra-system communication line is connected.

16. The communication device according to claim 11, wherein
the inter-system connection line connects electronic components of different control systems, and
the controller is configured to transmit a drive command to an electronic component of another system via an electronic component of an own system, and to receive sensor data and abnormality information about the control system from the electronic component of the another system.

17. The communication device according to claim 16, wherein
information about the own system and information about the another system are continuously updated between the electronic components.

18. The communication device according to claim 16, wherein
the electronic component communicates with the electronic component of the another system in response to a command from the controller of the own system.
